(19) United States
(12) Patent Application Publication
(10) Pub. No.: US 2015/0032514 A1
(43) Pub. Date: Jan. 29, 2015

(54) SYSTEM AND METHOD FOR OPTIMIZING PRODUCT DEVELOPMENT PORTFOLIOS AND INTEGRATING PRODUCT STRATEGY WITH BRAND STRATEGY

(71) Applicant: Stephen M. Cristol, Seattle, WA (US)

(72) Inventor: Stephen M. Cristol, Seattle, WA (US)

(21) Appl. No.: 14/453,556

(22) Filed: Aug. 6, 2014

Related U.S. Application Data
(63) Continuation of application No. 11/696,145, filed on Apr. 3, 2007.
Application No. 11/696,145 is a continuation-in-part of application No. 11/058,107, filed on Feb. 14, 2005, now Pat. No. 7,711,596.
Application No. 11/058,107 is a continuation-in-part of application No. 13/623,032, filed on Sep. 19, 2012, now abandoned.
(60) Provisional application No. 60/789,018, filed on Apr. 4, 2006.
(60) Provisional application No. 60/585,174, filed on Jul. 2, 2004.
(60) Provisional application No. 60/544,781, filed on Feb. 14, 2004.
(60) Provisional application No. 61/536,503, filed on Sep. 19, 2011.

(51) Int. Cl. G06Q 10/06

(52) U.S. Cl. CPC G06Q 10/0639
USPC 705/7.38

(57) ABSTRACT

A business and software method to cost-effectively optimize product and/or service development portfolios, to reduce time to market, and to better integrate and align product or service strategy with brand strategy. The business and software method includes defining in detail the product and service attributes that characterize the ideal customer experience, categorizing the attributes, assigning a numerical value of importance to the attributes, and applying those values to statistical analysis of each assessed product development initiative in terms of alignment with ideal experience and potential competitive impact relative to the resources and risks required to bring each initiative to market. A prioritization for product development resource allocation is developed based upon these analyses. The prioritization is presented in the form of decision intelligence tools for an organization to use and reach informed judgments concerning resource allocation to develop, maintain, or optimize a given product or service portfolio. The decision intelligence tools serve to improve business performance, increase market impact, and build brand equity for products and services of a given organization by improving alignment between what the organization promises customers and what it actually delivers.

### RELATED APPLICATIONS

This application is a continuation of U.S. patent application Ser. No. 11/696,145 filed on Apr. 3, 2007 which claims priority to and incorporates by reference in its entirety U.S. Provisional Patent Application No. 60/789,018 filed Apr. 4, 2006.

U.S. patent application Ser. No. 11/696,145 is a continuation-in-part of, claims priority to, and incorporates by reference in its entirety U.S. patent application Ser. No. 11/058,107 filed Feb. 14, 2005 now U.S. Pat. No. 7,711,596 issued on May 4, 2010. U.S. patent application Ser. No. 11/058,107 in turn claims priority to and incorporates by reference in their entirety U.S. Provisional Patent Application No. 60/585,174 filed Jul. 2, 2004 and U.S. Provisional Patent Application No. 60/544,781 filed Feb. 14, 2004.

This application is a continuation-in-part of U.S. patent application Ser. No. 13/623,032 filed on Sep. 19, 2012 which claims priority to and incorporates by reference in its entirety U.S. Provisional Patent Application No. 61/536,503 filed Sep. 19, 2011.

Each and all of the foregoing applications are incorporated by reference as if fully set forth herein.

### COPYRIGHT NOTICE

This disclosure is protected under United States and International Copyright Laws. © 2007. Steven M. Cristol. All Rights Reserved. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

Embodiments of the invention relate to enhancing business performance, market impact, and brand equity by optimizing product development portfolios and better integrating and aligning product strategy with brand strategy.

### BACKGROUND OF THE INVENTION

Brand equity is a significant contributor to the financial value of most successful firms. Brand equity represents the value inherent in the ability of a firm's brands to command premium prices for goods and services. The premium prices that customers are willing to pay for branded goods and services as compared to identical non-branded goods and services, and the incremental demand that strong brands generate can account for more than half the value of a firm. In other words, in some cases intangible brand equity can be worth even more than a firm's tangible assets. Growing brand equity requires strong brand identity—the meaning of the brand in the minds of targeted customers. Strong brand identity requires extensive coordination between various organizations within a firm such as marketing, product management, research and development, and sales. These different teams often have different levels of discipline, levels of sophistication, and sets of assumptions based on overlapping yet divergent views of the marketplace. Many companies are unable to coordinate these organizations in ways that help maximize brand equity and customer loyalty. To date, this is because integrating and aligning these different functions have required major organizational, management, and process changes that are expensive and time consuming. The preferred embodiment of the particular embodiments addresses this problem and many related ones.

### SUMMARY OF THE PARTICULAR EMBODIMENTS

A business and software method to cost-effectively optimize product and/or service development portfolios, to reduce time to market, and to better integrate and align product or service strategy with brand strategy. The business and software method includes defining in detail the product and service attributes that characterize the ideal customer experience, categorizing the attributes, assigning a numerical value of importance to the attributes, and applying those values to statistical analysis of each assessed product development initiative in terms of alignment with ideal experience and potential competitive impact relative to the resources and risks required to bring each initiative to market. A prioritization for product development resource allocation is developed based upon these analyses. The prioritization is presented in the form of decision intelligence tools for an organization to use and reach informed judgments concerning resource allocation to develop, maintain, or optimize a given product or service portfolio. The decision intelligence tools serve to improve business performance, increase market impact, and build brand equity for products and services of a given organization by improving alignment between what the organization promises customers and what it actually delivers.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee.

FIG. 1 is a method flowchart of master algorithm 10 to deliver decision intelligence to a client for making resource allocations for product/service portfolio development and alignment with brand strategy;

FIGS. 2A-D depicts expansion of method sub-algorithms contained with the processing blocks of master algorithm 10 of FIG. 1;

FIG. 3 depicts an alternate embodiment of the general method;

FIG. 4 depicts another embodiment of the general method

FIG. 5 depicts an entity relationship of brand strategy architecture;

FIG. 6 illustrates an example of a Brand Strategy Architecture in the first embodiment for an iMac® brand strategy;

FIG. 7 is an expansion of the Level 2 entity relationships of the iMac® Brand Strategy Architecture of FIG. 6;

FIG. 8 depicts a Strategic Harmony® example of Level 2 driver listings with identifiers and association factors similar to those described in FIGS. 6 and 7;

FIG. 9 depicts an expansion of another Strategic Harmony® example for prioritizing Level 2 drives of brand choice using the Application Consensus Builder tool in the case of applications related for use by a network IT manager;

FIG. 10 depicts a screenshot tabular illustration of examples of enterprise software having simplicity factor level association defined by numerical correlation coefficients as inputs to the Strategic Harmony® product development portfolio analysis;

FIG. 11 is a screenshot illustration from the first embodiment that shows how the output of the Consensus Builder tool displayed in a spreadsheet;

FIG. 12 is a screenshot example of results obtained for product development initiatives' alignment with key drivers of brand choice and distributed among cells of a spreadsheet by category, numerical scores, and alignment level classification determined from conducting an Alignment Assessment of a product development portfolio;

FIG. 13 is a screenshot depiction of the “Pacing Guide—Strategic Harmony® Proof Points Session” that Application workshop facilitators use to set workshop pacing targets;

FIG. 14 is a screenshot depiction from the first embodiment of the “Pacing Guide—Strategic Harmony® Portfolio Session” that Application workshop facilitators use to set workshop pacing targets;

FIG. 15 is a screenshot depiction of the templates used for capturing Proof Points Workshop output described as a Proof Points Inventory/Audit and Competitive Assessment;

FIG. 16 is a screenshot depiction of the templates used for capturing Product Development Portfolio Workshop output in the form of a Development Initiatives Assessment;

FIG. 17 is a depiction from using whiteboards in facilitating required team discussions during Proof Points and Product Development Portfolio Workshops;

FIG. 18 is a tabular illustration of Proof Points Inventory template designed for output to a spreadsheet program;

FIG. 19 is another tabular illustration for entry of driver dimensions distributed among proof points for control by factor name field that is changeable with each sheet of the Proof Points Inventory workbook;

FIG. 20 is a screenshot example from a completed page of a Proof Points Inventory for a fictitious enterprise software company;

FIG. 21 is a screenshot example of a “current competitive situation” baseline inventory of product characteristics distributed among key factors that drive brand choice and further classified against competing entities according to whether the client's product is superior to, at parity with, or inferior to competitors' products;

FIG. 22 is a screenshot example of how results display from an Alignment Assessment of a product development portfolio;

FIG. 23 is a screenshot illustrating a bar chart display from calculating the attribute-specific impact of the collective initiatives in a product development portfolio;

FIG. 24 is a screenshot example of results obtained for product development initiatives' potential competitive impact on key drivers of brand choice and distributed among cells of a spreadsheet by category, numerical scores, and competitive classification determined from conducting a Competitive Impact Assessment of a product development portfolio;

FIG. 25 is a screenshot example of a Competitive Impact Assessment showing the potential competitive impact of one selected initiative from a product development portfolio;

FIG. 26 is a screenshot example a total portfolio view of Competitive Impact Assessment results that shows the collective potential competitive impact of all product initiatives in a product development portfolio;

FIG. 27 is a screenshot example of a compressed view of the Strategic Harmony® Competitive Impact Dashboard that hides the rating rationales text;

FIG. 28 is a screenshot example of how results are displayed from a Manageability Assessment;

FIG. 29 is a screenshot example how a Product Development Portfolio Assessments Recap is displayed;

FIG. 30 is a screenshot example of Overall Strategic Importance rankings and indices that shows each importance index's Alignment and Competitive components;

FIG. 31 is a screenshot tabular example of a Strategic Harmony® Priority Guide is displayed to provide a rationale for overall strategic importance;

FIG. 32 is another screenshot tabular example of balancing strategic importance against development burden/manageability;

FIG. 33 presents a tabular screenshot graphic of a tiered approach to categorizing development priorities via integrated assessments;

FIG. 34 presents a screenshot graphic, as delivered to a client, of a three-dimensional Strategic Harmony® Quadrant Map integrating Alignment, Competitive Impact, and Manageability scores;

FIG. 35 depicts a screenshot graphic concerning inputs, consensus, and deliverable outputs to show key phases of how the method is implemented in a typical client consulting engagement;

FIG. 36 depicts an Application screenshot of an inputs master for use by consultants before project-specific date is entered;

FIG. 37 depicts another Application screenshot of an inputs master for use by consultants after the consultant enters project-specific data;

FIG. 38 depicts an Application screenshot concerning alignment with drivers of brand choice and illustrates a region denoted “Back Room: Consultants Only” where Strategic Harmony® mathematical formulae are applied to produce various metrics;

FIG. 39 depicts screenshot graphics of a two-dimensional Strategic Harmony® Quadrant Map integrating Alignment and Competitive Impact scores, and a three-dimensional Quadrant Map integrating Alignment, Competitive Impact, and Manageability scores;

FIG. 40 depicts an Application screenshot showing details operating or associated with the “Back Room: consultants Only” in arriving at numerical descriptors for manageability of designated portfolio initiatives;

FIG. 41 depicts an Application screenshot graphic of bar graphs describing alignment with brand choice, competitive impact, and manageability; and

FIG. 42 depicts an Application screenshot of scores, ranks, and indices of alignment, competitive impact, and manageability for designated portfolio initiatives, plus conversion ratios and reference metrics ranges for consultants.

### DETAILED DESCRIPTION OF THE PARTICULAR EMBODIMENTS

The particular embodiments are directed to a business method that improves business performance and strengthens brands by prioritizing product development projects based on a systematic approach of defining assumptions that drive brand choice and assessing a product development portfolio thereon—resulting in more effective allocation of product development resources. In one embodiment, consultants or consulting firms are principally employed to advise their client companies. Other particular embodiments may also be employed directly by client companies without the use of consultants. Yet other particular embodiments prioritize or reprioritize initiatives within a product development portfolio based on each initiative's relative alignment with ideal customer experience (and, therefore, likely relative contribution to brand equity), relative potential competitive impact, and the resource requirements, risks and complexities involved in successfully completing the initiative. Prioritization is accomplished by performing and integrating assessments of the client company's situation. These can include 1) a baseline assessment of the current competitive situation for a client company's brand and current product or service portfolio; 2) an assessment of each initiative's relative alignment with key drivers of brand choice that define the ideal customer experience; 3) an assessment of each initiative's likely competitive impact in terms of strengthening the client company's brand where it most needs strengthening vs. competitor brands; and 4) an assessment of the relative manageability, or development burden, of each initiative including human and financial resources, risk, and complexity. The assessments are then integrated to produce decision intelligence for strategically prioritizing initiatives within the product development portfolio, identifying gaps in the portfolio, and reallocating development resources accordingly. The client company's current situation can determine which implementing approach of particular embodiments is most appropriate: 1) the full method or 2) the streamlined method. The full method is most appropriate when the company's brand strategy is either underdeveloped or in need of updating or significant refinement. It includes a process for developing a “Brand Strategy Architecture” that encompasses multiple elements optionally advantageous as inputs to the product development portfolio assessment. The streamlined method is most appropriate when the client company already has the serviceable equivalent of a “Brand Strategy Architecture” and/or the drivers of brand choice have been adequately identified and prioritized. Alternatively, any method in between the streamlined and full method may be utilized or a combination of methods may be utilized. The decision on which method to utilize can be based on an assessment of the client company's current level of sophistication on brand strategy or the availability of recent brand choice research that adequately identifies and prioritizes drivers of brand choice.

The application software provides a means to implement the particular embodiments of the system and business methods in the form of computer readable media containing executable instructions to implement particular embodiments described herein. The application software specification explains details of particular embodiments of the business method employed using particular system embodiments described below in business related “use case” scenarios, references as Use Case Nos. 1-10.

1.1 Software Development Project Description. The software developed to date, and further specified enhancements yet to be developed, is to support the administration of Application—a proprietary business method developed principally for use by management consulting or marketing consulting firms, and business departments with in-house staff capable to perform consulting functions. Business methods employ software to support a consulting team's administration of application's methods, including collecting and entering specified inputs, analyzing inputs, generating and manipulating outputs, and building client presentations of results and recommendations. A tool for calculating a project's return of investment (ROI) is specified and a tool for generating a customer research Request For Proposal (RFP) for the client company. For clients requiring new customer research, the RFP is primarily to insure development of a brand choice research proposal designed specifically to produce data amenable for entry into application software-provided screenshot interfaces to culminate in the development of decision intelligence as regards product and service portfolio assessments. The software may be adaptable to enterprise-related applications and non-enterprise applications executed from standalone personal computers configured to run separately from enterprise software housed applications. Executed from non-enterprise computers, the software of the particular embodiments may be used more productively to help a company decide how to reprioritize and/or redefine its development portfolio and allocate resources within it.

1.2 Terms and Definitions. The term “product development initiative” is used throughout this document in lieu of “product development project” to eliminate confusion, so that the word “project” can refer exclusively to the software development project described herein—and not to projects in the companies whose strategies are being assessed. Also, the phrase “client company” is used to indicate a business client of a consulting firm using this software, as distinguished from a “client” that refers to a client computer in a client-server computing environment. As a precursor to feature specifications and use cases described in this document, this section defines Application assessments, assessment metrics and outputs, and seven supporting tools.

Portfolio Assessments—The four assessments previously referenced provide context for terms and definitions optionally advantageous to the software application. Before defining those terms, following is a brief description of the four assessments: 1. Assessment of current product(s)' alignment with customer perceptions of the “ideal” brand, as a baseline for comparisons used in competitive impact assessment; 2. Assessment of planned product development initiatives' likely alignment with drivers of brand choice, relative to each other and in combination; 3. Assessment of planned product development initiatives' likely competitive impact, relative to each other and in combination; and 4. Assessment of the relative development burden and manageability of each product development initiative.

Assessment Metrics and Outputs—Application assessment outputs are a combination of qualitative judgments made by experienced consultants—transcending the software application itself—and quantitative outputs generated by the software application's use of best practices templates, specified strategic filters, and prescribed underlying mathematics to assess and prioritize various inputs. Quantitative output is used primarily to prioritize specific variables within selected sets of attributes, projects, or resource burdens. As such, the quantitative outputs calculated by the software are expressed as the following nine metrics (definitions of each follow). These manifest as indices and/or rankings representing the relative importance of variables assessed within each metric: 1. Category Adoption Drivers Importance Index; 2. Brand Choice Drivers Importance Index; 3. Alignment of Product Development Initiative with Category Adoption Drivers; 4. Alignment of Product Development Initiative with Brand Choice Drivers; 5. Competitive Impact of Product Development Initiative; 6. Overall Strategic Importance of Product Development Initiatives; 7. Resource Requirements of Product Development Initiative; 8. Complexity of Product Development Initiative; 9. Overall Priority Based on Integrated Assessments (and Application Composite Priority Score). The following are definitions of each output listed above.

Category Adoption Drivers Importance Index. Category adoption drivers are the considerations in the minds of a client company's customers that drive their decision to adopt or not adopt a product or service category that they have not yet purchased. In other words, what factors make a product or service category attractive enough to merit customers' serious purchase consideration—before they ever get to the stage of evaluating specific brands? For example, in the category of color laser printers for businesses, category adoption drivers may include the need to save money over the long haul by reducing outsourcing of color printing jobs or the desire to make a small business look more professional by cost-efficient use of color in documents intended for their customers. Understanding the relative importance of what is usually a multitude of such drivers is a key to both effective product development and marketing communications, and particularly important in emerging, less mature categories. The Category Adoption Drivers Importance Index expresses this relative importance for each driver, from a customer perspective.

Brand Choice Drivers Importance Index. Brand choice drivers are the considerations in the minds of a client company's customers that determine (once they decide to adopt a category or repurchase within a category already adopted) how they differentiate between Brand X and Brand Y. These choice-driving attributes define the characteristics of the “ideal brand” as perceived by the customer. In the business color laser printer example, such attributes cluster under high-level factors such as performance, reliability, simplicity, and value. Each of those abstract, high-level factors has multiple dimensions that are more concrete; for example, simplicity may comprise specific attributes, or choice drivers, such as easy to purchase, easy to install, easy to use, easy to upgrade, and easy-to-manage supplies. A customer's perceptions of each brand on brand choice drivers, then, will determine whether HP, Lexmark, Canon, or some other brand of color printer is actually purchased. In any product or service category, there may be as many as 20 to 35 discrete attributes that play a significant role in brand choice dynamics. As with category adoption drivers, understanding the relative importance of brand choice drivers is a key to both effective product development and marketing communications—and of utmost strategic importance in more mature, established categories where category adoption is in the past and competing brands are now fighting it out for market share. The Brand Choice Drivers Importance Index expresses this relative importance for each driver, from a customer perspective.

Alignment of Product Development Initiative with Category Adoption Drivers. Having established an importance hierarchy for category adoption drivers, each of the client company's planned product development initiatives can be assessed in terms of how well aligned it is with those considerations that are driving the customer toward category adoption. This assessment is ideally provided by client company primary research, but in the absence of such research may be supplied by consensus among internal company experts on customer needs and market conditions. Regardless of input source, each development initiative may be determined to have one of five levels of impact on how the client company's brand may be perceived as providing the customer benefits implied in each specific adoption driver. These five possible impact levels (“Alignment Ratings”) are expressed subjectively as: high impact, moderate impact, low impact, no impact, or negative impact. In the software, different quantitative values may be assigned to each of those five levels and an Alignment Index may be calculated.

Alignment of Product Development Initiative with Brand Choice Drivers. Having established an importance hierarchy for brand choice drivers, each of the client company's planned product development initiatives can be assessed in terms of how well aligned it is with characteristics of the “ideal brand.” This assessment is also ideally provided by client company primary research, but in the absence of such research may be supplied by consensus among internal company experts on the degree to which a particular development initiative would likely impact customer perceptions of their brand. Regardless of input source, each development initiative may be determined to have one of the same five levels of impact (“Alignment Ratings”) described above on how positively the client company's brand may be perceived on each brand attribute that drives brand choice. In the software, different quantitative values may be assigned to each of those five levels and an Alignment Index may be calculated for each product development initiative.

Competitive Impact of Product Development Initiative. Based on results of the assessment of the client company's current product(s), each development initiative is assessed for potential competitive impact at twelve possible levels describing the degree to which it helps the client's company's competitive situation where help is most needed. Some development initiatives, even though responding to customer needs for a certain feature or product, may strengthen brand perceptions only where the brand is already strong and perceived to be superior on a particular brand choice driver. But other initiatives may close critical gaps vs. a strong competitor or even “leapfrog” the client company's brand over that competitor to enable a legitimate claim of superiority on a particular brand choice driver where the current product is relatively weak. The latter case has more competitive impact than the former, and would therefore be rated at a much higher impact level and is, accordingly, assigned a higher quantitative value. In the software, these quantitative values are used to produce a Competitive Impact Index for each product development initiative.

Overall Strategic Importance of Product Development Initiative. Overall strategic importance of each initiative, relative to other initiatives in the product development portfolio, is a composite of the three measures immediately above (or two, in more mature categories where category adoption drivers are less relevant)—combining for each initiative its competitive impact ranking with its ranking on alignment with drivers of brand choice (and/or drivers of category adoption if relevant). Together, without regard for development burden, these provide a composite ranking of the overall strategic importance of each development initiative relative to the other initiatives either planned or under serious consideration in the development portfolio. Aggregately, these rankings also provide an assessment of the total portfolio on both alignment and competitive impact as a group of initiatives, possibly pointing the client company to the need for adding or replacing initiatives to strategically strengthen the portfolio overall. By combining the Alignment Index and Competitive Impact Index (both described above), the software can produce an Overall Strategic Importance Index for each product development initiative. Resource Requirements of Product Development Initiative. Each product development initiative carries a projected resource requirement of people and money. In the enterprise software business, for example, the resource requirement may be as straightforward as X number of internal developer weeks or as complex as some combination of outsourcing and technology acquisition. Client company internal consensus within the product development organization can determine whether the resource requirement of any one development initiative, relative to the other planned initiatives, is very high, high, moderate, or low. A relative quantitative value is assigned accordingly. This resource measure, along with the relative complexity (defined below), provides a picture of overall resource burden of one initiative vs. another—a burden that can be revisited for resource allocation purposes in light of each initiative's overall strategic contribution as assessed by the alignment and competitive impact measures above. Complexity of Product Development Initiative. Some product development initiatives require a lot of human and financial resources, but are actually relatively straightforward in terms of knowing how to do them and managing risks. Other initiatives—even some with relatively lower human resource requirements—may be sufficiently complex that the client company has not yet “cracked the code” on how to get it done, so the risks and uncertainties are greater. Perhaps invention, further research, or technology acquisition/licensing are required. So complexity augments resource requirements as another component of overall development burden. As with the resource requirements assessment, client company internal consensus within the product development organization can determine whether the complexity of any one development initiative, relative to the other planned initiatives, is very high, high, moderate, or low. A relative quantitative value is assigned accordingly. Application software can weight resources vs. complexity by a ratio that the consultant users prescribe based on client company circumstances. A product of that ratio may be a ranking of the overall relative development burden of each development initiative, incorporating both resource requirements and complexity in generating a Manageability Index. Overall Priority Based on Integrated Assessments. To balance the strategic filters applied in each of the Application assessment modules, the alignment assessment, competitive assessment, and manageability assessment may be all be integrated to produce an overall recommendation of relative priority among the initiatives in the product development portfolio. Although this is in part a subjective process driven by experienced consultants who are users of the software, it is based substantially on underlying mathematics that the software can automate to produce a master Application Priority Guide that the consultant may modify as subjectivity dictates. Further, an optional Application Composite Priority Score (“CPS”) takes the overall strategic priority (alignment plus competitive impact) of each initiative and modifies it by counterbalancing the development burden to produce one composite score for each product development initiative, reflecting full integration of all three types of product development portfolio assessments. CPS is the highest-level Application metric in that it reflects the results of all assessments in a single comparative score for each initiative in a portfolio. Support Tools—Three software tools can support the consultant in collecting required inputs to feed Application assessments: (1) a Consensus Builder tool, (2) a Proof Points Inventory tool, and (3) a Facilitator Support toolset. A fourth tool, the Interactive Methodology Flowchart, helps the consultant find his or her way through the overall input, assessment, and analysis phases of Application administration. Additional tools include a ROI analysis tool, a customer research Request For Proposal tool, and a reference library containing best practices information and training tutorials. These are not discussed immediately below but are described in more detail in relevant Section 2 uses cases below. Consensus Builder Tool. In some client company circumstances where there is no existing quantitative research that provides the coefficients required to determine the first two indices listed above, “proxy” coefficients can be substituted. Proxy coefficients are determined by use of a tool called the Consensus Builder. This tool, designed to harness internal knowledge within the client company organization and drive consensus regarding the relative importance of certain variables, using a multi-voting technique, is currently modeled in Microsoft Excel and is to be rebuilt as an integrated, native part of Application software. As noted in Section 2.2, the Consensus Builder may be used on an alternative path that occurs when proxy coefficients are required. Since a Strategic Harmony® implementation can be completed without Consensus Builder when proxy coefficients are not required, this document does not include Consensus Builder specifications. A Consensus Builder use case may be prepared to append to this document and, based on software developer feedback, decisions may be made on how to handle inclusion of Consensus Builder in the system and/or whether to link to the standalone Excel version in some way. Proof Points Inventory Tool. Integral to assessment of a client company's existing product portfolio—which in turn serves as a baseline for assessing the competitive impact of product development initiatives—is a tool called the Proof Points Inventory. This is a templated matrix that is used to capture reasons for customers to believe that the client company's brand excels on certain characteristics of the “ideal brand.” Its input is simply text bullet points, but Application software may be required to count the number of bulleted text entries per matrix cell, subtotal and total them, and search for certain specified words and count their incidence of occurrence. The template currently exists in Microsoft Excel. Facilitator Support Toolset. Consultants administering Application may, in most cases, be required to facilitate in-person work sessions with teams from the client company to gather inputs for analysis. The information that may be be gathered is very specific; the process for gathering it is highly structured in both sequence and format, based on field-tested facilitation experience. A Facilitator Support Center in the software can provide various templates for formatting easel pads and/or whiteboards to capture the required inputs in each client company work session. Once printed to hardcopy, these can then be enlarged or manually copied by a graphic artist for use in the actual session. Or, the templates can be used on a laptop computer by a keyboard recordist to make a digital record of the session in real time. The tool also provides a timings worksheet for planning out a detailed schedule of events, and their pacing, in each client company work session. Interactive Methodology Flowchart Tool. The Strategic Harmony methodology is graphically represented by a process flowchart that is conducive to interactivity—whereby a consultant could click on any box on the flowchart and see the steps involved, prescribed sequence, and any best practices templates or information available for those steps.

1.3 General Requirements—In lieu of building a commercial-grade Application software application that is fully functional, secure, collaborative, interoperable with multiple operating systems, and supported with built-in online help to primarily serve three purposes: (1) enabling a live demo of all key features and functions, with high-quality graphical display of information and automated mathematic calculations, (2) enabling the support of implementing method embodiments for current consulting clients, and (3) providing an architectural foundation that a larger development team can ultimately build upon to complete and further evolve the application.

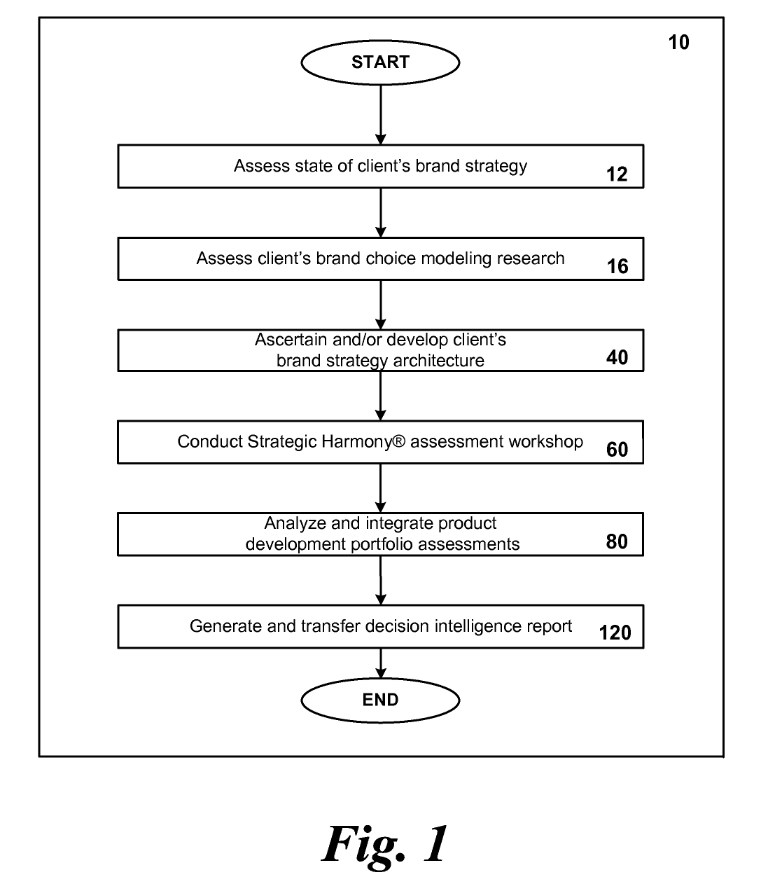

FIG. 1 depicts a flowchart from the first embodiment showing where the nine basic use cases in the Strategic Harmony® application software specification fit in the context of the overall business method process flow. The flowchart provides the software developer with an overview of Application process flow and provides visual context for the first nine use cases contained in this document. Technology Requirements—Basic assumptions for particular embodiments of the software include: (1) that the software may be used by the consultant on a client computer running any operating system that supports use of a Web browser, with the application engine and business logic residing on a server, and (2) that a Web browser may be used on the client to navigate the application. Server platform may be based on considerations of developer preferences, efficiency, and effectiveness, and modified to the needs of a given user consulting firm. User Interface Requirements—As depicted in the accompanying drawings, most information to be graphically displayed is quite straightforward and represented simply in bar graphs, 2-D dashboards (that could perhaps be more dimensional), text, and listings of rankings, that in particular embodiments, is presented using professional looking graphics having attractive dimensions, aesthetically colored, and highly readable to users. Specific interface requirements are best implied by the features, uses and actors described in alternate embodiments described below.

1.4 Overview of Features—Below is a high-level overview of Application feature sets, including: 1. Home page; 2. Process overview and monitoring; 3. Inputs administration; 4. Assessments administration; 5. Analysis administration; 6. Presentation administration; Other overviews need not have an ROI module, a Customer Research RFP module, a reference library, or a Help module because these modules may be depicted in a placeholder page accessible from a navigation tab/link on the home page.

Home Page—This section describes the optionally advantageous functionality of the Application home page. This is the first page that may be presented to the user upon navigation to www.strat-harmony.com and/or www.strategicharmony.net (Cristol & Associates/Strategic Harmony® Partners registered domain names) or a designated substitute URL. It allows users to log on to the system, and then presents navigation links to all features—along with text that welcomes authenticated users and provides a brief overview paragraph describing Application and a paragraph describing the software site and available tools.

FIG. 1 is a method flowchart of master algorithm 10 to deliver decision intelligence to a client for adjusting resource allocation for product/service portfolio development and brand strategy purposes. Master algorithm 10 presents in flowchart form a particular embodiment showing where the nine basic use cases (discussed above and referenced below) in the Strategic Harmony® application software specification presented in the context of an overall business method. Master algorithm 10 begins with process block 1, assess state of client's brand strategy, and continues with process block 16, assess client's brand choice modeling research. Thereafter, at process block 40, master algorithm 10 continues with ascertaining and/or developing the client's brand strategy architecture, followed by process block 60, conducting Strategic Harmony® assessment workshops. Master algorithm 10 then continues with process block 80, analyzing and integrating product development portfolio assessments. Thereafter, master algorithm finishes with performance of the completion of process block 120, generate and transfer decision intelligence report to client.

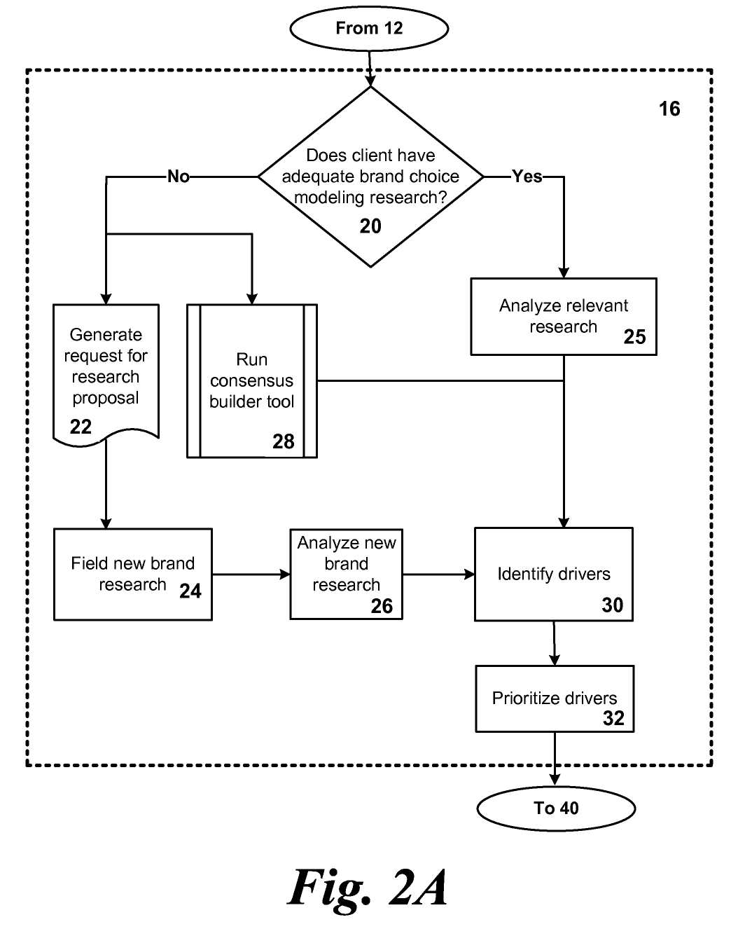

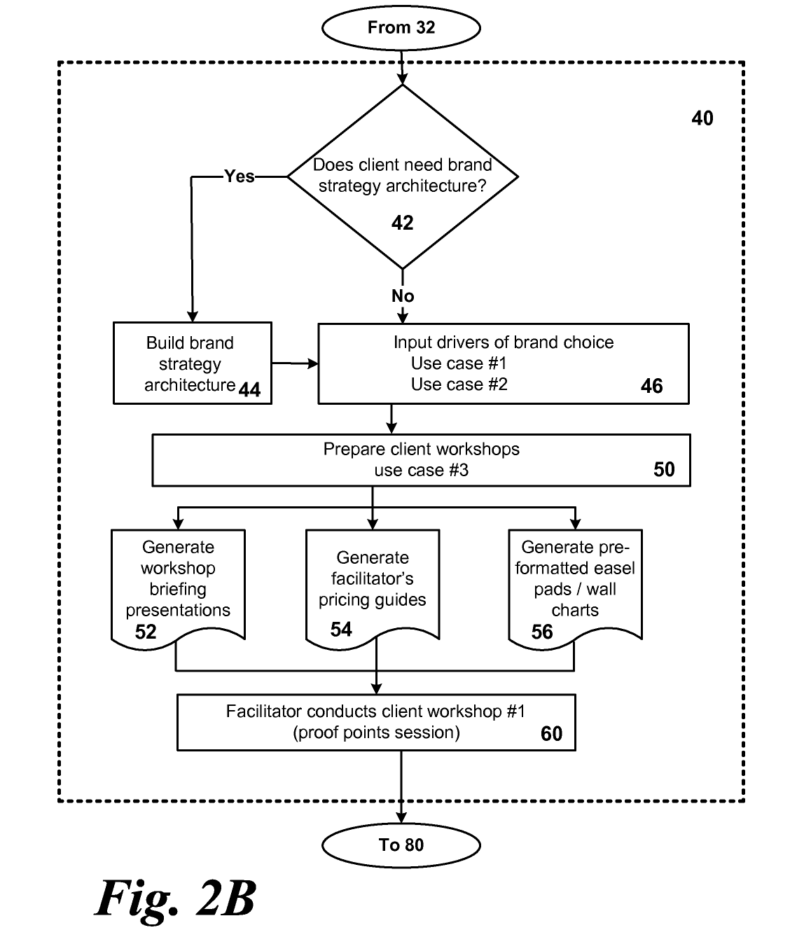

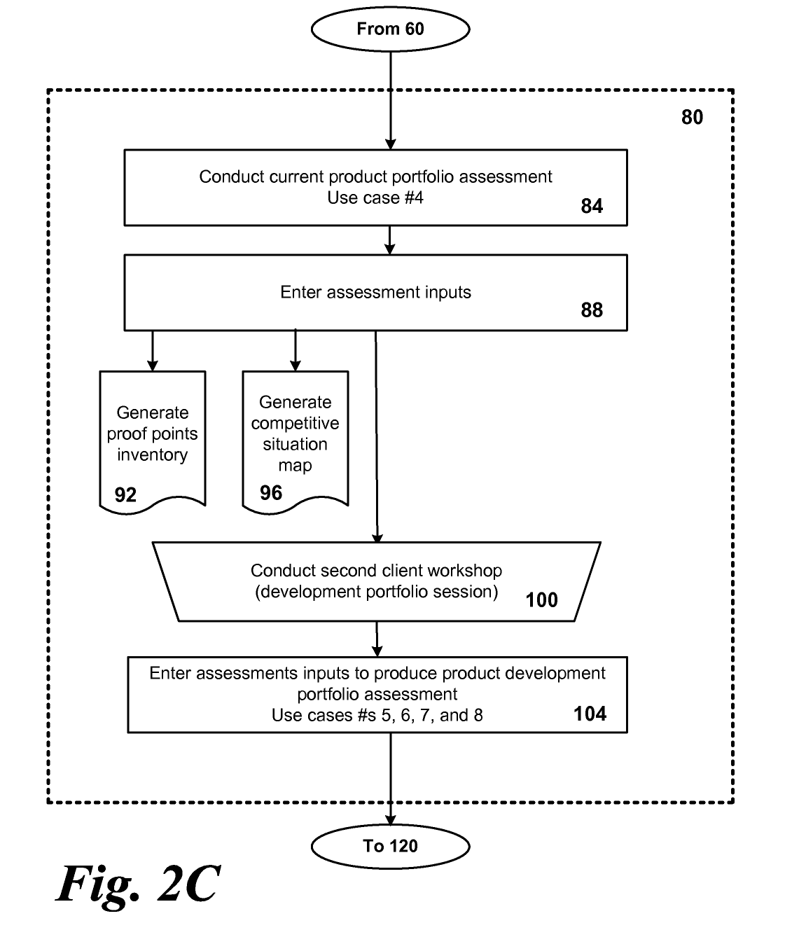

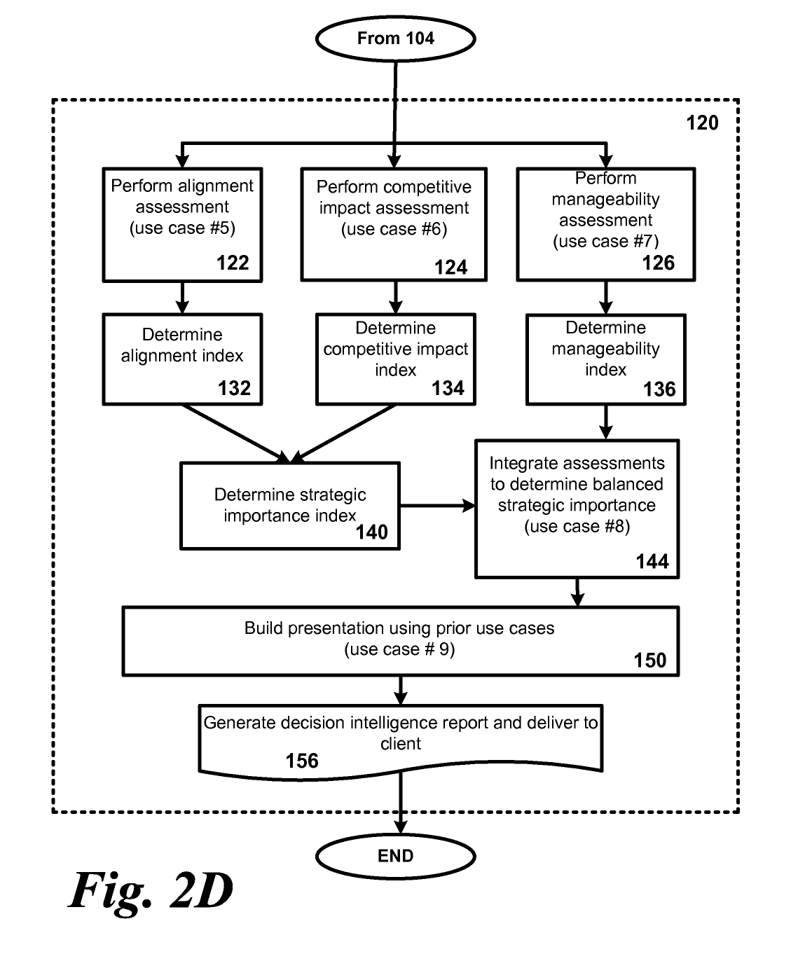

FIGS. 2A-D depicts expansion of method sub-algorithms contained with the processing blocks of master algorithm 10 of FIG. 1.

FIG. 2A is an expansion of sub-algorithm 16. Entering from process block 12, decision diamond 20 is reached with the query “Does client have brand choice modeling?”. If the answer is negative, sub-algorithm 16 routes to process blocks 22, generate Request for Research Proposal or, alternatively, to block 28, run Consensus Builder tool. From process block 22, the negative route continues to process block 24, field new brand research, and thereafter to process block 26, analyze new brand research. If the answer is positive, sub-algorithm 16 routes to process block 25, analyze relevant research. The negative branches from process blocks 26 and 28 converge with the positive branch 25 at process block 30, identify drivers. Thereafter, at process block 32, identified drivers are then prioritized as to importance and subalgorithm 16 exits to process block 40.

FIG. 2B is an expansion of subalgorithm 40. Entering from process block 32, decision diamond 42 is reached with the query “Does client need brand strategy architecture?”. If the answer is positive, sub-algorithm 40 routes to process blocks 44, build brand strategy architecture. If the answer is negative, sub-algorithm 40 routes to process block 46, input drivers of brand choice. The positive branch from process block 44 converges with the negative branch at process block 46 and continues to process block 50, prepare client workshops. Thereafter, three workshop products are generated respectively at process blocks 52, generate workshop briefing presentation, 54, generate facilitator's pacing guide, and 56, generate pre-formatted easel pads or wall charts. After preparing for conducting client workshops, subalgorithm 40 contiues with process block 60, conduct first client workshop. Subalgorithm 40 is completed and then exits to process block 80.

FIG. 2C is an expansion of subalgorithm 80. Entering from process block 60, subalgorithm 80 begins with process block 84, conduct current product portfolio assessment. Refer to use case #4 as a representative example. Thereafter, at process block 88, enter measurement inputs are performed using screenshots interface described in the figures below. Outputs generated from blocks 60 and 84 are then combined to produce output blocks 92, generate proof points inventory, and 96, generate situation map. In view of the proof points inventory and generated situation maps, at process block 100, a second workshop is conducted on the client's behalf by the consultants. From the second workshop, at process block 104, other inputs are entered to produce a product development portfolio assessment. Subalgorithm 80 is completed and then exits to process block 120.

FIG. 2D is an expansion of subalgorithm 120. Entering from process block 104, subalgorithm 120 begins with entry into process blocks 122, perform alignment assessment, 124, perform competitive impact assessment, and block 126, perform manageability assessment. From the alignment assessment, an alignment index is determined at process block 132. Similarly, a competitive impact index is determined at process block 134 obtained from the competitive assessment, and a manageability index is determined at process block 136 obtained from the manageability assessment. The alignment and competitive impact indices from process blocks 132 and 134 are combined to determine a strategic importance index at process block 140. The strategic importance and manageability indices from process blocks 140 and 136 are combined or integrated together to determine a balanced strategic importance index at process block 144. With the balanced strategic importance index, at process block 150, a presentation for the client is built using prior use cases. Thereafter, subalgorithm 120 and master algorithm 10 is completed process block 156 with the production of a decision intelligence report for use by the client.

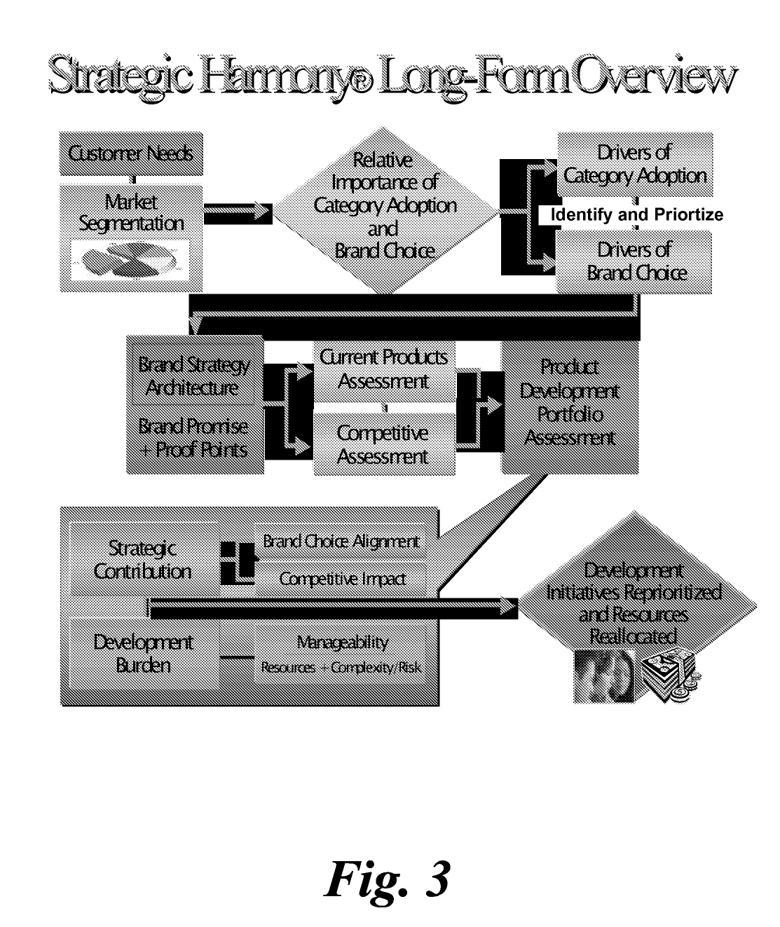

FIG. 3 depicts a general method to develop the inputs required for product development portfolio assessments and alignment of product strategy and brand strategy. The user of the method is orientated to the application model and methodology in the form of a visual interactive map of the process for implementation and shows beginning with a process overview and monitoring. A tracking visual can be used to monitor the progress of a particular implementation. Clicking on any text box can link to an explanation of that part of the process, as well as any associated inputs, outputs, and examples.

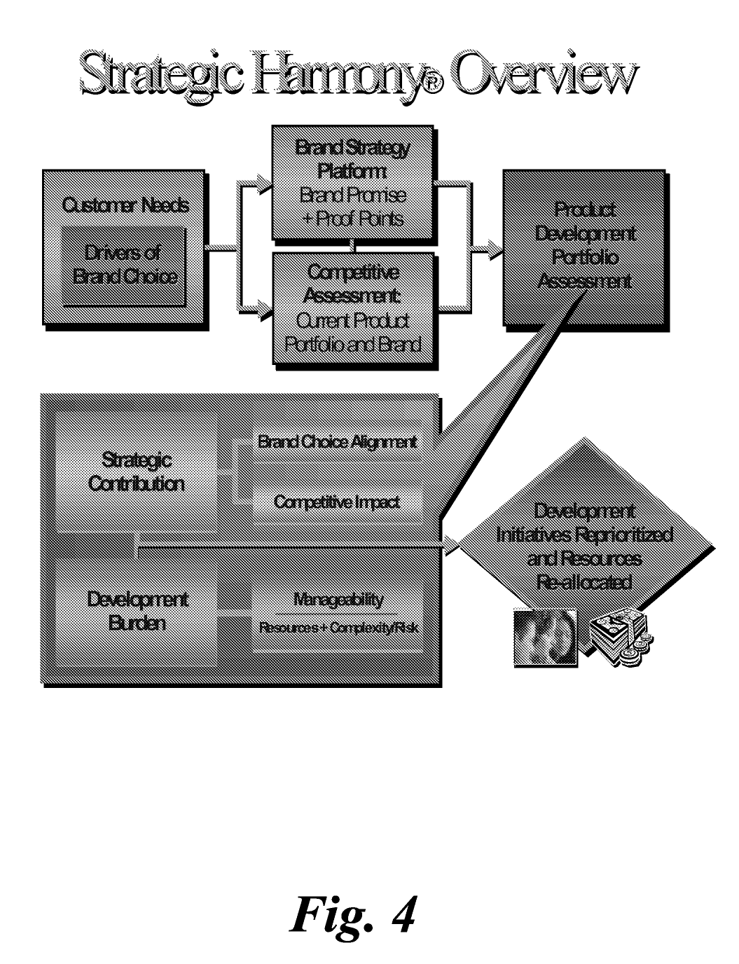

FIG. 4 depicts an alternate embodiment of the general method. The alternate embodiment provides a “streamlined” version of the Application model, which is used for client companies that may not need a Brand Strategy Architecture and prefer to proceed directly to product portfolio assessment after identifying and prioritizing drivers of brand choice. This screen may be used in the same ways as FIG. 3, as an alternative version that may be selected by the user in Use Case #1.

Inputs Administration—This feature set enables users to collect, archive, and access all the client company inputs required for Application implementation as detailed in Section 2 use cases. It allows users to: (1) enter the consulting client's specific market segment names and profile characteristics, where applicable; (2) administer the Consensus Builder tool; (3) import a client-specific Brand Strategy Architecture from Microsoft PowerPoint; (4) import or manually enter drivers of brand choice and/or category adoption and, if available, their correlation coefficients, as well as linking to any customer research studies or excerpts approved as input to a particular implementation; (5) administer the Facilitation Support tool to select and populate pre-formatted templates for use in facilitating the in-person team work sessions designed to capture client company inputs; (6) administer the Proof Points Inventory tool; (7) enter the client company's product development portfolio, including each development initiative being assessed; (8) enter the client company R&D experts' estimate of resource requirements and task complexity. This feature set also defines the means by which the parameters for every input can be added, modified or deleted. Where specific display formats are important to the functions listed above, Excel- or PowerPoint screen shots are shown in Section 3.

Assessments Administration—This feature set allows the user to manipulate the inputs above to conduct Application assessments. It enables administration of the four different assessments referenced previously, known to users by the following “shorthand” labels and based on inputs as noted below: Baseline Assessment—Current Products' Alignment. (Based on drivers of brand choice entered in Inputs Administration.) Assessment 1—Development Portfolio Alignment.—Based on drivers of brand choice entered in Inputs Administration.) Assessment 2—Development Portfolio Competitive Impact. (Based on competitive assessment derived from Proof Points Inventory data entered in Inputs Administration). Assessment 3—Manageability. (Based on the client company's R&D experts' estimate of resource requirements and task complexity as entered in Inputs Administration.) Excel screen shots for each assessment are shown in the accompanying drawings as specifically cross-referenced in Use Cases #4, 5, 6 and 7. Calculations and underlying mathematics optionally advantageous for each assessment are specified in the relevant use cases in Section 2.

Analysis Administration—This feature set assists the user in integrating the assessments completed in Assessments Administration to produce a consolidated set of outputs and insights that can ultimately be used in presentation building. Analysis Administration can provide users with a best-practices Q&A format for deriving conclusions and recommendations, and for optimal use of the dashboard display formats shown in the accompanying drawings. Presentation Administration—This feature set enables the user to build a Web-based or standalone PowerPoint presentation to the client company containing results and recommendations from the Application implementation. It also provides access to a sample presentation prepared by Cristol & Associates, which may serve as an editable template for the user. 1.5 Identification of Actors—For the alternate software embodiments, focus is on users and not on those responsible for installation and maintenance. Primary user is the Administering Consultant; secondary users are Consulting Team Members (who collectively function as one actor because of similar needs relative to the system) and the Consultant Facilitator, as explained below. The users external to the consulting firm may be limited to interaction with the Consensus Builder tool. Five types of users are identified and described below. Administering Consultant—This is the principal consultant responsible for managing a Application implementation. Though s/he may, on a large-scale implementation, designate certain consulting team members as responsible for managing different portions of the implementation and different subordinate use cases for the software, the alternate embodiment system presumes that the Administering Consultant can provide all inputs to the system, conduct all manipulations of outputs and analysis, and build the presentation of results and recommendations without delegating specific software uses. Team members can simply be able to access the system from inside the consulting firm's firewall to observe implementation status and retrieve information. Consulting Team Members—Team Members are those consulting firm employees authorized by the Administering Consultant to log on to the system to observe implementation status, inputs and outputs. Alternate software embodiments make team access functional to meet the eventual access needs of authorized external contractors such as marketing research firms. Consultant Facilitators—these actors are members of the consulting team—and in some cases may be the same person as the Administering Consultant—who serve as facilitators of in-person Application work sessions with client company personnel. Facilitators may need to access the templates for the easel pad and whiteboard formatting optionally advantageous to capture specific client company inputs to the system during these work sessions. Recordists—In the finished Application application, keyboard recordists may need to access the Consultant Facilitator templates in Section 2's Use Case #3 via the Internet, to make a real-time digital record of the client company work sessions if the Facilitator chooses not to use physical easel pads or whiteboards in the session conference room. Recordist access is not required in alternate software embodiments. Client Company Managers—Selected client company managers in geographies around the world may be asked to provide inputs to the system via the Consensus Builder tool. Until such time as this tool can be integrated into Application software, client company managers may be asked to enter inputs into an Excel version of Consensus Builder that may be distributed via e-mail as an Excel file attachment. More desirably, however, these actors could enter inputs by accessing Consensus Builder forms via the Internet—connecting to a password-protected Web page on the Application server. (The Consensus Builder tool in Excel and has been field tested by Cristol & Associates with client company managers on four continents using Microsoft Outlook for distribution. Alternate software embodiments provide formulae for underlying mathematics may be programmed into Excel and/or performed manually.

Section 2: Use Cases—This Section contains the ten basic use cases to be demonstrated via alternate software embodiments. Use cases reference certain accompanying drawings in which prescribed use of color is of material significance in communicating selected information, and such use of color is described in the text herein; the accompanying drawings are printed in black and white, but are available electronically in color. Ultimately, fully developed software can enable several variations and multiple subordinate use cases, depending on client company circumstances and project complexity. When implementing a Application project, the first nine of the following ten use cases can generally occur in the same sequence—except for Use Case #10, which may occur at any time (and therefore does not appear on FIG. 1 or 2A-2D process flows, since Use Case #10 provides random access to a variety of tools that may be used at any point in the process flow rather than at a prescribed point or in a prescribed sequence.) Use cases are identified and described below:

Use Case #1—Input Brand Drivers Identification. Enter/change identification, description, and categorization of drivers of brand choice (or, alternatively, drivers of category adoption) In practice, except when the client company's product/service competes in a category that is mature, many customers' behavior may be driven by some combination of category adoption drivers and brand choice drivers rather than by brand drivers exclusively. For clarity and simplicity throughout this document, however, primary focus is on drivers of brand choice. Since drivers of either kind may be handled in nearly identical ways by the software, separate use cases are not presented here for category adoption drivers. Rather, where small differences may exist, these are covered in the “Alternative Paths” section of each relevant Section 2 use case. Use Case #2—Input Brand Drivers Prioritization. Enter/change data allowing system to establish the relative priority of each driver. Use Case #3—Prepare for Client Workshops. Access facilitator support tools, such as templates for easel pads/whiteboards to capture optionally advantageous assessment inputs, to assist Consultant Facilitator in preparing for client workshops. Use Case #4—Perform Current Product Portfolio Assessment. Access and populate template for Proof Points Inventory and generate current Competitive Situation Dashboard. Use Case #5—Perform Strategic Alignment Assessment. Assess each product development initiative's alignment with drivers of brand choice. Use Case #6—Perform Competitive Impact Assessment. Assess each product development initiative's likely competitive impact. Use Case #7—Perform Manageability Assessment. Assess the relative burden of each product development initiative. Use Case #8—Integrate Individual Assessments. Merge the three prior assessments to generate blended view of overall strategic importance weighed against development burden. Use Case #9—Build Presentation. Input conclusions and recommendations based on all prior use cases, select outputs from prior use cases for inclusion in presentation to client company, and draft/complete the presentation. Use Case #10—Access Management Tools. Monitor project status and access ROI tool, Request For Proposal (RFP) tool, Consensus Builder tool, Reference Library (including best practices and Application tutorials), and archived projects. Management Tools provides a selected “placeholder” function in alternate software embodiments.

The principal actor for all basic uses cases is the Administering Consultant, except as noted in Use Case #3 situations when the Consultant Facilitator is not the same person as the Administering Consultant. Finally, note that while robust online help is envisioned for the finished application, it may be a placeholder in the alternate software embodiments. However, user interface may indicate Online Help.

Drivers of brand choice (or, alternatively, drivers of category adoption) provide the user with the fundamental building blocks for most of the subsequent Application use cases. These drivers are perceived brand attributes (see definition on page 14 under “Brand Choice Drivers Importance Index”) that constitute the user's first and most critical set of inputs to the system after each new project is set up. These drivers can come from one of three sources outside the system: customer research studies, driver lists supplied by the client company or consulting firm, or directly from the Application Consensus Builder tool (as it currently exists in Excel, though this tool ultimately may be integrated into the software system as a Web-based set of data entry forms and analytics). Accordingly, for purposes of alternate software embodiments, these drivers may be manually entered into the system by the Administering Consultant regardless of which data source is used.

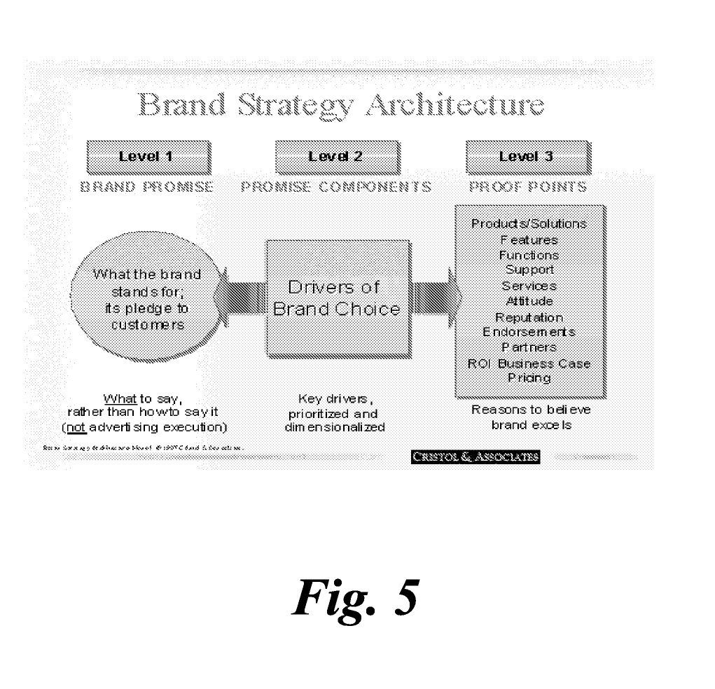

Use Case #1 Pre-Conditions—1. A valid user has logged on to the system. 2. User has been authenticated as Administering Consultant (authorized to enter data, make changes, perform analyses, etc. —vs. other users who are limited to “read-only” browsing access except as specifically indicated in selected use cases). 3. A consulting project has been previously set up and assigned a name and Project ID code. 4. Outside the system, the consulting firm and/or client company has identified, defined, and categorized relevant drivers of brand choice (or, alternatively, drivers of category adoption) to be used in this particular Application implementation. 5. If the client company has a Brand Strategy Architecture (see FIGS. 5, 6 and 7 below), it has been input to the system and is accessible to users in an appropriate graphics compression format.

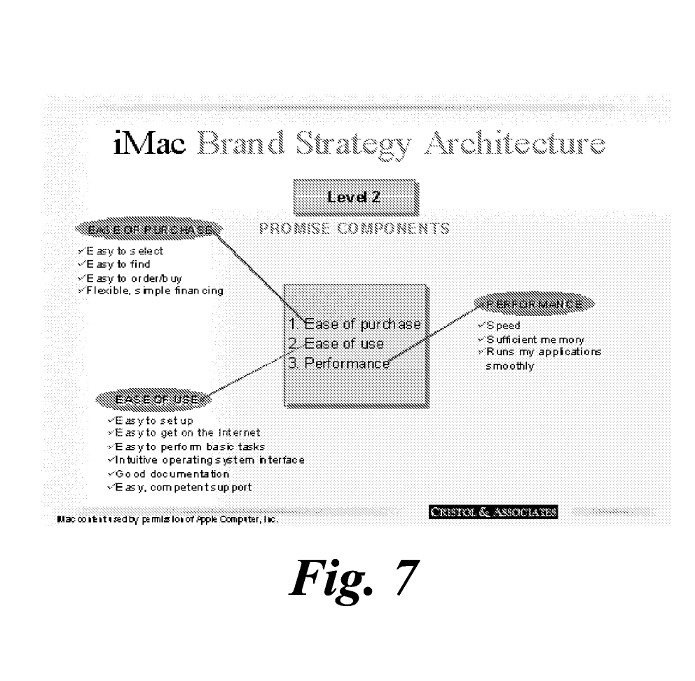

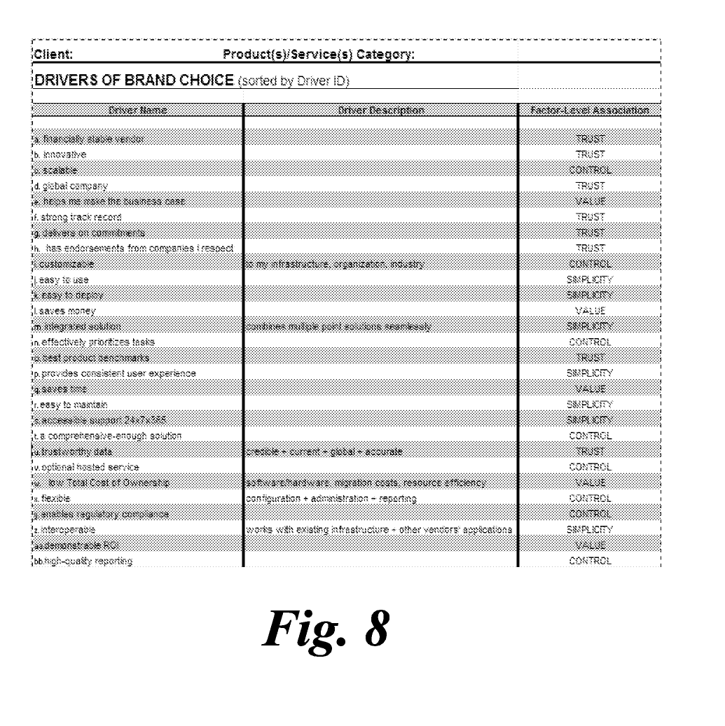

Use Case #1 Flow of Events—1. User (Administering Consultant) enters Project ID code. Code is alphanumeric, eight characters, and formatted as XXX-1111—where the three letters are the client company's name abbreviation or stock symbol, the first two digits signify the year, and the last two digits signify project sequence (example: HPQ-0501, which signifies the first Application implementation conducted for Hewlett-Packard in 2005). 2. User navigates to project home page—the page from which all other basic use cases for this project are accessible via individual links. 3. From a list of use case events (regardless of whether designed as navigation bar, drop-down menu, etc.), user selects “Drivers of Brand Choice.” 4. User preferably may enter the Driver Name for each driver. Maximum number of drivers allowable for one project is 40; each driver name is a maximum of 40 characters. Examples of drivers names are: “Interoperable,” “Delivers on commitments,” “Easily accessible service and support,” “Demonstrable ROI,” etc. 5. For each Driver Name entered, user may [optional] enter a Driver Description. The Driver Description elaborates on Driver Name, providing contextual meaning when the name alone is not confidently self-explanatory. Using an example from a client company in the enterprise software business, for the driver “Interoperable,” Driver Description might be “Works with existing infrastructure and other vendors' applications.” Though Driver Description can usually be just a phrase, occasionally a couple of sentences (maximum 400 characters, including spaces) may be required if driver dynamics are unusually complex. User may be able to hold the cursor over or, alternatively, click on “Driver Description” and see a help balloon or pop-up window that contains the text of the first three sentences in this paragraph (beginning with “For each Driver Name entered, . . . ”). 6. For each Driver Name entered, the user may preferably enter the driver's Factor-Level Association. This refers to a higher-level theme that typically comes from a multivariate statistical technique known as “factor analysis” that is used in customer research studies—showing how a driver like “Interoperable” belongs to (i.e., has a strong relationship with) a higher-level concept like “Simplicity.” As in that example, each driver belongs to, or is a dimension of, some higher-level “factor.” Typically, a total of 20-35 drivers of brand choice can sort into four to eight factors. So, in this example, the user, after entering “Interoperable” as Driver Name and entering the Driver Description, would categorize the driver by assigning it to a factor (in this instance, “Simplicity”) in the Factor-Level Association field. Factor-Level Association can usually be only one word (e.g., “Reliability,” “Performance,” “Simplicity, “Value,” etc.), though may occasionally require up to 30 characters. In selecting the appropriate Factor-Level Association for each driver, it would be helpful to users if the four to eight factors were readily available in a drop-down menu, which would necessitate giving users the opportunity to manually enter the factors earlier in this use case. 7. After data entry is complete for all drivers, user may need to sort drivers in three possible ways: (1) in the original order as entered into the system, (2) alphabetically by driver name, or (3) grouped by Factor-Level Association. The second sort simply displays the drivers alphabetically by Driver Name as entered; the third sort displays, for example, all drivers associated with the “Simplicity” factor, followed by all drivers associated with each of the other factors. For the consultant's shorthand identification of drivers when communicating with the client company, it is helpful if each driver has a letter ID that stays with that driver regardless of how the list is sorted. Accordingly, as drivers are entered into the system, the software may sequentially assign a lower-case Driver ID that displays preceding the first character of the Driver Name (whether or not it appears as a separate column or field). For example, if “Interoperable” was the first driver entered into the system and “Easy to use” was second, they would always appear in any sort as “a. Interoperable” and “b. Easy to use” unless the user requests “Switch off driver ID's.” (Letters may be be used for ID's since numbering them would imply relative importance—and relative importance may be described numerically in Use Case #2, separate and distinct from driver identification. If there are more than 26 drivers, exhausting the alphabet, Driver ID can go to double letters (aa., bb., etc.) So the user does need to be able to switch ID's on and off for different purposes, but not for selected individual drivers; rather, all ID's are either turned on or all are turned off. 8. User may need ability to easily print a 3-column hard copy that fits to one page showing all input entered (or a selected subset)—displaying for all drivers the Driver ID, Driver Name, Driver Description (where applicable), and Factor-Level Association. (This could be four columns depending on whether Driver ID for each driver displays as a separate column or is integrated into the Driver Name field as in the example shown below.) FIG. 8 illustrates how an “as entered” sort currently appears in Excel. 9. User may need to add, change, or delete drivers, descriptions, or factor associations at any time after initial completion of Use Case #1 data entry. User may need to save different iterations or sorts. And, finally, the user may need to consolidate driver list by combining certain drivers—sometimes creating a new driver name and/or description in the process. 10. For return visits to this page, user may now choose a default display from the three types of sorts (Driver ID, Driver Name, Factor Association). In the next visit, if the user has skipped this step, data can display in the same sort last used.

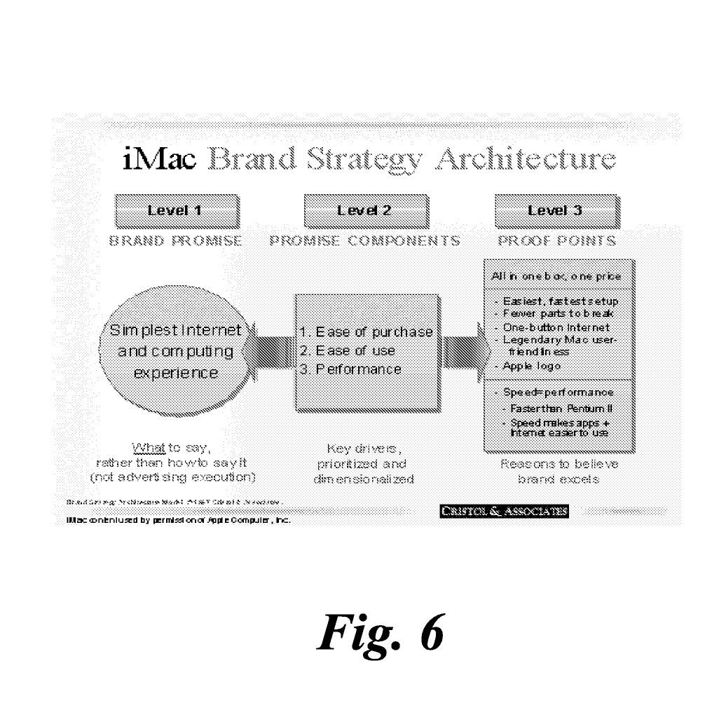

Alternative Paths: After Step 2, user may wish to click on “Brand Strategy Architecture” to view the architecture if there is one (see #5 in Pre-Conditions above, and sample architecture in FIGS. 6 and 7). If so, the architecture displays as in the FIG. 6 example. Also after Step 2, user may wish to enter, edit, or view market segment profiles. If user chooses to enter, system presents three fields for each segment (maximum eight segments): a “Segment Name” field (maximum 25 characters), a “Segment Profile” field (maximum 400 characters), and a “Source Research” field, in which the user enters the name of the source segmentation study (maximum 100 characters) where more information can be found. System may also allow user to enter a link to the segmentation study, which may be external to the system or, in the alternate software embodiments application, may be stored within it. (Research storage not required in alternate software embodiments.)

At Step 3, user selects “Drivers of Category Adoption” in lieu of “Drivers of Brand Choice.” All subsequent data entry is the same from a software standpoint. Only the display heading changes (“Drivers of Brand Choice” becomes “Drivers of Category Adoption”). The finished application can allow the user to enter both sets of drivers separately and then combine them in different ways but this is not required in alternate software embodiments.

At Step 5, if user chooses not to enter Driver Descriptions (or if they are entered but later deemed inconsequential for certain purposes), user will want the flexibility to hide the Driver Description column when displaying and/or printing the data.

After Step 6, user may wish to use the Brand Strategy Architecture interactively—to the extent that the user could click on any of the factor-level drivers of brand choice that appear in the architecture's center box (“Promise Components”) and see a balloon or pop-up that lists the dimensions of that driver. For example, a user could click on (or hold the cursor over) “Performance” in the example in FIG. 5 and see that “Performance” consists of several specific driver dimensions (FIG. 7) such as speed, memory, and smooth running of software applications. When relevant, the system can already have this factor association data stored after Step 6 is completed, since Factor-Level Associations may have been entered then (e.g., in Step 6 Performance would have been entered by the user in the Factor-Level Association field for each driver).

Use Case #1 Post-Conditions—All use case data entry is saved in the system, available for Administering Consultant to access, add to, modify, sort, or delete, and is accessible to other valid users on a read-only basis. When this use case ends, user may either log off or proceed to other use cases.

Use Case#2—Input Brand Drivers Prioritization—With brand drivers now in the system—coded, named, described (where applicable), and linked to factors, they now may be prioritized in terms of strategic importance to the client company's brand. Use Case #2 enters inputs from sources external to the system and then calculates the Brand Choice Drivers Importance Index (as defined in “Terms and Definitions”). Ultimately, Application software may be able to import the correlation coefficients described below directly from Excel (see FIG. 10) or other data file formats commonly used by marketing research firms in generating these coefficients, but for alternate software embodiments all data in Use Case #2 may be manually entered.

Use Case #2 Pre-Conditions—The first three pre-conditions of Use Case #1 are also applicable here. Alternatively, the Administering Consultant user may be coming to Use Case #2 directly from other use cases (especially Use Case #1) without logging off and back on. Additional pre-conditions: 1. All relevant data from Use Case #1 have been previously entered and stored in the system. 2. Outside the system, the consulting firm and/or client company has prioritized the brand choice drivers (or, alternatively, drivers of category adoption) either by: (1) calculating brand choice correlation coefficients for each driver in a brand choice modeling research study, or (2) driving consensus internally among client company managers, with proxy correlation coefficients derived from use of the Application Consensus Builder tool. Specifications for Consensus Builder are not included in this document; prototype Strategic Harmony® software may initially show a non-functional Consensus Builder as a placeholder in navigation, and as a fixed sample template for display purposes as described in this use case. Future versions of the Master Use Case can provide feature specifications for all uses of the Consensus Builder tool, with appropriate subordinate use cases. Consensus Builder is currently prototyped in Excel as shown in FIGS. 8, 10, and 11. Either in lieu of, or in addition to, coefficients, the consulting firm or client company may also have assigned each driver a simple importance ranking and/or an “importance tier”—e.g., sorting the drivers into four quartiles that are simply called “Tier I, “Tier II,” etc.

Use Case #2 Flow of Events—1. User (Administering Consultant) enters Project ID code. 2. User navigates to project home page and selects “Drivers of Brand Choice.” The data entered in Use Case #1 displays. 3. User is presented with option to either “Configure relative importance of drivers” or “Skip relative importance.” Upon selecting option to configure, user is presented with three choices: (1) “Enter correlation coefficients,” (2) “Enter proxy correlation coefficients from Consensus Builder,” or (3) “Skip coefficients to enter importance rankings or assign importance tiers.” 4. If user selects either “Enter correlation coefficients” or “Enter proxy correlation coefficients,” s/he can enter for each driver a numeric value greater than zero and less than 1, to two decimal places—i.e., between 0.01 and 0.99. (Ultimately, the software can automatically import proxy coefficients from the Consensus Builder tool when proxy coefficients are selected, but this not a requirement for alternate software embodiments.) Alternatively, if user elects to skip coefficients altogether, s/he can proceed directly to the next event. 5. User can now elect to enter, for each driver, either an “Importance Ranking” or an “Importance Tier,” or both. An importance ranking can simply be an integer greater than or equal to 1 and less than 100. Importance tiers may be expressed in Roman numerals, from “Tier I” through “Tier IV.” (User may be able to specify using fewer than four tiers when the list of drivers is relatively short, but four tiers may be the maximum.) When the user enters rankings and also requests the option to enter tiers, the software may automatically assign the appropriate tier to each driver by dividing the total number of rankings by four. For example, if there are 32 drivers in total, ranked 1 through 32 in importance, the software may automatically assign drivers ranked 1-8 to Tier I, drivers ranked 9-16 to Tier II, etc. However, user may be able to override automated tier assignments after they occur, as occasionally circumstances can suggest that tiers may not be evenly divided—requiring a manual adjustment. 6. User may need ability to easily print a 4-column hard copy that fits to one page showing Driver Name in Column A. Although MS Excel column headers do not literally appear in any of the screen shots in this document, occasionally the use case text may use the Excel convention of lettered columns (e.g., “Column A”=the first column, B=the second, etc.) to identify specific columns in the graphics display being described, Correlation Coefficient (or proxy coefficient) in Column B, Importance Ranking in Column C, and Importance Tier in Column D. User may have the flexibility to hide columns B, C, or D. 7. Ideally, user can now append Columns B, C, and/or D to the three columns in Use Case #1, producing a matrix of up to six columns in which any column other than Driver Name can be hidden or dragged and dropped to change the order of column display. Default display at this point in this use case may hide Driver Description (from Use Case #1) and display the remaining five columns in the following sequence, left to right: Driver Name>>Importance Ranking (displays ranking integer)>>Correlation Coefficient (displays coefficient or proxy coefficient)>>Importance Tier>>Factor-Level Association. (This assumes that Driver ID displays in the same column with Driver Name as discussed in Use Case #1 but, if ID is better handled by the software in a separate column, that solution may be carried through in this and subsequent use cases as well.) 8. If correlation coefficients or proxy coefficients were entered into the system in Step 4, user may now want the software to translate coefficients into a Brand Driver Importance Index for each driver—with the highest coefficient translating to an index of 100 and all other drivers' coefficients indexed against that. If no coefficients were entered, this Step 8 is skipped. 9. To see a high-level recap of results of this use case, user may select “Display Brand Driver Importance Indices.” System then displays all Driver Names and the corresponding Brand Driver Importance Index, sorted by the index in descending order, and with the option to display Factor-Level Association as a third column if user desires.

Alternative Paths: At Step 2, user navigates to “Drivers of Category Adoption” in lieu of “Drivers of Brand Choice.” All subsequent data entry is the same from a software standpoint. Only the display headings change (“Drivers of Brand Choice” becomes “Drivers of Category Adoption”) in subsequent steps, and “Brand Driver Importance Index in Step 9 becomes “Category Driver Importance Index.”) Alternate software embodiments may allow the user to enter both sets of drivers separately and then combine them in different ways, but this is not required in alternate software embodiments. At Step 3, user selects “Skip relative importance” and this use case ends. (If user does not select “Configure . . . ,” it is mandatory that user goes through the step of electing to skip before proceeding to Use Case #3.) At Step 5, user mayn't have to enter importance rankings if correlation coefficients were already entered in Step 4—since correlation coefficients provide the best basis for rankings, the software may be able to automate Step 5 by supplying rankings based on the coefficients. The higher the coefficient value, the higher the ranking (In case of a tie between two or more coefficients, their corresponding Driver Names may show the same ranking integer; for example, if the top five coefficients are 0.82, 0.75, 0.75, 0.66, and 0.58, the rankings for corresponding Driver Names may appear, respectively, as 1, 2, 2, 4, 5.) With automation of rankings, user may be able to simply request that the system populate the Importance Ranking fields based on the coefficients.

Use Case #2 Post-Conditions All use case data entry is saved in the system, available for Administering Consultant to access, add to, modify, sort, or delete, and is accessible to other valid users on a read-only basis. When this use case ends, user may either log off or proceed to other use cases.

2.3 Use Case #3—Prepare for Client Workshops—Each Application implementation requires a skilled facilitator (the “Consultant Facilitator” actor described on page 22, abbreviated as “Facilitator” in this Use Case #3) to work face to face with the client company team in a workshop setting. In some instances, the Facilitator may be the same person as the Administering Consultant; in others, s/he may be a different employee of the consulting firm. In this Use Case #3, the Facilitator may access various support tools in the software's “Facilitator Support Center” to prepare for and develop materials to use in these client company workshops. The Facilitator may typically conduct two workshops (the number depends on client company circumstances) to capture inputs that may be entered into the system prior to Uses Cases #4-#7, in which the core Application assessments may be generated. The first workshop is referred to by the consulting team as the “Proof Points Session,” and the second as the “Portfolio Session” (shorthand for “Development Portfolio Assessment Session”). This Use Case #3 describes the flow of events required when the Facilitator accesses the system to prepare workshop agendas, work out precise timing and pacing targets (for what is typically a very time-constrained session in which a lot of material is covered), and prepare the easel pads and/or whiteboards that may be used in the workshop conference room. In preparing layouts/content for the easel pads and whiteboards, the Facilitator accesses pre-formatted templates as well as content already entered into the system in Use Cases #1 and #2. In alternate software embodiments, the Facilitator may access sample materials and the templates for the easel pads/whiteboards, along with instructions for their use. Ultimately, alternate software embodiments may largely automate the process of populating those templates with selected content from the first two use cases (and, alternatively, may offer the option of manual entry), and may perform timing and pacing calculations based on the workshop agenda and on the number of brand drivers and product development initiatives to be assessed. But these functions are not required in the alternate software embodiments.

Use Case #3 Pre-Conditions—The first three pre-conditions of Use Case #1 are also applicable here; however, Facilitator may have been authenticated as either: (1) Administering Consultant, if the same person, or (2) “Facilitator,” in which case s/he has read-only access to all other use cases but has full access to this Use Case #3. In either instance, the Facilitator may be coming to Use Case #3 directly from other use cases (especially #1 or #2) without logging off and back on. But the flow of events below presumes that the Facilitator is logging on to engage directly in Use Case #3, which is more likely. Additional pre-conditions: 1. All relevant data from Use Cases #1 and 2 have been entered and stored in the system. 2. As specified in Steps 4, 5, 7 and 8 below, sample workshop agendas, timing guidelines and worksheet, sample briefing presentation, and easel pad/whiteboard templates have been entered in the system during software development. (Ultimately, templates may be augmented with online help and a Reference Library tutorial to insure successful use in actual workshop environments, but this may not be required in alternate software embodiments.)

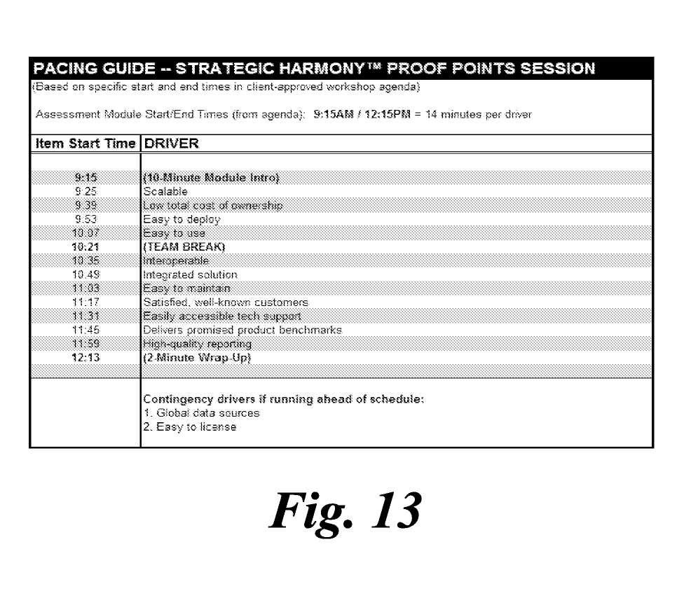

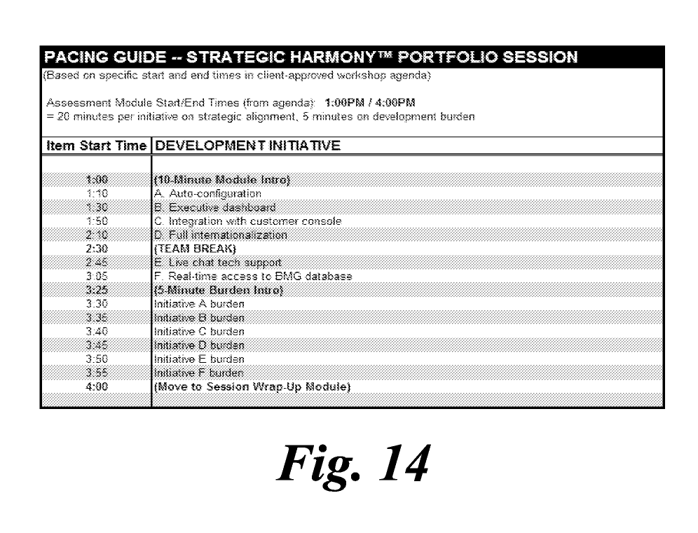

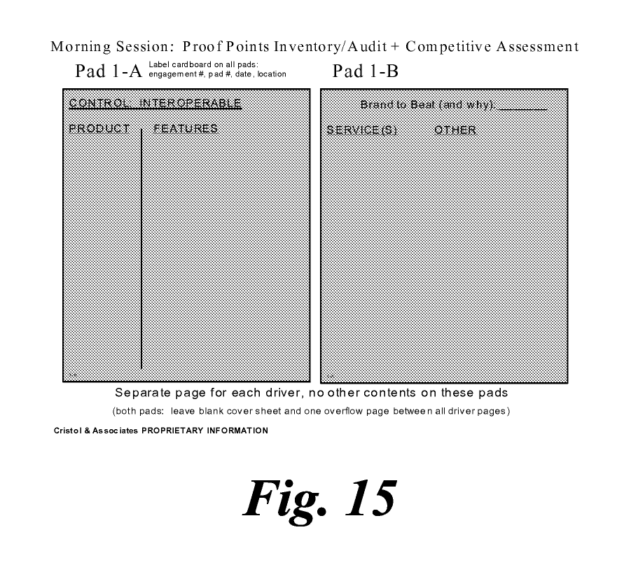

Use Case #3 Flow of Events—1. User enters Project ID code; 2. User navigates to project home page and selects “Facilitator Support Center”—where sample workshop agendas, guidelines for timing and pacing, workshop team briefing presentations, and templates for workshop easel pads/whiteboards all reside. From here, user may also link to Facilitator Tutorials in the Reference Library (see “Alternative Paths” below). 3. User is presented with a facilitator support menu that offers four options: (1) Access workshop agenda builder (2) Access timing guidelines and pacing calculator (3) Access workshop briefing presentation builder. Workshop briefing presentations are not to be confused with the Strategic Harmony® presentation of results and recommendations, which is the focus of Use Case #9. Workshop briefing presentations, which are typically less elaborate, are used by the Consultant Facilitator in the workshop setting to orient the client company team for their effective participation in the workshop's activities. (4) Access easel pad/whiteboard templates. The remainder of Use Case #3 presumes that the user accesses each of the four options in numbered sequence, though in practice the user may access any of the four in any sequence. 4. User selects “Workshop Agenda Builder.” System presents three options: (1) Half-Day Proof Points Session Agenda, (2) Half-Day Portfolio Session Agenda, (3) Full-Day Combined Session Agenda. When user selects any option, system presents a sample agenda (which currently exists as a one-page Microsoft Word document). User may be able to edit each agenda, save edits to the system, e-mail agenda to client company for approval (though actual e-mail functionality is not required in alternate software embodiments), and print hard copies for distribution in the actual workshop. For each agenda type, user may also be able to access an “Agenda-Building Tutorial”—which may not be live in the prototype but may signify the eventual online accessibility of helpful text, including considerations in building an effective agenda for each session and tips on contingency planning 5. User returns to facilitator support menu and selects “Timing Guidelines and Pacing Calculator.” System presents three options: (1) Half-Day Proof Points Session, (2) Half-Day Portfolio Session, (3) Full-Day Combined Session. When user selects any option, system asks user if s/he has already stored a client-approved agenda for this workshop. If “No,” system retrieves the default sample agenda (as in Step 4) of the type selected; if “Yes,” system retrieves the most recently saved agenda for this Project ID. Along with the agenda presented, system also presents Session Timing Guidelines text for that session and a link/button for “Pacing Calculator”—a tool to calculate pacing targets (i.e., how many minutes may be allotted in the workshop for each brand driver and for each product development initiative to be covered), which are critical to keep the facilitator on track in an actual workshop. 6. After reading Session Timing Guidelines, which also instruct the user on what inputs s/he may need in using the Pacing Calculator to create “Pacing Guides,” user clicks on Pacing Calculator button/link. Calculator tool asks for two inputs [mandatory] to create a Pacing Guide for each type of session: the Proof Points Session Pacing Guide requires entry of (1) Number of Drivers (numeric field, maximum two digits) and (2) Driver Name for each driver (maximum 40 characters) System may be able to supply Driver Names automatically from Driver Names entered in Use Case #1, Step 4, and drivers may display here in order of Importance Rankings (i.e., driver ranked #1 in importance displays first) entered in Use Case #2, Step 5.; the Portfolio Session Pacing Guide requires (3) Number of Development Initiatives (numeric field, maximum two digits) and Initiative Name (maximum 40 characters) for each initiative. Since the optimum total number of “cells” in a single Application implementation is about 60 to 70 (e.g., 10 Drivers×7 Initiatives), system may ask user “Are you sure?” if the product of multiplying Number of Drivers times Number of Development Initiatives entered by user is greater than 72. User may either respond “No” and re-enter one or both inputs, or may respond “Yes.” User may then have the option to select “Generate Pacing Guide” for any of the three types of work-shop sessions, as shown in the examples below. (Pacing calculations may be made based on total agenda time allotted for drivers and initiatives, divided by the number of drivers and number of initiatives that were entered by user, but alternate software embodiments need not perform these calculations and can instead simply display a sample Pacing Guide for each type of session like the samples shown below.) User can select “Proof Points Pacing Guide only,” “Portfolio Pacing Guide only,” or “Pacing Guide for both sessions.” Depending on which session is selected, each of the half-day session guides below may display separately, or may display together if user selected “Pacing Guide for both sessions.” An example of the Proof Points Pacing Guide is shown in FIG. 13; an example of a Portfolio Pacing Guide is shown in FIG. 14. (In FIG. 14, note that Development Initiative names may each display with a letter ID, sequentially—i.e., A, B, C, etc.). User may be able to edit pacing guides and save edits, since client company circumstances sometimes dictate spending a little more or a little less time on certain drivers and initiatives rather than spending equal time on each one (equal time being the default that the Pacing Calculator would automatically prescribe, since it divides a fixed amount of time by a fixed number of drivers/initiatives). 7. User returns to facilitator support menu and selects “Workshop Briefing Presentation Builder.” Sample briefing presentation (referenced in Pre-Condition #2, which currently exists in MS PowerPoint) displays. Ultimately, user may be able to edit and save, but alternate software embodiments can just display presentation as read-only and indicate “Edit” and “Save changes” functionality without actually providing it. 8. User returns to facilitation support menu and selects “Easel Pad/Whiteboard Templates.” System then presents three choices: (1) “Proof Points Session Templates only” (2) “Portfolio Session Templates only” (3) “Display all templates” If user selects option #3, “Display all templates,” all facilitation templates as shown in FIGS. 14, 15 and 16 may graphically appear as described below (template ID #'s, like “Pad 1-A,” correspond to the exhibits as labeled in FIGS. 15, 16 and 17):

Proof Points Session Easel Pads/Whiteboards—Capturing Proof Points and Current Competitive Assessment Inputs Pad 1-A and Pad 1-B display side by side (as that is how they are always used, in conjunction with each other). Whiteboard 1-C displays below the pad templates. Portfolio Session Easel Pads/Whiteboards—Capturing Product Development Portfolio Assessment Inputs Pads 2-A, 2-B, and 2-C display side by side (always used in conjunction with each other). Whiteboard 2-D displays below the pad templates. Templates may initially display as thumbnails if space constraints dictate. For each template, user may also wish to view detailed instructions for actual use of the completed template in a workshop situation (e.g., via a link to “Instructions for using this template in a workshop”). If the user selected an option other than #3 (“Display all templates”) above, the selected templates may display. Upon clicking on the Pad 1 set (A and B always together), Pad 2 set (A, B and C always together), Whiteboard 1, or Whiteboard 2, user is presented with two choices for that particular template: (1) use Facilitation Template Wizard to prepare template for workshop, or (2) prepare the templates manually, in which case the user may have the option to view the instructions for manual preparation (these instructions for preparing templates are separate and distinct from the instructions for actually using them in a workshop). Alternate software embodiments does not require a fully functional wizard, manual preparation instructions, or data entry for manual preparation by the user, but it may indicate the presence of all three. In alternate software embodiments, a query box may ask the user a series of questions if wizard has been selected and may produce completed templates—by importing data stored from other use cases—that can be printed to hard copy for offline use by a graphics person who may then reproduce/recreate them on the actual easel pads and whiteboards prior to the workshops. Also, alternate software embodiments may provide optionally advantageous data entry fields to users selecting manual preparation.

Alternative Paths: At Step 2, user may access a link to Facilitator tutorials in the Reference Library, which then presents a menu of four tutorials that correspond to the four subject areas in the Step 3 menu above: (1) Developing Workshop Agendas, (2) Timing and Pacing, (3) Workshop Briefing Presentations, and (4) Using Easel pad/whiteboard templates. These are placeholders in alternate software embodiments; alternate software embodiments includes the tutorials content. At Step 6, if user doesn't yet know the number of development initiatives, s/he may still need a pacing guide for the Proof Points Session. In this instance, after user clicks on “Pacing Calculator,” Number of Drivers may be the only mandatory input (unless the Number of Initiatives field offers a “Don't know” option). Then user can proceed directly to “Generate Pacing Guide” to get a guide for the Proof Points Session only.

Use Case #3 Post-Conditions—All use case data entry is saved in the system, available for Consultant Facilitator or Administering Consultant to access, modify, or delete, and is accessible to other valid users on a read-only basis. When this use case ends, user may either log off or proceed to other use cases.

2.4 Use Case #4—Perform Current Product Portfolio Assessment. Once the first Application workshop—the Proof Points Session—has been completed, the consulting firm has the necessary inputs for performing an assessment of the client company's current product portfolio. In Use Case #4, those inputs are entered into the system and the Administering Consultant uses the system to prepare a Proof Points Inventory, perform the current portfolio assessment, and generate outputs to be used later in building a presentation of findings and recommendations. Entering inputs for this assessment (through Step 7 below) may be performed by either the Facilitator or the Administering Consultant, but only the Administering Consultant is authorized to actually perform the assessment (Step 8).

Use Case #4 Pre-Conditions—The first three pre-conditions of Use Case #1 are also applicable here. Alternatively, the Administering Consultant may be coming to this Use Case #4 directly from other use cases without logging off and back on. Additional pre-conditions: 1. All relevant data from Use Cases #1 and #2 have been previously entered and stored in the system. 2. Outside the system, the consulting firm has completed the Proof Points Session with the client company. The user in this use case now has in his/her possession the completed physical Easel Pads 1-A and 1-B from the workshop, as well as a hard copy of Whiteboard 1-C.

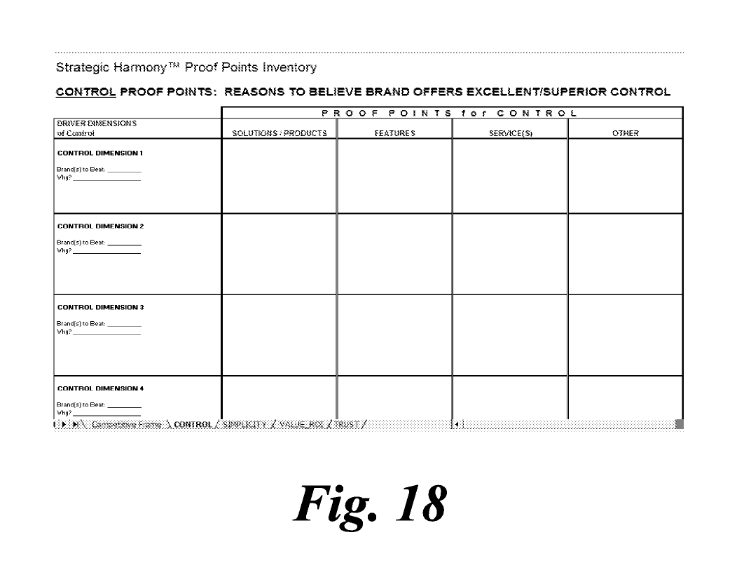

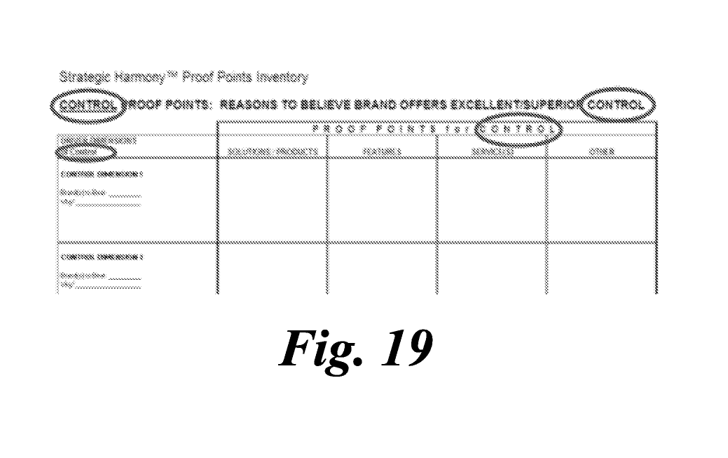

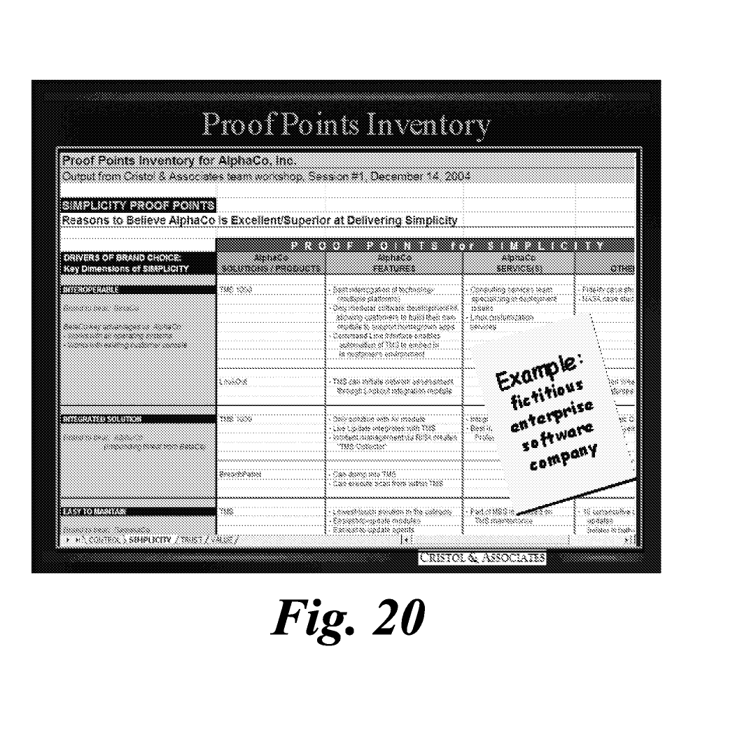

Use Case #4 Flow of Events—1. User enters Project ID code. 2. User navigates to project home page and selects “Current Product Portfolio Assessment.” 3. User is presented with four options: (1) Enter/modify assessment inputs (2) Perform/update assessment (3) View assessment (4) Print assessment In the user's initial visit to this module for this Project ID, or unless this assessment has already been performed in a previous visit, user may select option #1. Once those inputs have been entered and stored in the system, user may alternatively select any of the other options. (In subsequent user visits to this assessment module, if user selects option #3 or 4 without yet having performed the assessment in option #2, user can still view or print just the inputs without a performed assessment. If the assessment has been performed in a previous visit in Step 8 below, here the user may select any of the four options above in any sequence—option #1 to make changes in the inputs, option #2 to update the assessment based on those changes, or options #3 or 4 may be selected first to view or print the last assessment stored in a previous visit. Users other than Administering Consultant are only allowed to access options #3 and 4; if they attempt to access either of these options before assessment inputs have been entered by the Administering Consultant, the system may inform them that viewing/printing is unavailable because assessment inputs are not yet entered. If inputs have been entered but the assessment (Step 8) not yet performed, users may view or print inputs but the system may inform them that the completed assessment is not yet available.) 4. User has selected option #1, “Enter/modify assessment inputs,” and is now prepared to enter the required inputs to build the Proof Points Inventory. An example Proof Points Inventory format and content is shown in FIG. 20 as prototyped in Excel. (FIG. 18 shows the basic template structure before populating with content and design features.) The system may present a sequence of matrices as described below for the user to fill in, field by field. (Notice in FIG. 19 how each high-level driver of brand choice—i.e., each “factor,” such as “Control,” “Simplicity,” “Trust,” etc. —has its own inventory matrix, formatted as a separate page for each factor in the Excel workbook example shown). However, for the system to know which matrix to present, it may be first present to the user a menu that includes all “factors” (stored during Use Case #1, Step 6, as “Factor-Level Associations” assigned by the user); typically, four to seven factors may already be stored in the system. User may now select any of the factor matrices on the menu in any sequence.

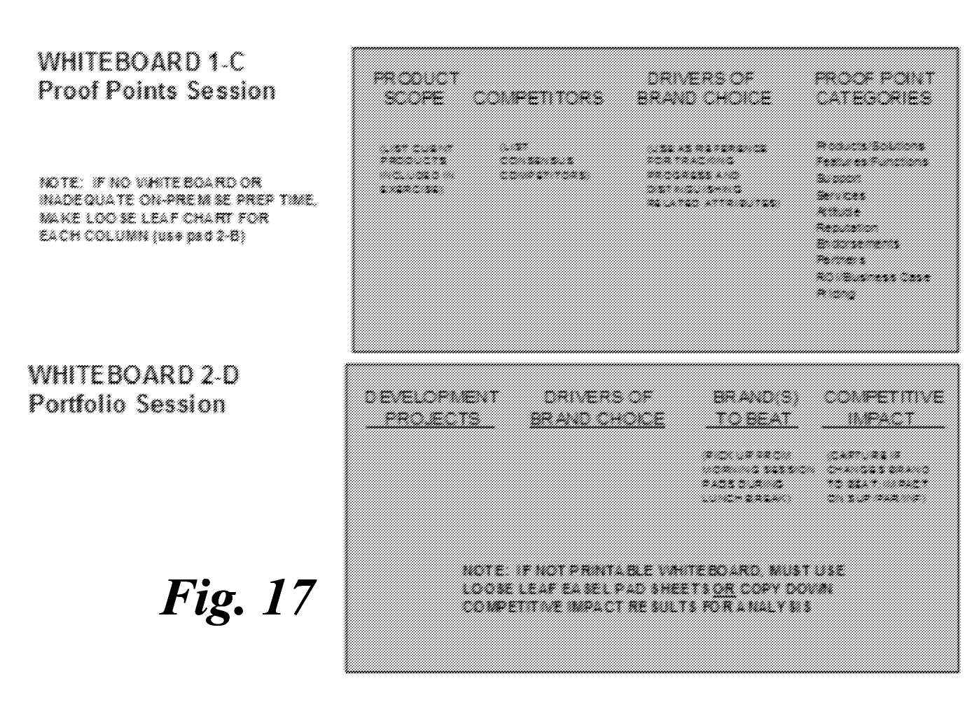

5. For each factor matrix selected, user may preferably enter the number of “driver dimensions” s/he wishes to display in Column A of the matrix. Entry may be a number from 1 to 10, or user can select “All.” Then, the following occurs for each matrix. First, the template shown in FIG. 18 appears for the factor selected by the user, with the selected factor name automatically displaying in the template's various headings (see the four places circled in FIG. 19 where the example factor name is “Control”). All column headings of FIG. 18, and all Column A row headings, also display; however, in the Column A fields that say “CONTROL DIMENSION 1,” “CONTROL DIMENSION 2,” etc., the system automatically substitutes the actual names (and descriptions, when available) of the drivers of brand choice entered in Use Case #1 (Driver Name field from Use Case #1, Step 4, and Driver Description field from Use Case #1, Step 5) that are dimensions of “Control” (i.e., dimensions are the drivers that were assigned to “Control” in the “factor-level association” field in Use Case #1, Step 6). In each matrix template, these drivers may display in descending order of their Brand Driver Importance Index (if indices were calculated in Use Case #2; if not, use importance ranking) Importance ranking and tier assignments (e.g., Tier I, Tier II, etc.) from Use Case #2 may display as well. So, for example, if “Customizable” was the highest ranking driver assigned to the “Control” factor as entered in Use Case #1, it would display here in the first cell of Column A on the Control matrix as follows (in place of “CONTROL DIMENSION 1”): CUSTOMIZABLE [94/2/Tier I]. This indicates that “Customizable” has a Brand Driver Importance Index of 94 as calculated in Use Case #1 Step 8, has an Importance Ranking of 2 out of all the drivers ranked in Use Case #1 Step 5, and was also assigned to Tier I in that step. If any of these three measures are unavailable in the system, its field within the brackets shown above may display “--” or “N/A.” 6. In Column A (see FIG. 17 where, under each driver, the template says “Brand to beat” and “Why?”), user enters name of brand(s) to beat and, under that in a separate field, enters reason(s) why. User repeats these two actions for each factor matrix. “Brand to beat” field may accommodate up to four brand names, each up to 20 characters, since sometimes multiple brands are at parity with each other as best in class on a particular driver. (“Unknown” may also be offered as an option in the “Brand to beat” field, for situations when competitive intelligence is too weak to determine a leader.) The “Why?” field may accommodate text up to approximately 100 characters, though most entries may be much shorter. Entering “brand to beat” is mandatory; “Why?” is optional, but failure to enter a reason why may prompt a reminder (e.g., “Are you sure you want to skip ‘Why?’”) if user tries to proceed to another driver or activity directly from entering “Brand to beat.”

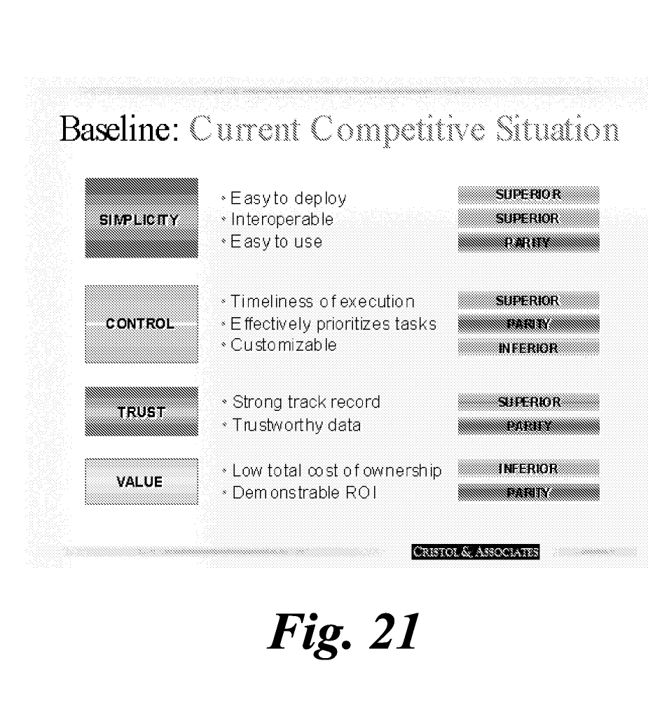

7. User enters proof points text in matrix Columns B, C and D. Each cell needs flexible capacity, as some cells may be left empty (so all cells may be optional) and others may contain as many as 10 bullet points (though 2 to 5 is most common). User repeats this step for each factor matrix. Typical user motion may be to complete Columns B, C, and D cells moving across for each driver rather than doing all Column B cells first, but user may have flexibility to do cells in any sequence. If no proof points are entered anywhere on the currently displayed factor matrix, user may be prompted to enter proof points [optional] before skipping to a different factor matrix. When Proof Points Inventory is complete (FIG. 20 example), user may be able to create a PDF version to print or e-mail to client company. 8. The Administering Consultant user returns to the menu from Step 3 and chooses “Perform/update assessment.” User is prompted to “Create Competitive Situation Dashboard” (FIG. 21) and chooses to proceed. (User may have the option to skip but, if skipping, may be prompted “Are you sure?” since this step may eventually have to be completed before the full assessment can be finished.) The system derives the Dashboard content from a combination of data already used in Step 5 above plus data entered by the user in Step 6, and may automatically populate the Dashboard template. Specifically, note in FIG. 21 that the Dashboard consists of three content elements: (1) a list of brand drivers on the left; (2) a color-coded bar labeled “Superior,” “Parity,” or “Inferior” on the right, where green color bars are used for “Superior,” amber color bars for “Parity,” and red color bars for “Inferior;” (3) the factor-level association for each group of drivers (just to the left of the driver list). The driver names already reside in Column A of each factor matrix in the Proof Points Inventory in Step 5 above (originating from the Driver Name field in Use Case #1). The factor names also already reside in the heading of each factor matrix in Step 5. And the data required to determine “Superior”/“Parity”/“Inferior” reside in the “Brand to beat” field from Step 6. For any particular driver, if user entered only the client company's brand in the “Brand to beat” field in Step 6, that translates to “Superior” since the client's brand has been determined to be best in class on that driver. If user entered the client company's brand along with one or more competitor brands in the “Brand to beat” field for that driver, this translates to “Parity.” Finally, if the user did not enter the client company brand in the “Brand to beat” field, this translates to “Inferior”—unless “Unknown” was entered as brand to beat. In the case of “Unknown,” the Dashboard may show a gray color-coded bar with the text “UNKNOWN” (in lieu of the green SUPERIOR/amber PARITY/red INFERIOR bars otherwise used).

Completed/updated Dashboard now displays as in FIG. 21. Any subsequent changes made to “Brand to beat” fields in future user visits may automatically update the Superior/Parity/Inferior/Unknown color-coded bars on the Dashboard.

9. User now returns to the Step 3 menu and chooses “View assessment,” and is given the option to view Proof Points Inventory, Competitive Situation Dashboard, or both. User's choice triggers appropriate display. When the completed Proof Points Inventory displays, the system also provides an opportunity (e.g., a button) for users to “Collect proof points diagnostics.” If user clicks on that button [optional], system counts and displays: (1) the total number of bullet-text proof points (again, see FIG. 20) in the “Features,” “Service(s),” and “Other” columns combined. Note that the “Solutions/Products” column is omitted from the tally since its primary use is to identify which products the proof points in the next three columns belong to. across all factors (i.e., all matrices, or “pages,” in the compete inventory); (2) the total number of bullet-text proof points for each factor (each individual matrix, or “page”), listed in descending order; (3) the total number of bullet-text proof points for each driver, listed in descending order. So results in this example might appear as follows (content, not design): PROOF POINT TALLIES TOTAL INVENTORY 215 By Factor:-CONTROL 73-SIMPLICITY 62-TRUST 48-VALUE 32 By Driver:-Easy To Use 29-Strong Track Record 27-Interoperable 23-Demonstrable ROI 18-Integrated Solution 17, etc.

Results display includes a button to “Calculate pre-emptive language incidence.” In the competitive context of the Proof Points Inventory, “pre-emptive language” refers to any of the following superlative words used in the entered text of the listed proof points (reasons for customers to believe that the client company excels on a particular brand driver): “best,” “most,” “first,” “fastest,” etc., plus other superlative words that the user may add to the list as described above. Consultants are trained to urge the client company to strive for pre-emptive words in proof points language whenever they can be legitimately claimed; this incidence of superlatives is another data point for how strong or weak the client company's current story is on any specific driver of brand choice as well as across all drivers. This function asks the system to search for specified superlative words in the text of the Proof Points Inventory User chooses to do so, and system presents a list of the following default superlatives—to which user may add custom words—that the system may search for in the bullet points text in the “Features,” “Service(s),” and “Other” columns (see FIG. 20) within all drivers and across all factors: Best, First, Most, Only, Fastest, Easiest, Least, #1, or a specified other. The system counts the incidence of these words and reports them only in the aggregate (the incidence of each individual word is irrelevant; it's the incidence of all superlatives, taken together, that matters), then calculates the percentage incidence by driver based on the totals reported in “Proof Point Tallies” above, and displays the results alongside the tallies as follows (content, not design): PROOF POINT TALLIES-215-PRE-EMPTIVE LANGUAGE INCIDENCE: Occurrences-84|% of Proof Points-39%|TOTAL INVENTORY-215

By Factor:-CONTROL 73|34|47%-SIMPLICITY 62|21|34%-TRUST 48|25|52%-VALUE 32|4|13%

By Driver:-Easy to use 29|9|31%-Strong track record 27|13|44%-Interoperable 23|7|30%-Demonstrable ROI 18|2|11%-Integrated solution 17|8|47%-etc.

Finally, the user may choose to audit these results by asking the system to “Show me superlatives found.” Since words like “most” may occasionally occur in proof points in a context other than superlative (e.g., “most of the time,” rather than “rated the most effective product by customers”), user may be able to locate right on the inventory each superlative that was found and be able to manually exclude it from the incidence totals. After this is done, system can re-calculate and re-display results.

10. User may now elect to print or create PDF of the Proof Points Inventory and/or Competitive Situation Dashboard. Alternatively, user may use the Step 3 menu's option #4 to do the same in future visits. (Alternate software embodiments may provide ability to e-mail PDFs to client company or consulting colleagues, via Microsoft Outlook, without having to manually open Outlook and attach file, but this is not necessary in the prototype.)

Use Case #4 Post-Conditions—All use case data entry is saved in the system, available for Administering Consultant to access, modify, or delete, and is accessible to other valid users on a read-only basis with the exception that the Consultant Facilitator may also modify or delete data through Step 7 (the Proof Points Inventory, but not the Dashboard). When this use case ends, user may either log off or proceed to other use cases. In future visits, any user may be able to access any of the different factor matrices in the Proof Points Inventory in any sequence.

2.5 Use Case #5—Perform Strategic Alignment Assessment—Use Case #5 performs the first of three Application assessments of the client company's product development portfolio, in which each development initiative—products, features, and/or services—is evaluated in terms of how much or how little it will likely improve customer perceptions of the company's brand on the most important drivers of brand choice. Just as Use Case #4 brought into the system the output of the offline “Proof Points Session” workshop conducted by the Facilitator, Use Case #5 may bring in certain outputs of the “Portfolio Session” (Development Portfolio Assessment Session) workshop conducted by the Facilitator and described in Use Case #3. The Administering Consultant may perform this strategic alignment assessment, which produces an Alignment Dashboard (FIG. 22) and, for each product development initiative, an Alignment Index as defined in “Terms and Definitions.”

Use Case #5 Pre-Conditions—The first three pre-conditions of Use Case #1 are also applicable here. Alternatively, the Administering Consultant may be coming to this Use Case #5 directly from other use cases without logging off and back on. Additional pre-conditions: 1. All relevant data from Use Cases #1 and #2 have been previously entered and stored in the system. 2. Outside the system, the consulting firm has completed the Portfolio Session with the client company. The user in this use case now has in his/her possession the completed physical Easel Pads 2-A, 2-B and 2-C from the workshop, as well as a hard copy of Whiteboard 2-D.

Use Case #5 Flow of Events—1. User enters Project ID code. 2. User navigates to project home page and selects “Product Development Portfolio Assessment.” 3. User is presented with three options: (1) Assessment 1: Strategic Alignment (2) Assessment 2: Competitive Impact (3) Assessment 3: Manageability. User selects option #1 and proceeds to Assessment 1. (As specified later in this document, options 2 and 3 would take user to Use Cases #6 and #7, respectively.) 4. User is presented with four options: (1) Enter/modify assessment inputs (2) Perform/update assessment (3) View assessment (4) Print assessment. In the user's initial visit to this module for this Project ID, or unless this assessment has already been performed in a previous visit, user may select option #1. Only after option #1 inputs have been completed (Step 5 below) may the user alternatively select options #2, 3 or 4. (Any attempt to select the latter three options before Step 5 has been completed may elicit a message such as, “Assessment inputs not yet complete.” In subsequent user visits to this assessment module, if user selects option #3 or 4 without yet having performed the assessment (option #2), user can still view or print just the inputs without a performed assessment. If the assessment has already been performed in a previous visit (completion through Step 8 below), the user may select any of the four options above in any sequence—option #1 to make changes in the inputs, option #2 to update the assessment based on those changes, or options #3 or 4 may be selected first (to view or print the last assessment stored in a previous visit). Users other than Administering Consultant are only allowed to access options #3 and 4; if they attempt to access either of these options before assessment inputs have been entered by the Administering Consultant, the system may inform them that viewing/printing is unavailable because assessment inputs are not yet complete. If inputs are complete but the assessment has not yet been completed, users may view or print inputs but the system may inform them that the completed assessment is not yet available.) 5. User has selected option #1, “Enter/modify assessment inputs,” and is now prepared to enter the remaining inputs required to perform the assessment in Step 6 below. Using information stored from Use Case #3, Step 6, the system may now be able to display the product development Initiative Names and letter ID's as they appeared in the Portfolio Session Pacing Guide (FIG. 14). (If Use Case #3 was not completed, see “Alternative Paths” below.) When the list of initiatives displays, user may be prompted to enter: (1) Initiative Description [optional] and (2) Alignment Rating is explained previously in “Terms and Definitions.” Though Initiative Description is optional, it is strongly encouraged in training—so skipping it may elicit a prompt such as “Skip description of Initiative A?” The Initiative Description field may accommodate text entry up to 700 characters, to insure that the scope of the initiative is sufficiently communicated to all users who may need to reference portfolio content. User is then prompted to enter Alignment Rating for each initiative on each driver of brand choice included in the assessment (as entered and stored in Use Case #1, Step 4, and presented here in order of Importance Ranking as stored in Use Case #2, Step 5). For each initiative, user is presented with five possible ratings on each brand driver:-HIGH IMPACT-strong alignment; likely yielding high positive impact on how brand is perceived by customers on this driver-MODERATE IMPACT-moderate alignment; likely yielding significant positive impact on this driver, but not as much as those initiatives rated “High”-LOW IMPACT-low alignment, likely yielding minor impact on this driver-NO IMPACT-no, or negligible, impact on this driver-NEGATIVE IMPACT-inverse alignment; likely to hurt brand perceptions on this driver.

For the first initiative in the portfolio, the user cycles through entering these ratings for each driver and then moves to the next initiative and repeats until ratings have been entered for every initiative on every driver included in the assessment.

6. User is ready to build the dashboard called “Development Portfolio Alignment with Drivers of Brand Choice” as shown in FIG. 22. From the menu at the beginning of Step 4 above, user selects “Perform/update assessment.” Since FIG. 22 is designed to display the drivers of brand choice grouped according to Factor-Level Association (as entered in to the system in Use Case #1, Step 6), the system may now present those Factor-Level Associations (e.g., Control, Simplicity, Trust, Value) and ask the user to choose the order in which s/he would like the drivers displayed. User stipulates the order, and system then presents the FIG. 22 template—automatically providing the following: a. Column headings automatically populated with the Driver Names (from Use Case #1, Step 4), grouped by Factor-Level Association; factor names also automatically appear as column footers as shown in FIG. 22. Within each group of drivers belonging to the same factor (e.g., in FIG. 22, the drivers “Timeliness,” “Effectively Prioritizes,” and “Customizable” all belong to the “CONTROL” factor), drivers may display in adjacent columns in order (from left to right) of their Importance Ranking (from Use Case #2, Step 5)—so that each group of drivers is visually prioritized from left to right. System can abridge Driver Names in the column headings if necessary to have all drivers fit in uniform column widths on the dashboard, but for each heading the column width may accommodate at least two lines of up to 14 characters each. b. Row headings automatically populated with the Initiative Names and their letter ID's, as retrieved from the system in Step 5 above, and a blank text box between each initiative that extends across all driver columns (as shown in FIG. 22 after these text boxes have subsequently been selectively filled in with ratings rationales). c. For each initiative in the first column, looking across the row at the top of each blank text box in each Driver column, system automatically supplies the appropriate Alignment Rating color bar as shown in FIG. 22—using the Alignment Ratings that were just input by the user in Step 5 above. System may translate these ratings from Step 5 as follows: each “High Impact” rating becomes a green bar containing the word “HIGH”; a “Moderate Impact” rating becomes an amber bar containing the word “MODERATE”; a “Low Impact” rating becomes a light grey bar containing the word “LOW” in black text; a “No Impact” rating becomes a white, or blank, bar with no text; a “Negative Impact” rating becomes a white bar containing the word “NEGATIVE” in red text. 7. When system displays the completed template as described above, user will likely study it and may need the option to manually override or edit Driver Name column headings and/or Initiative Name row headings. Whether user edits or not, user is then presented with three choices: (1) Enter ratings rationales (2) Skip ratings rationales (3) Print Strategic Alignment Dashboard as is If user selects option #1, s/he is ready to use the blank text box below the color bar in each Initiative/Driver cell on the dashboard to type in the rationale for the Alignment Rating. (These rationales were captured by the Facilitator on the easel pads in the Portfolio Session, and subsequently given to the Administering Consultant.) Each rationale field may accommodate up to 120 characters in the alternate software embodiments; alternate software embodiments may ultimately allow each text box to produce a pop-up window in which a more detailed rationale can also be entered and later retrieved. Entering rating rationales is an optional step, but rationales for all High, Moderate, and Negative ratings are strongly encouraged in consultant training. If user selects option #2 or attempts to leave this use case before entering rationales, system may show user how many High, Moderate, and Negative rationale cells remain blank and ask if user is sure s/he wants to skip entering ratings rationales for these cells. 8. To complete this assessment, user now wishes to calculate an Alignment Index (alternatively known as a Brand Equity Impact Index) for each product development initiative as described in “Terms and Definitions”. Whether user entered or skipped ratings rationale in Step 6, user is now presented with the opportunity to optionally “Calculate Alignment Index for each initiative.” In other embodiments, calculating the alignment index may be required before Use Cases #8 or #9 can be completed. User elects to do that now, and the system may use the following underlying mathematics to produce a separate Alignment Index for each Initiative Name—reflecting how strongly aligned the initiative is with each of the drivers of brand choice on which it was rated. a. System first assigns to each HIGH rating a quantitative value of 3 points, to each MODERATE rating a value of 2 points, to each LOW rating a value of 1 point, to each NO rating a value of zero points, and to each NEGATIVE rating a value of −1 point. (Alternate software embodiments may allow user to manually override these value assignments to be able to change values by increments of +/−0.25 for those initiatives with alignment gauged in Portfolio Session as “in between” High and Moderate, for example, or in between any two ratings, or where negative impact may be sufficiently significant to justify a negative rating greater than −1 point. This manual override capability is not required in alternate software embodiments.) b. For each rating, system multiplies the rating's quantitative value by that particular driver's Brand Driver Importance Index (from Use Case #2, Step 8), thereby weighting each rating and producing “weighted alignment points” for each driver as it pertains to each initiative. (Example: Initiative A was rated HIGH on the driver “Scalable,” which has a Brand Driver Importance Index of 80 and therefore assigns a total of 3×80, or 240 weighted alignment points, to Initiative A for “Scalable.”) c. System produces an Alignment Index equal to 100 for the Initiative Name that has the highest number of total weighted alignment points. For each of the other Initiative Names, system calculates its Alignment Index based on that initiative's total weighted points as a percentage of the total weighted points for the initiative that was indexed at 100. All Alignment Indices are expressed as whole numbers.

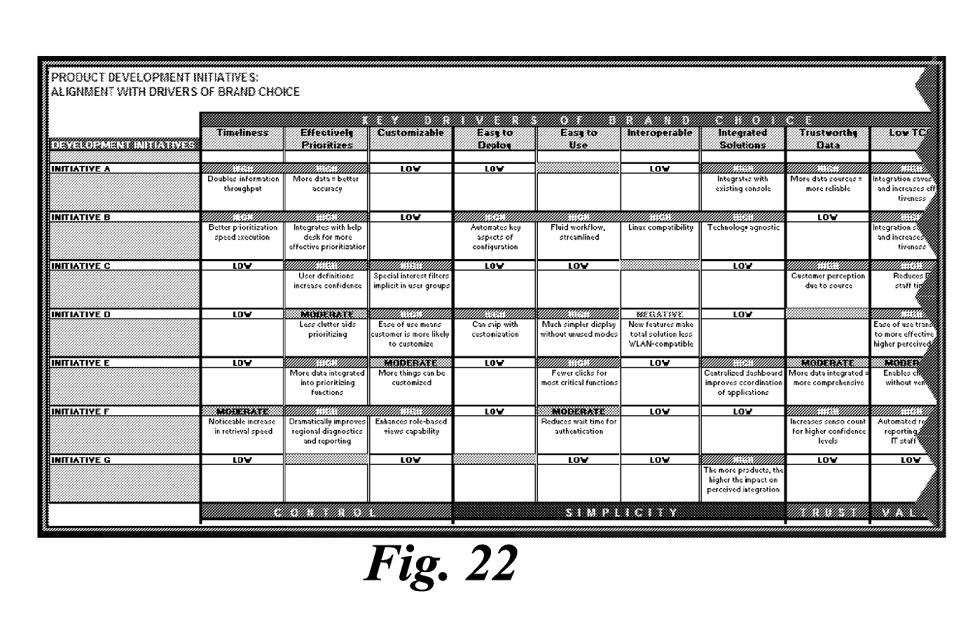

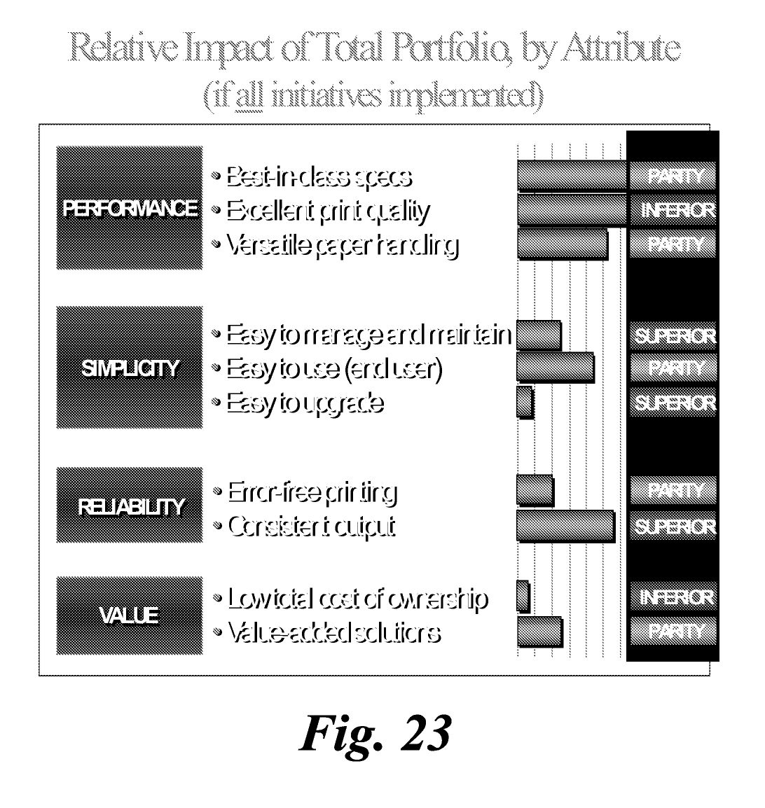

System now displays the results, showing a prioritized list displaying Initiative Name and ID, rank, and index. For example: RANK INITIATIVE ALIGNMENT INDEX 1. D. Full internationalization 100; 2. B. Executive dashboard 94; 3. F. Real-time access to BMG database 87; 4. A. Auto-configuration 77; 5. E. Live chat tech support 58; 6. C. Integration with customer console 42. 9. After examining results for individual initiatives, user may wish to examine collective results for the entire product development portfolio—that is, if all initiatives are brought to market, what is the likely relative degree of impact on each driver of brand choice. User is presented with option to “Create total portfolio impact summary by attribute.” If option is selected, the system produces a bar-graph representation of the collective impact of all initiatives on each attribute that is a driver of brand choice, grouped by factor-level association as shown in FIG. 23.

10. Upon viewing results from Steps 8 and/or 9, user may now elect to print or create PDF of the Alignment Dashboard and the display of index results (which can be combined in a single PDF), and/or the Total Portfolio Impact Summary By Attribute (FIG. 23). Alternatively, user may use the Step 4 menu's option #4 to do the same in future visits. (Alternate software embodiments may provide ability to e-mail PDFs to client company or consulting colleagues, via Microsoft Outlook, without having to manually open Outlook and attach file, but this is not necessary in the prototype.)

Alternative Paths: In Step 5, if the development portfolio was not already entered in Use Case #3, it is not yet in the system. User is prompted to “Define development portfolio” before s/he can enter initiative descriptions. First, user may preferably specify the number of initiatives in the portfolio; entry in this field may be an integer ≧3 and ≦12. Next, based on the number of initiatives, the system may provide an Initiative Name field for each—and each initiative may be coded with a letter of the alphabet to serve as an Initiative ID that follows that initiative through the remainder of the assessments. So, for example, if the user entered 6 as the number of initiatives, the system may automatically provide the IDs and display them along with blank name fields and description fields for data entry:

ID|INITIATIVE NAME|INITIATIVE DESCRIPTION. Initiatives are ID-coded alphabetically (e.g., A. B. C. D., etc.). User may now enter Initiative Names [mandatory] and Initiative Descriptions [optional, with prompt if skipped as described in Step 5 above]. (For example, for Initiative A above the user would type in “Auto-configuration” as the name and then enter the description, “Enabling Release 6.0 to configure itself through a simple auto-configuration wizard that requires the customer to answer only four questions.” Then user would proceed to enter the Initiative B description, and so on.) User may then complete Step 5 above, starting at the point where user is prompted to enter Alignment Ratings, and continuing through to use case completion from there.

At Step 8b, user may elect to perform the assessment on an unweighted basis. If user does so, then for each initiative the system simply adds together the initiative's total unweighted rating points across all drivers and proceeds to Step 8c to produce the Alignment Index based on unweighted points. On this alternative path, the Alignment Index column displaying at Step 8c would display with the modified heading, “Alignment Index (Unweighted).”

Use Case #5 Post-Conditions—All use case data entry is saved in the system, available for Administering Consultant to access, modify, or delete, and is accessible to other valid users on a read-only basis—with the exception that the Consultant Facilitator may also add, modify or delete only the ratings rationales in the rationale text boxes in Step 7. (In some instances, Administering Consultant may ask the Facilitator to log on to the system and check/correct the rationale entries, or may have skipped entering the rationales and instead asked the Facilitator to make those entries.) When this use case ends, user may either log off or proceed to other use cases.

2.6 Use Case #6—Perform Competitive Impact Assessment—Use Case #6 performs the second of three Application assessments of the client company's product development portfolio, in which each development initiative—products, features, and/or services—is evaluated in terms of how much or how impact it will likely have on the client company's competitive situation (as expressed in the Competitive Situation Dashboard generated in Use Case #4, Step 8). Just as Use Case #5 brought into the system certain outputs of the “Portfolio Session” (Development Portfolio Assessment Session) workshop conducted offline by the Facilitator, Use Case #6 brings in and uses other outputs from that same session. The Administering Consultant may perform this competitive impact assessment, which produces a Competitive Impact Dashboard (FIG. 24) and, for each product development initiative, a Competitive Impact Index as defined in “Terms and Definitions.”

Use Case #6 Pre-Conditions—The first three pre-conditions of Use Case #1 are also applicable here. Alternatively, the Administering Consultant may be coming to this Use Case #6 directly from other use cases without logging off and back on. Additional pre-conditions: 1. Use Cases #1 through #6 have all been completed and their data stored in the system. 2. Outside the system, the consulting firm has completed both the Proof Points Session and the Portfolio Session with the client company.

Use Case #6 Flow of Events—1. User enters Project ID code. 2. User navigates to project home page and selects “Product Development Portfolio Assessment.” 3. User is presented with three options: (1) Assessment 1: Strategic Alignment (2) Assessment 2: Competitive Impact (3) Assessment 3: Manageability. User selects option #2 and proceeds to Assessment 2. 4. User is presented with four options: (1) Enter/modify assessment inputs (2) Perform/update assessment (3) View assessment (4) Print assessment In the user's initial visit to this module for this Project ID, or unless this assessment has already been performed in a previous visit, user may select option #1. Only after option #1 inputs have been completed (Step 5 below) may the user alternatively select options #2, 3 or 4. (Any attempt to select the latter three options before Step 5 has been completed may elicit a message such as, “Assessment inputs not yet complete.” In subsequent user visits to this assessment module, if user selects option #3 or 4 without yet having performed the assessment (option #2), user can still view or print just the inputs without a performed assessment. If the assessment has already been performed in a previous visit (completion through Step 7 below), the user may select any of the four options above in any sequence—option #1 to make changes in the inputs, option #2 to update the assessment based on those changes, or options #3 or 4 may be selected first (to view or print the last assessment stored in a previous visit). Users other than Administering Consultant are only allowed to access options #3 and 4; if they attempt to access either of these options before assessment inputs have been entered by the Administering Consultant, the system may inform them that viewing/printing is unavailable because assessment inputs are not yet complete. If inputs are complete but the assessment has not yet been completed, users may view or print inputs but the system may inform them that the completed assessment is not yet available.) 5. User has selected option #1, “Enter/modify assessment inputs,” and is now prepared to enter the remaining inputs required to perform the competitive impact assessment in Step 6 below. Using information stored in the system in Use Cases #4 and 5, the system may now be able to display the product development Initiative Names and letter ID's in ID alphabetical order. Upon display, user selects each initiative in turn and, upon doing so, may enter three pieces of information for each driver of brand choice as it pertains to the initiative currently selected: (1) Type of impact [mandatory], (2) Competitive outcome [mandatory], and (3) Explanation [optional]. For the initiative selected, the system presents each Driver Name in the same sequence in which driver names appeared on the Proof Points Session Pacing Guide (FIG. 13). For the Driver Name presented (while the selected Initiative Name is still displayed), system prompts user to “Enter impact type” and presents a menu of twelve types from which to select: (1) Leapfrogs all key competitors (moves from inferior to superior), (2) Leapfrogs some competitors, (3) Unconditional move from parity to superior, (4) Unconditional move from inferior to parity, (5) Conditional move from parity to superior, (6) Conditional move from inferior to parity, (7) Lengthens lead where impending threat, (8) Strengthens parity (moves closer to superior), (9) Mitigates inferiority (but still not parity), (10) Lengthens lead where no impending threat, (11) No impact, (12) Weakens position. (These definitions are: Leapfrogs all key competitors=The selected initiative, successfully executed, will likely move the client company's brand from being worst-in-class (or inferior to at least one brand) to best-in-class on this driver of brand choice. Leapfrogs some competitors=The selected initiative, successfully executed, will likely move the client company's brand from being worst-in-class to better than at least one key competitor but not all key competitors. Unconditional move from parity to superior=The selected initiative, successfully executed, will likely move the client company's brand from parity with one or more competitors to category superiority on this driver. Unconditional move from inferior to parity=The selected initiative, successfully executed, will likely move the client company's brand from being inferior to at least one competitor to being at parity (i.e., no longer inferior to any competitor) on this driver. Conditional move from parity to superior=Like “unconditional move from parity to superior” above, except that: (1) the initiative breaks parity with at least one competitor but not with all competitors, so client company brand still can't claim category superiority on this driver, and/or (2) the move to superiority may only be among some, but not all, key customer segments. Conditional move from inferior to parity=Like “unconditional move from inferior to parity” above, except that: (1) the initiative reaches parity with at least one competitor but not with all competitors, so client company brand still can't claim category parity on this driver, and/or (2) the move to parity may only be among some, but not all, key customer segments. Lengthens lead where impending threat=The selected initiative, successfully executed, will likely increase the degree of superiority and/or protect the superiority already enjoyed by the client company's brand on a driver for which the brand's lead is judged to be in jeopardy. Strengthens parity (moves closer to superior)=The selected initiative, successfully executed, may move the brand closer to superior on this driver, but not far enough to claim superiority. Mitigates inferiority=The selected initiative, successfully executed, may help close the gap vs. competitors on this driver, but not enough to claim parity with “brand(s) to beat” (as occurred in “Inferior to Parity” above). Lengthens lead where no impending threat=The selected initiative, successfully executed, will likely increase the degree of superiority already enjoyed by the client company's brand on a driver for which the brand's lead is not judged to be in jeopardy, but still further insulating it from competitive attack.) No impact=no, or negligible, impact on this driver. Weakens position=negative impact on this driver. After selecting the Impact Type for this particular initiative on this particular driver, user is prompted to select/enter Competitive Outcome on this same driver. This predicts the competitive position of the client company's brand after this initiative is successfully brought to market, and represents the team consensus reached in the Portfolio Session conducted offline. One of these four Competitive Outcome choices may now be selected/entered:-Superior-Parity-Inferior-Unknown.

After the Competitive Outcome has been selected for this driver, user is prompted to enter Explanation in a text box—summarizing why the client company's competitive position is predicted to change if this initiative is successfully brought to market. (Explanation is optional; each explanation field may accommodate up to 120 characters in the alternate software embodiments; alternate software embodiments may ultimately allow each text box to produce a pop-up window in which a more detailed explanation can also be entered and later retrieved.) After user enters Impact Type, Competitive Outcome, and Explanation, system presents the next driver; user cycles through every driver and enters these three pieces of information for this initiative. Upon completion of all drivers, system presents the next initiative from the development portfolio and cycles through all the drivers again as user enters Impact Type, Competitive Outcome, and Explanation for each driver—repeating the cycle until inputs for all drivers on all initiatives have been entered in the system. 6. User is now ready to build the competitive impact assessment dashboard as shown in FIG. 24. From the menu at the beginning of Step 4 above, user selects “Perform/update assessment.” Since the template for FIG. 24 is very similar to FIG. 22 (the Alignment Dashboard that was built in Use Case #5) and the column headings and footers are identical, the system can use the same instructions from Use Case #5 to build FIG. 24 with only the following changes vs. FIG. 22 (besides the title change at the top of the dashboard): (1) note that FIG. 24 has two extra rows and row headings—one at the top, just below the column headings (see the “Current Product” row heading), and one at the bottom (see the “With ALL Initiatives” row heading); (2) when the product development initiative names display in Column A, each name and letter ID is preceded by the word “With” and followed by the word “only”; (3) the color bars in all the driver columns contain different words than in FIG. 24 (differences explained in the next paragraph). With these changes/additions, system now presents the FIG. 24 template—and automatically provides the following: a. Column headings automatically populated with the Driver Names; Factor-Level Association also automatically appears as column footers as shown. (FIG. 22 rules from Use Case #5 apply here as well.) b. Row headings automatically populated with the words “With <Letter ID> <Initiative Name> only” and a blank text box between each initiative that extends across all driver columns as shown. (Headings for the additional row above and below are described above and shown in FIG. 24; these two row headings are fixed for all competitive impact assessments and never change regardless of project or portfolio.) c. For each initiative in the first column, looking across the row at the top of each blank text box in each Driver column, system automatically displays the appropriate Competitive Outcome color bar as shown in the color version of FIG. 24—using the Competitive Outcome choices entered by the user in Step 5 above. Color bars displayed may correspond to the following color key as shown: “Superior” becomes a green bar containing the word “SUPERIOR”; “Parity” becomes an amber bar containing the word “PARITY”; “Inferior” becomes a red bar containing the word “INFERIOR,” and “Unknown” becomes a gray or transparent bar containing the word “UNKNOWN” (signifying inadequate competitive intelligence). Note that, since client company's current product was absent from Step 5 above when the competitive outcomes were entered, the color bars for the first row of FIG. 24, “Baseline: Current Portfolio,” may come from Use Case #4, Step 8—where these specific color bars for the current product were already created to build the Competitive Situation Dashboard (FIG. 21) for the current product. d. In each text box in each driver column, system automatically displays the Explanation text entered (if entered) by the user in Step 5 above. 7. When system displays the completed template as described above, user is ready to complete the competitive impact assessment by generating a Competitive Impact Index (as defined in “Terms and Definitions”) for each product development initiative and to see the initiatives ranked accordingly. User is now presented with the opportunity to optionally “Calculate Competitive Impact Index for each initiative.” In alternate embodiments, calculating competitive impact indices for each initiative may be required before Use Cases #8 or #9 can be completed. User elects to do that now, and the system uses the following underlying mathematics to produce a separate Competitive Impact Index for each Initiative Name—reflecting the relative degree to which each initiative will likely improve the client company's competitive situation where improvement is most needed: a. System first assigns quantitative values to each of the subjective Competitive Outcomes entered in Step 5 above, as follows:

Competitive impact scoring detail
(defaults and recommended ranges):

| | |
|---|---|
| Leapfrogs all key competitors | 7.5-8.5 (8.0 default) |
| Leapfrogs some competitors | 6.0-7.0 (6.5 default) |
| Unconditional move from parity to | 6.0-7.0 (6.5 default) |
| superior | |
| Unconditional move from inferior to parity | 5.0-6.0 (5.5 default) |
| Conditional move from parity to superior | 4.0-6.0 (5.0 default) |
| Conditional move from inferior to parity | 3.0-5.0 (4.0 default) |
| Lengthens lead where impending threat | 2.0-5.0 (3.5 default) |
| Strengthens parity (moves closer to | 1.5-3.5 (2.5 default) |
| superior) | |
| Mitigates inferiority (but still not parity) | 1.5-2.5 (2.0 default) |
| Lengthens lead where no impending threat | 0.5-1.5 (1.0 default) |
| No impact | 0.0-0.0 (0.0 default) |
| Weakens position | (−0.5)-(5.0) (−2.0 default) |

Alternate software embodiments may allow user to manually override these value assignments for exceptional occurrences, entering a value to two decimal places in increments of +/−0.25 points. Examples of such occurrences requiring manual override are situations in which lengthening a lead is especially critical because of anticipated imminent innovation by a strong competitor, or situations in which leapfrogging is so extreme that it vaults the client company's brand from being the worst in the industry on a particular driver to being far superior to all competitors. Manual override is not required in alternate software embodiments.) b. For each competitive outcome, system multiplies the outcome's quantitative value by that particular driver's Brand Driver Importance Index (from Use Case #2, Step 8), thereby weighting each outcome and producing “weighted competitive outcome points” for each driver as it pertains to each initiative. (Example: if Initiative A was assessed as “Parity to Superior-unconditional” (a value of 3 in the table above in Step 7) on the driver “Scalable,” which has a Brand Driver Importance Index of 80, the system would multiply 3×80 to assign 240 weighted competitive outcome points to Initiative A for “Scalable.”) c. System produces a Competitive Impact Index equal to 100 for the Initiative Name that has the highest total number of weighted competitive outcome points. For each of the other Initiative Names, system calculates the Competitive Impact Index based on that initiative's total weighted points as a percentage of the total weighted points for the initiative that was indexed at 100. All Competitive Impact Indices are expressed as whole numbers. System now displays the results, showing a prioritized list displaying Initiative Name and ID, rank, and index. For example:

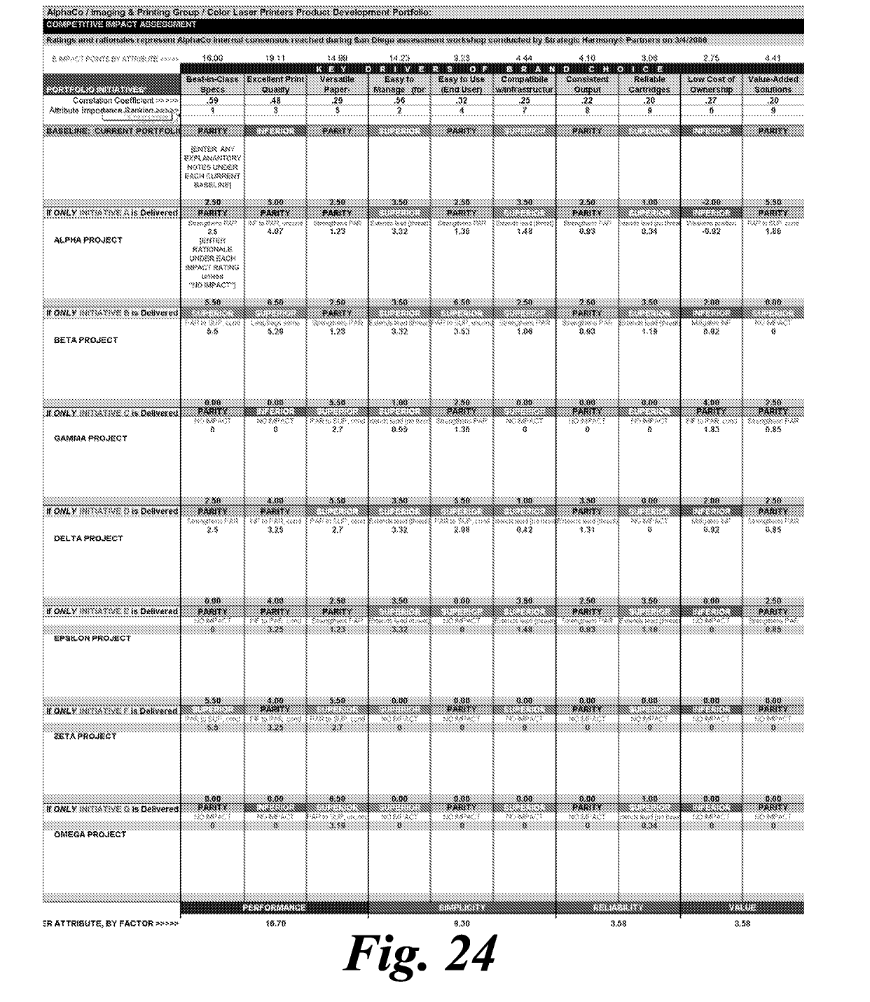

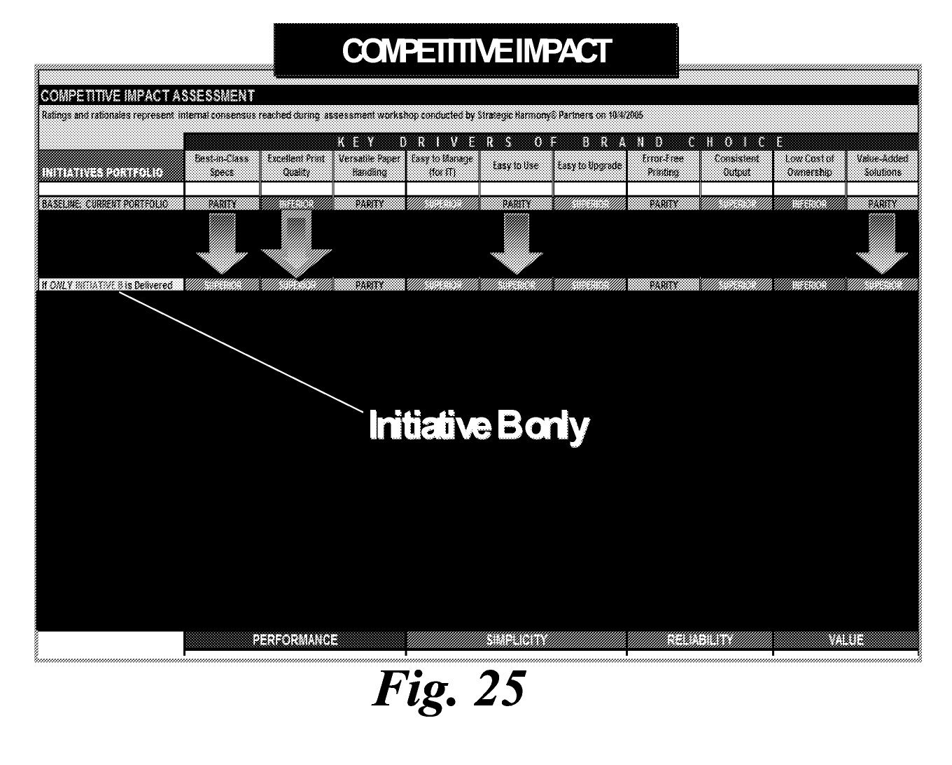

RANK|INITIATIVE|COMPETITIVE IMPACT INDEX are the three column headings displaying the following tabular data with Rank followed by initiative ID and name followed by Competitive Impact Index: 1. B. Executive dashboard 100|2. A. Auto-configuration 91|3. D. Full internationalization 84|4. C. Integration with customer console 80|-5. F. Real-time access to BMG database 62|6. E. Live chat tech support 52 8. User may now wish to selectively examine the competitive impact of individual initiatives in the portfolio, one at a time, without all the clutter of the full dashboard produced in Step 6. User is presented with option to “Display selected initiative only.” If option is selected, a drop-down menu presents with the ID and name of each initiative. User selects the initiative s/he wants displayed. The system then produces the view shown in the FIG. 25 example (in which only Initiative B appears, along with the client company's current competitive status for comparison) and vertical arrows indicate where the client company's competitive status will likely change (vs. current competitive status) as a result of bringing only this initiative to market. Note in FIG. 25 that any instance of “leapfrogging” is indicated by a vertical arrow that has a bold-highlighted border.

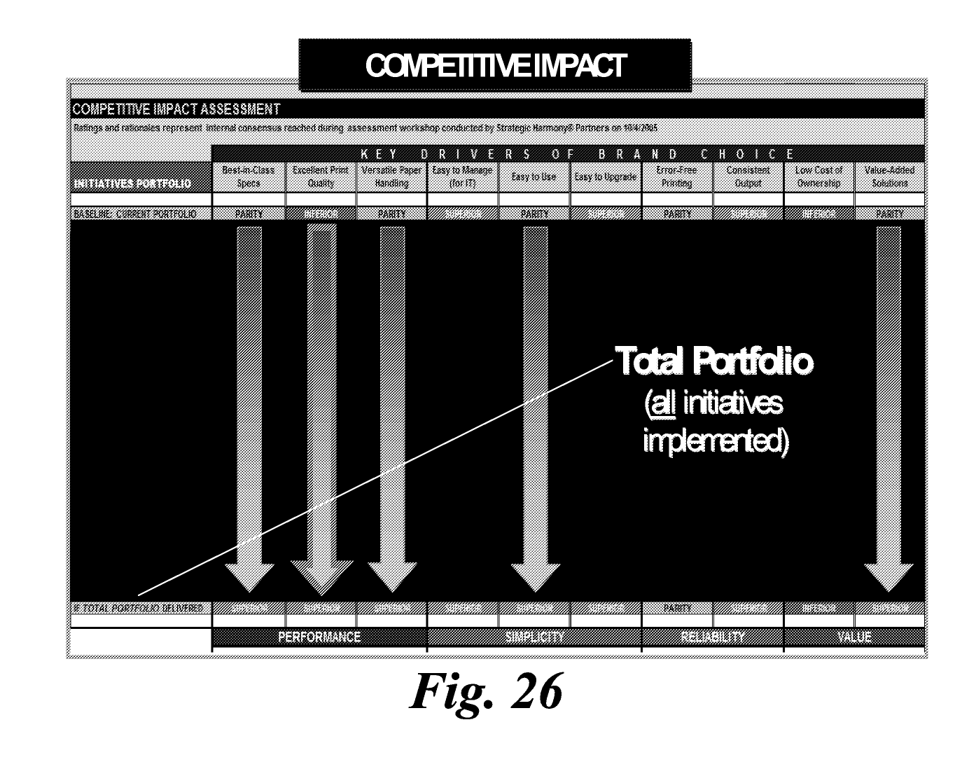

9. After examining results for individual initiatives, user may wish to examine collective results for the entire product development portfolio—that is, if all initiatives are brought to market, what is the likely collective impact on the client company's competitive status (superior/parity/inferior) for each driver of brand choice. User is presented with option to “Display total portfolio impact only.” If option is selected, the system produces the view shown in the FIG. 26 example in which individual initiatives are masked out and vertical arrows indicate where the client company's competitive status will likely change (vs. current competitive status) as a result of bringing the entire portfolio to market. Note in FIG. 26 that any instance of “leapfrogging” is indicated by a vertical arrow that has a bold-highlighted border. 10. Upon viewing results of Step 7, 8 and/or 9, user may now elect to print or create PDF of the competitive impact dashboard and the index results display (which can be combined in a single PDF) and/or any view of an individual intiative's impact (as in FIG. 25 example) or total portfolio impact (FIG. 26). Alternatively, user may use the Step 4 menu's option #4 to do the same in future visits. (Alternate software embodiments may provide ability to e-mail PDFs to client company or consulting colleagues, via Microsoft Outlook, without having to manually open Outlook and attach file, but this is not necessary in the prototype.) Alternative Paths: At Step 6d, when the Competitive Impact dashboard (FIG. 24) displays, system gives user the option to view a visually compressed dashboard version of the display in which all text boxes between color bars are hidden and most of the vertical space between the color bar rows are eliminated (example shown in FIG. 27). This view may be printed or converted to PDF. At Step 7b, user may elect to perform the assessment on an unweighted basis. If user does so, then for each initiative the system simply adds together the initiative's total unweighted competitive outcome points across all drivers and proceeds to Step 7c to produce the Competitive Impact Index based on unweighted points. On this alternative path, the Competitive Impact Index column displaying at Step 7c would display with the modified heading, “Competitive Impact Index (Unweighted).”

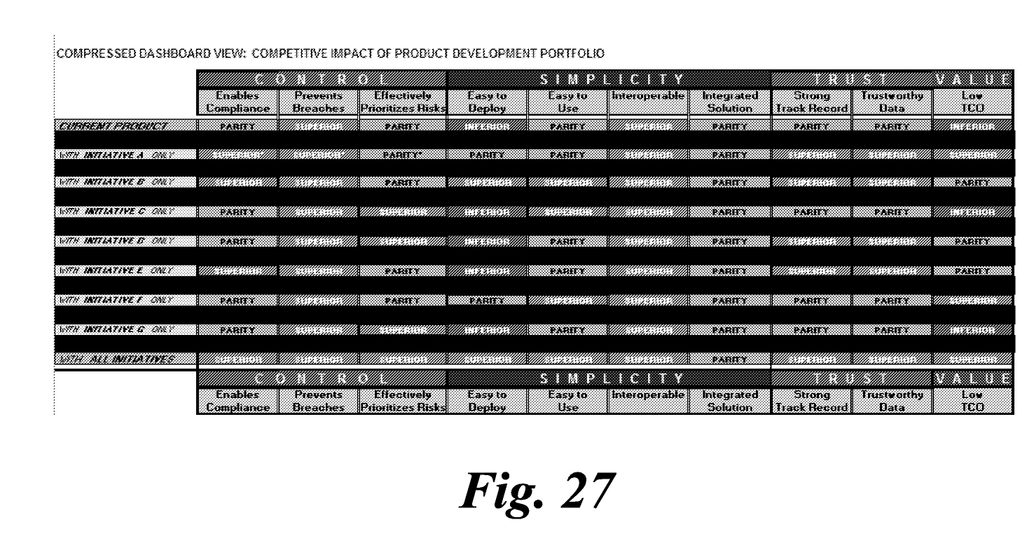

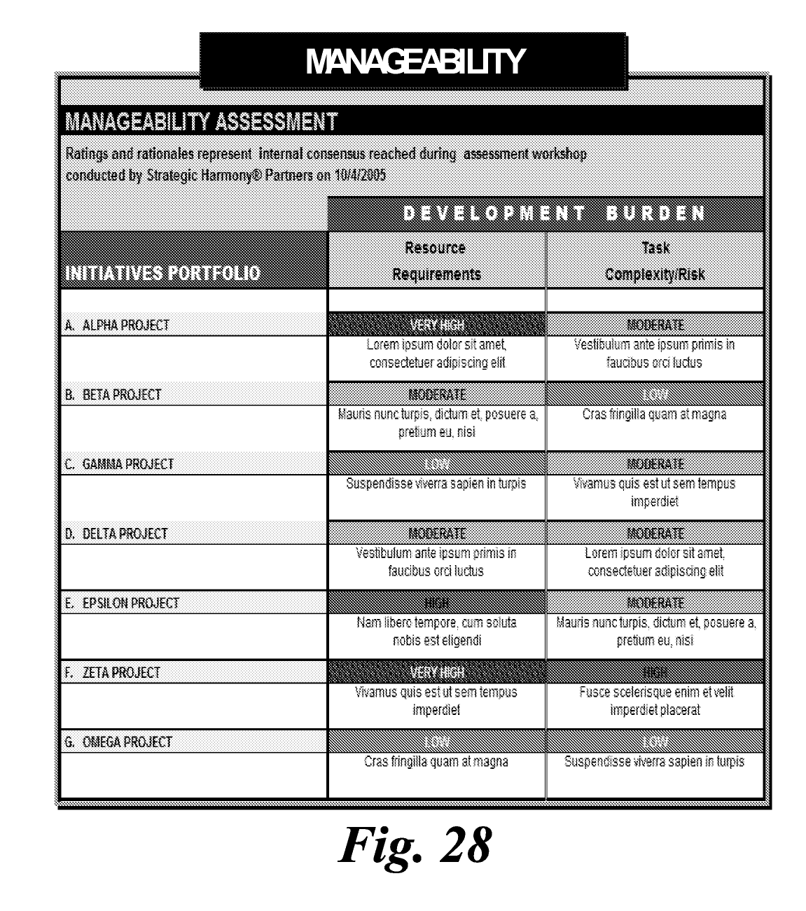

Use Case #6 Post-Conditions—All use case data entry is saved in the system, available for Administering Consultant to access, modify, or delete, and is accessible to other valid users on a read-only basis—with the exception that the Consultant Facilitator may also add, modify or delete only the “Explanations” entered (or not yet entered) in Step 5. (In some instances, Administering Consultant may ask the Facilitator to log on to the system and check/correct the Explanation entries, or may have skipped entering the explanations and instead asked the Facilitator to make those entries.) When this use case ends, user may either log off or proceed to other use cases. 2.7 Use Case #7—Perform Manageability Assessment—Use Case #7 performs the last of the three Application assessments of the client company's product development portfolio, in which each development initiative—products, features, and/or services—is evaluated in terms of its development burden (i.e., human and financial resources required in, and the complexity of, and risks inherent in, bringing the initiative to market). Just as Use Cases #5 and #6 brought into the system certain outputs of the “Portfolio Session” (Development Portfolio Assessment Session) workshop conducted offline by the Facilitator, Use Case #7 brings in and uses other outputs from that same session. The Administering Consultant may perform this manageability assessment, which produces a Manageability dashboard (FIG. 28) and, for each product development initiative, a Manageability Index (as defined in “Terms and Definitions”). Use Case #7 Pre-Conditions—The first three pre-conditions of Use Case #1 are also applicable here. Alternatively, the Administering Consultant may be coming to this Use Case #7 directly from other use cases without logging off and back on. Additional pre-conditions: 1. Use Case #3 or #5 has been completed and its data stored in the system. 2. Outside the system, the consulting firm has completed the Portfolio Session with the client company.

Use Case #7 Flow of Events—1. User enters Project ID code. 2. User navigates to project home page and selects “Product Development Portfolio Assessment.” 3. User is presented with three options: (1) Assessment 1: Alignment (2) Assessment 2: Competitive Impact (3) Assessment 3: Manageability. User selects option #3 and proceeds to Assessment 3. 4. User is presented with four options: (1) Enter/modify assessment inputs (2) Perform/update assessment (3) View assessment (4) Print assessment In the user's initial visit to this module for this Project ID, or unless this assessment has already been performed in a previous visit, user may select option #1. Only after option #1 inputs have been completed (Step 5 below) may the user alternatively select options #2, 3 or 4. (Any attempt to select the latter three options before Step 5 has been completed may elicit a message such as, “Assessment inputs not yet complete.” In subsequent user visits to this assessment module, if user selects option #3 or 4 without yet having performed the assessment (option #2), user can still view or print just the inputs without a performed assessment. If the assessment has already been performed in a previous visit (completion through Step 7 below), the user may select any of the four options above in any sequence—option #1 to make changes in the inputs, option #2 to update the assessment based on those changes, or options #3 or 4 may be selected first (to view or print the last assessment stored in a previous visit). Users other than Administering Consultant are only allowed to access options #3 and 4; if they attempt to access either of these options before assessment inputs have been entered by the Administering Consultant, the system may inform them that viewing/printing is unavailable because assessment inputs are not yet complete. If inputs are complete but the assessment has not yet been completed, users may view or print inputs but the system may inform them that the completed assessment is not yet available.)

5. User has selected option #1, “Enter/modify assessment inputs,” and is now prepared to enter the remaining inputs required to perform the manageability assessment in Step 6 below. Using information stored from Use Case #3—or, if Use Case #3 was not completed—Use Case #5, the system may now be able to display the product development Initiative Names and letter ID's in ID alphabetical order. Upon display, user selects each initiative in turn and, upon doing so, user is prompted to enter four pieces of information for each initiative: (1) Resource Level [mandatory], (2) Resource Explanation [optional], (3) Complexity Level [mandatory], and (4) Complexity Explanation [optional]. (In alternate software embodiments, Online Help and a tutorial in the Reference Library may provide more detail and examples of how to distinguish complexity issues from resource issues, since they often overlap significantly.) For the initiative currently selected, upon seeing the “Enter resource level” prompt, user may select from the following menu of four possible resource levels:-VERY HIGH-HIGH-MODERATE-LOW Then, upon seeing the “Enter complexity level” prompt for the same initiative, user may select from the exact same menu (i.e., the same four levels are used to describe both resource requirements and complexity in this assessment). User is then given the option to enter explanation of rationale for selecting that level. Upon completing this cycle, user may select each of the remaining initiatives in turn and enter the appropriate level for resources and complexity and, if desired, explanations, for each initiative. 6. User is now ready to build the Manageability Assessment dashboard as shown in FIG. 28. From the menu at the beginning of Step 4 above, user selects “Perform/update assessment.” System now presents the FIG. 28 template with column headings as shown, and automatically provides the following: a. System automatically populates row headings with the Initiative Names and their letter ID's, displaying alphabetically by letter ID. b. For each initiative in the first column, looking across the row at the top of each blank text box in the Resource Requirements and Task Complexity columns, system automatically supplies the appropriate burden level color bar as shown in the color version of FIG. 28—using the Resource Requirement Level and Task Complexity Level inputs entered by the user in Step 5 above. System may translate these inputs as follows for FIG. 28 display: each “Very high” level becomes a red bar containing the words, “VERY HIGH”; each “High” level becomes an amber bar containing the word “HIGH”; each “Moderate” level becomes a grey bar containing the word “MODERATE”; each “Low” level becomes a green bar containing the word “LOW.” c. In each text box in the Resources Required and Task Complexity columns, system automatically displays the appropriate Resource Explanation text and Complexity Explanation text that was entered (if entered) by the user in Step 5. 7. When system displays the completed template as described above, user is ready to complete the manageability assessment by generating a Manageability Index (as defined in “Terms and Definitions”) for each product development initiative and to see the initiatives ranked accordingly. User is now presented with the opportunity to “Calculate Manageability Index for each initiative.” (This step is mandatory before Use Cases #8 or #9 can be completed.) User elects to do that now, and the system uses the following underlying mathematics to produce a separate Manageability Index for each Initiative Name—reflecting the relative development burden of each initiative as compared to the other initiatives: a. System first assigns quantitative values to each of the subjective Resource Levels and Complexity Levels entered in Step 5 above, as follows:-VERY HIGH=1 point-HIGH=2 points-MODERATE=3 points-LOW=4 points (Alternate software embodiments may allow user to manually override these value assignments for exceptional occurrences, entering a value to two decimal places in increments of +/−0.25 points. Manual override is not required in alternate software embodiments.) b. System now offers user the choice of a default formula or custom formula in computing Manageability Indices. User chooses “Default” (see “Alternative Paths” below if user chooses “Custom”), and the system uses the following default formula. In Application pilot implementations to date, client companies have agreed that resources may be weighted at roughly twice the importance of complexity, in part because resources are more finite and controllable—so this is the default weighting, but manual override may be available as client company circumstances dictate.—which weights Resources: Complexity at a ratio of 2:1—to produce a Manageability Index for each initiative: multiply the initiative's Resource Level quantitative value by 2, add the product to that initiative's Complexity Level quantitative value, and divide the sum by 2. This represents a weighted manageability total score for each initiative. After calculating this for each initiative, the system looks for the highest-scoring initiative and indexes every other initiative's score to the highest score. This produces the Manageability Indices. An example: let's say Initiative E has a Resource Level of Moderate (3 points) and a Complexity Level of Low (4 points), yielding the highest weighted burden manageability score among all initiatives in the portfolio at 5.0—derived from ((3×2)+(4×1))/2=5.0; let's day Initiative D, however, has a Resource Level of High (2 points) and a Complexity Level of Moderate (3 points), yielding a manageability score of ((2×2)+(3×1))/2=3.5. If Initiative C is indexed at 100 as the highest-scoring on manageability, Initiative D will index at 70 (=3.5/5.0). Remember, the lower the burden, the more manageable it is, so the initiative with the lowest burden will have the highest Manageability Index.

System now displays the results, showing a prioritized list displaying Initiative Name and ID, rank, and index. For example: RANK|INITIATIVE|MANAGEABILITY INDEX, displaying in tabular form as 1. E. Live chat tech support 100|2. A. Auto-configuration 80|3. B. Executive dashboard 70|3. D. Full internationalization 70 (Note two initiatives ranked number 3 signifies that, in all rankings produced by the system in all uses cases, any “ties” (identical indices) may assign the same rank number to the initiatives that are tied but then skip a number for the next initiative.) |5. F. Real-time access to BMG database 60|6. C. Integration with customer console 50 8. Upon viewing the Step 7 results, user may now elect to print or create PDF of the Competitive Impact dashboard and the index results display (which can be combined in a single PDF). Alternatively, user may use Step 4's menu option #4 to do the same in future visits. (Alternate software embodiments may provide ability to e-mail PDFs to client company or consulting colleagues, via Microsoft Outlook, without having to manually open Outlook and attach file, but this is not necessary in the prototype.) Alternative Paths: At Step 7b, user chooses custom formula instead of default formula. User is prompted to enter weighting ratio [mandatory for custom formula] for Resources: Complexity (the numeric field on either side of the ratio colon may accommodate integers <10; e.g., 5:2). User is provided a text box to enter rationale [optional] for the custom formula. System then substitutes the numbers entered here as the multipliers in the formula described in Step 7b, and the remainder of the use case continues on the main path from there. (However, when the index results display at the end of Step 7, a footnote at the Index column heading may indicate that “Indices based on custom formula, weighting Resources:Complexity at ______:______.”)

Use Case #7 Post-Conditions—All use case data entry is saved in the system, available for Administering Consultant to access, modify, or delete, and is accessible to other valid users on a read-only basis—with the exception that the Consultant Facilitator may also add, modify or delete only the custom formula rationale text entered (or not yet entered) in Alternative Path Step 7b. (In some instances, Administering Consultant may ask the Facilitator to log on to the system and check/correct the rationale entry, or may have skipped entering the rationale and instead asked the Facilitator to make that entry.) When this use case ends, user may either log off or proceed to other use cases.

2.8 Use Case #8—Integrate Individual Assessments—In Use Case #8, the user brings together the inputs and analyses from Uses Cases #5, 6 and 7 to integrate these three standalone assessments into a more holistic picture of strategic priorities. This Use Case #8 may: produce an at-a-glance visual recap of the three individual product development portfolio assessments, side by side; combine the Alignment Rankings from Use Case #5 with the Competitive Impact Rankings from Use Case #6 to produce a blended ranking of Overall Strategic Importance; balance Overall Strategic Importance against Manageability (from Use Case #7) to produce a recommended list of strategic priorities; allow user to enter rationales for these recommendations that may be carried forward into presentation building in Use Case #9.

Use Case #8 Pre-Conditions—The first three pre-conditions of Use Case #1 are also applicable here. Alternatively, the Administering Consultant may be coming to this Use Case #8 directly from other use cases without logging off and back on. Additional pre-conditions: 1. Use Cases #1, 2, 4, 5, 6 and 7 have all been completed and their data stored in the system. 2. Outside the system, the consulting firm has completed both the Proof Points Session and Portfolio Session with the client company.

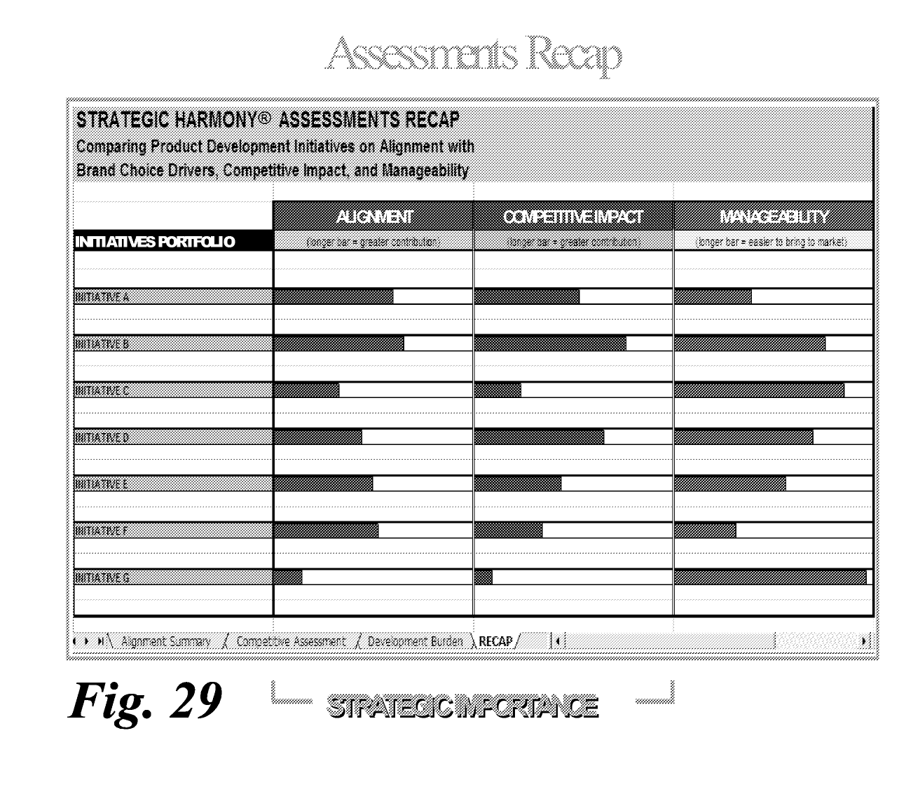

Use Case #8 Flow of Events—1. User enters Project ID code. 2. User navigates to project home page and selects “Integrate Assessments.” If Use Case #8 has already been completed in a previous visit, user may elect to view or print integrated assessment results and is presented with a menu of output displays from the previously completed Steps 3 through 7 below. If Use Case #8 was not completed previously, the Administering Consultant user is now taken to a page describing the six tasks that s/he may be asked to perform in Steps 3 through 7 below for assessment integration. These six tasks will most always be performed in the following sequence (though users may have flexibility to skip the first task and perform it at any point before task #5, as tasks #2-4 are not dependent on it): (1) Generate a single-page Assessments Recap (2) Generate Overall Strategic Importance Rankings (3) Create Application Priority Guide (4) Display Strategic Importance and Manageability side by side (5) Enter indicated action for each initiative In future visits, this page may indicate which of the steps have already been completed in previous visits. 3. User is prompted to request “Generate Assessments Recap” [mandatory, though can be deferred until any point in this Use Case #8 as long as it is completed before advancing to Use Case #9]. Using the template in FIG. 29, the system may create the recap's five columns using data from previous use cases as follows: a. The first column, “Product Development Initiatives,” displays the client company's initiative names and letter ID's exactly as they appeared in Step 6b of Use Case #5, so that the complete set of portfolio initiatives displays. b. The second column, “Alignment with Brand Drivers,” converts data from Use Case #5 to horizontal bar graph representation (the longer the bar, the better the alignment between the development initiative and that particular driver). Specifically, the value underlying each bar graph in this column is determined by the total “weighted alignment points” for each initiative—as calculated in Use Case #5, Step 8b—as a percentage of total possible points. The system now calculates total possible points by first adding together the Brand Driver Importance Indices for all drivers included in Assessment 1 (Use Case #5, in which each driver is a separate column in the Alignment Dashboard), and multiplying that sum by 2 (2 points being the maximum total points for each rating, since HIGH rating equaled 2 as stipulated in Use Case #5). For example, if ten drivers were included in the Alignment Dashboard, and their respective 10 indices (each index, in this example, being between 50 and 100) added up to 800, total possible weighted alignment points would be 800×2, or 1,600. Next, each initiative's total weighed alignment points, as already calculated in Use Case #5, Step 8b, is divided by the 1,600 total points possible. So, for example, let's say that Initiative B's total weighted alignment points from Use Case #5 was 1,200, the horizontal bar graph for Initiative B in FIG. 29 would cover 75% of the total horizontal bar graphing area (visually representing 1,200 out of a possible 1,600 points, or 75%). The system completes this same process for each initiative in the portfolio until all initiatives have been graphed. When complete, Column B shows an alignment bar representing this percentage value for each initiative in Column A of the Assessments Recap and may also, at the user's option, display the percentage number on, or adjacent to, each bar. c. The third column in FIG. 29, “Competitive Impact,” converts data from Use Case #6 to horizontal bar graph representation. Specifically, the value underlying each bar graph in this column is determined by the total “weighted competitive outcome points” for each initiative—as calculated in Use Case #6, Step 7b—as a percentage of total possible points. Since each initiative's total weighted competitive outcome points has already been calculated, now the total possible weighted competitive outcome points may be calculated. Total possible points may vary from one Application project to the next, depending on the client company's current competitive situation as stored in the Competitive Situation Dashboard from Use Case #4, Step 8. The bigger the gap between the client company's current situation and attainment of superiority on a particular driver, the greater the number of possible competitive outcome points (i.e., the more room for improvement of competitive position on that driver). Accordingly, total possible competitive outcome points are calculated as follows:-System assigns “gap” values to the current competitive situation. Each “SUPERIOR” on the Competitive Situation Dashboard, indicating the client company is already superior on that driver, is assigned 1 point. Each “PARITY” is assigned 3 points. Each “INFERIOR” is assigned 5 points.-Each gap value assigned above is now multiplied by the corresponding brand driver's Brand Driver Importance Index (from Use Case #2, Step 8). The products of this multiplication for all the brand drivers are then added together, and the sum produces the total possible weighted competitive outcome points. For example, if ten drivers were included in the assessment and they had Brand Driver Importance Indices as shown below, total competitive outcome points would be derived as follows if the competitive situation and corresponding gap values are also as shown below (note: this is not a display of data for the user, but an example to demonstrate for the software developer how total possible weighted competitive outcome points are calculated) describing five columns of tabular data with the column headings DRIVER, COMPETITIVE SITUATION, GAP VALUE, BRAND DRIVER IMPORTANCE INDEX, and TOTAL POSSIBLE WEIGHTED POINTS. The DRIVER column lists the drivers of brand choice used in the Alignment and Competitive Impact Dashboards; the COMPETITIVE SITUATION column indicates “SUPERIOR,” “PARITY,” or “INFERIOR” as the client's current competitive position on each driver; the GAP VALUE column indicated the statistical value of each gap as stipulated in Use Case #8, Step 3c; the BRAND DRIVER IMPORTANCE INDEX column displays the indices per Use Case #2, Step 8; the TOTAL POSSIBLE WEIGHTED POINTS column displays the product of multiplying the Gap Value for each driver by that driver's Brand Driver Importance Index. The sum of all Total Possible Weighted Points displays at the bottom of the table as TOTAL POSSIBLE WEIGHTED COMPETITIVE OUTCOME POINTS FOR ALL DRIVERS.

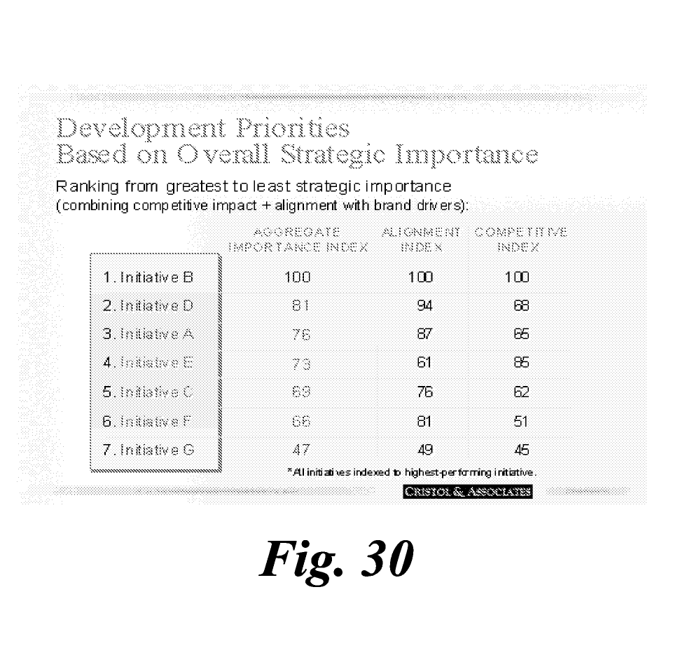

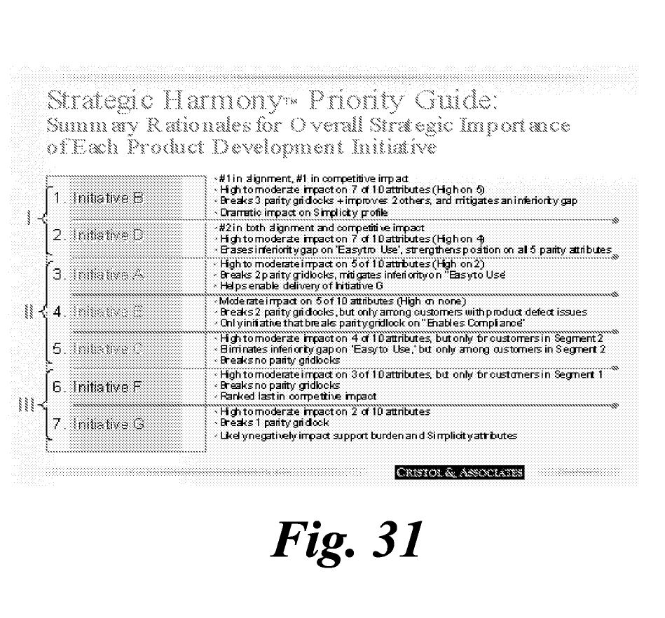

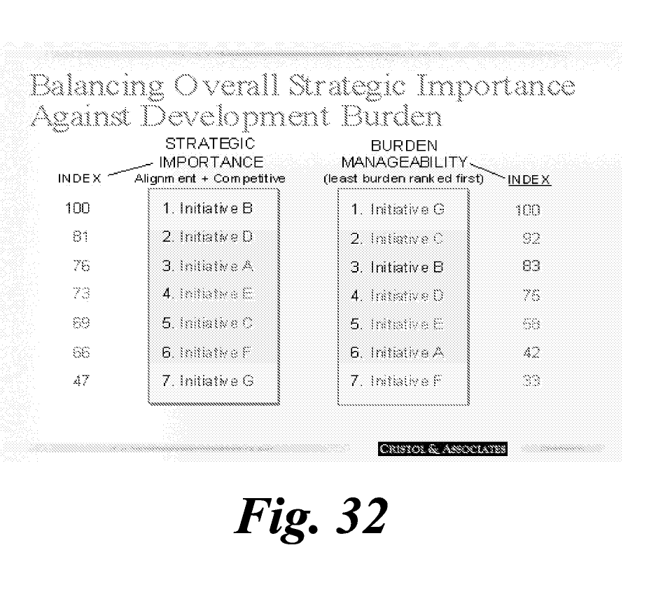

The system now may divide each initiative's total weighted competitive outcome points by the total possible points. To derive each initiative's total, the system may first add together that initiative's total weighted competitive outcome points on each driver (as already calculated in Step 7b of Use Case #6). For example, let's say that in Use Case #6, Initiative D's total weighted competitive outcome points on the “Scalable” driver was calculated to be 200. The system adds this 200 to the same initiative's corresponding total points for each of the other nine drivers, bringing Initiative D's total weighted competitive outcome points for all ten drivers to 1,000. The system then divides this 1,000 by the total number of possible points as derived above (1,547), producing 65% as an expression of the percentage of total possible weighted competitive impact points likely achievable by Initiative D if successfully brought to market. This calculation for each initiative provides the basis for the horizontal bar graphs in Column 3 (“Competitive Impact”) of the FIG. 29 Assessment Recap; in this example, then, the horizontal bar for Initiative D would visually cover approximately two thirds of the total horizontal graphing area in that column. The system completes this same process for each initiative in the portfolio until all initiatives have been graphed. When complete, Column C shows an alignment bar representing this percentage value for each initiative in Column A of the Assessments Recap and may also, at the user's option, display the percentage number on, or adjacent to, each bar. d. The fourth column (or Column D in the Excel-modeled FIG. 29), under the combined heading, “Manageability,” simply reprise the two columns of color bars already created in Use Case #7, Step 6b, for FIG. 28—one Resource Requirements color bar for each initiative and one Task Complexity color bar for each initiative—and displays them as here in FIG. 29 column 4 as an aggregate metric for Manageability. With these color bars displaying for each initiative in the portfolio, the Assessment Recap is now complete. 4. User is prompted to request “Generate Overall Strategic Importance Rankings” [mandatory]—a combination of alignment and competitive impact, as defined in “Terms and Definitions.” In this step, the system generates FIG. 30 by combining the results of product development portfolio Assessments 1 and 2 with equal weighting. To derive the Overall Strategic Importance Ranking for each initiative relative to the others, the system first derives an Overall Strategic Importance Index (alternatively known as the “Aggregate Importance Index”) for each initiative by adding together the initiative's Alignment Index from Use Case #5, Step 8c, and its Competitive Impact Index from Use Case #6, Step 7c, and then dividing the sum by 2. For example, in the prior use cases, the initiative “Full internationalization” had an Alignment Index of 100 and a Competitive Impact Index of 84, so its Overall Strategic Importance Index would be 92. When the system has calculated this index for each initiative, it ranks them in descending order and displays the results as in FIG. 30, showing—from left to right—the rank number, initiative letter ID and name, Overall Strategic Importance Index, Alignment Index, and Competitive Impact Index (the latter two columns are included so that the user can readily see the component parts of the Overall Strategic Importance Index and, therefore, the source numbers for the overall ranking) 5. User is prompted to “Create Application Priority Guide (importance rationale summary”) [mandatory] as shown in FIG. 31. This is simply a list of the Overall Strategic Importance rankings from Step 4, with text fields for the user to summarize the rationale for each ranking and, if appropriate, to manually override the rankings produced in Step 4 if there are justifiable subjective reasons to do so. Upon displaying the product development initiatives in descending order of Overall Strategic Importance (as in Step 4), and a text field to the right of each initiative (see FIG. 31), user is presented with the option of leaving the rankings as is or manually overriding them. (If override is selected, system allows user to change the order; system then refreshes the descending order display.) After selecting either option and seeing the final ranking of initiatives, user is prompted to “Enter strategic importance rationales” and may select “Now” or “Later.” (If “Later,” however, rationales are still mandatory before proceeding to Use Case #9.) To complete this step, user may cycle through the initiatives and, for each, may type in up to 400 characters of bullet-point text. (Alternate software embodiments may link to larger text fields for more detailed rationale notes, but this is not required in alternate software embodiments.) 6. User is prompted to request “Display Strategic Importance and Manageability side by side” [mandatory]. The system then generates FIG. 32, using the Overall Strategic Importance rankings and indices from Step 4 above for the left side and the Manageability rankings and indices from Use Case #7, Step 7b, for the right side. The user may study this display to consider the tradeoffs between which product development initiatives are most crucial strategically and whether the required development resources are disproportionately high or low. To visually assist the user in comparing each initiative's strategic importance to its burden, the system may automatically color code each initiative (so that, for example, Initiative A is yellow in both columns, regardless of its rank position, Initiative B is orange in both columns, etc.), or may display a color connecting line between Initiative A in the Importance column and Initiative A in the Manageability column (or may display both—whatever will help the user most readily compare the position of any single initiative in one column to that same initiative's position in the other column). 7. Based on data from Steps 3 through 6 above (if Step 3 was deferred by the user, it may be competed now), user is ready to suggest indicated actions for the client company in deciding how to allocate/reallocate product development resources and how quickly or slowly to proceed on bringing each product development initiative to market. User will want to be able to simultaneously reference reduced-size versions (if readable) of the completed Assessment Recap from Step and the Importance/Manageability comparison from Step 6 while entering data in this Step 7, so system may be able to display them simultaneously in frames if possible. (For use in this step, alternate software embodiments may allow user to display reduced-size versions of multiple outputs of the user's choice from all prior use cases, but this is not required in alternate software embodiments.) With these displayed for reference, user is now prompted to “Enter indicated action for each initiative” [optional, as this may be deferred until Use Case #9 or may even be omitted if Administering Consultant decides to write an indicated actions recommendation offline]. For each initiative, the system presents the following menu of possible actions; user may select the one most appropriate action for each initiative:-Speed up development-Maintain development speed-Slow down development-Suspend/kill development immediately If user selects actions that are variable (“Speed up” or “Slow down”), system presents user with a corresponding numeric field in which the user can enter the suggested intensity of that action; number entered may be a percentage <1000%, with no decimal places. When user has completed entries for all initiatives, all fields display as a summary of suggested indicated actions, in descending order from most positive to most negative recommendation, as shown in this example:

Column headings: INITIATIVE|INDICATED ACTION|INTENSITY, with tabular data displaying, for example, as |B. Executive dashboard|SPEED UP 1300%∥D. Full internationalization|SPEED UP|200%∥A. Auto-configuration|MAINTAIN|--∥C. Integration with customer console|SLOW DOWN|75%∥F. Real-time access to BMG database|SLOW DOWN|25%∥E. Live chat tech support|SUSPEND/KILL|--∥8. User may elect to print or create PDF of any displayed results from Steps 3 through 7. Alternatively, user may do this in Step 2 above, as indicated, in future visits. (Alternate software embodiments may provide ability to e-mail PDFs to client company or consulting colleagues, via Microsoft Outlook, without having to manually open Outlook and attach file, but this is not necessary in the prototype.) Alternative Paths: At Step 3, if no driver correlation coefficients or proxy coefficients were stored in the system in Use Case 2's Step 4 (and, therefore, no weighted alignment points were calculated in Use Case #5 and no weighted competitive impact points were calculated in Use Case #6), Steps 3b and 3c may use unweighted alignment points and unweighted competitive impact points, respectively, for the bar graphing calculations prescribed. At Step 7, user may wish to arrive at recommendations for indicated action through a less subjective method, and is therefore presented the option to “Calculate Application Composite Priority Scores” (a composite score for each product development initiative based on a formula that weighs development burden against strategic importance, as described in “Terms and Definitions”). To derive the Composite Priority Score (“CPS”) for each initiative, the system uses the Overall Strategic Importance Index (alternatively known as the “Aggregate Importance Index”) from Step 4 above and the Manageability Index generated in Use Case #7, Step 7. The default formula for calculating the Composite Priority Score for each initiative is (3x+y)/4, where x is the initiative's Overall Strategic Importance (Aggregate Importance) Index and y is the initiative's Manageability Index. For example, in FIG. 32, Initiative A has an Overall Strategic Importance Index of 76 and a Burden Manageability Index of 42, so Initiative A's Composite Priority Score would be 67.5 (applying the default formula, or ((3*76)+42)/4 in this case). Composite Priority Scores may display to one decimal place. System calculates Composite Priority Scores for all initiatives and displays the results in descending order in a table (which uses all the index values from the example in FIG. 32 in which there are seven initiatives in the product development portfolio) described as follows:

Column 1, with the heading RANK, displays the ranking of each initiative by Composite Prioirity Score; Column 2, with the heading INITIATIVE, displays the initiative name; Column 3, with the heading COMPOSITE PRIORITY SCORE, displays the raw CPS score as calculated in column 12 of FIG. 43.

Alternatively, user may [optional] require the capability to override the default formula with a custom formula. To do this, user is prompted to enter weighting ratio [mandatory for custom formula] for Importance:Manageability (the numeric field on either side of the ratio colon may accommodate integers <10; e.g., 5:2). (In the default formula, the Importance:Manageability ratio was 3:1 as expressed in the formula 3x+y, where x equaled Importance and y equaled Manageability.) User is provided a text box to enter rationale [optional] for the custom formula. System then substitutes the numbers from the custom ratio for the multipliers in the default formula and substitutes the sum of those multipliers for the default divisor, which was 4. (For example, if user stipulates a custom Importance: Manageability ratio of 2:1, the system may convert the default formula to the following custom formula: (2x+y)/3. For the Initiative A example above, this custom formula would yield a Composite Priority Score of 64.6, the result of ((2*76)+42)/3, instead of the 67.5 yielded by the default formula.) If the user chooses to override the default with a custom formula, the score results may display with a footnote at the Composite Priority Score column heading indicating that “Scores are based on custom formula, weighting Importance: Manageability at ______:______.”) After Composite Priority Scores are calculated and displayed, user may [optional] wish to have the system automatically convert the scores to indicated actions for speeding up, maintaining, slowing down, or suspending work on selected product development initiatives (actions such as those described in Step 7 above). While the user and/or client company may ultimately still decide the degree to which any single initiative may be sped up or slowed down, the system can show, as guidance, the degree to which any single initiative is above or below average in its CPS relative to other initiatives in the portfolio. (A default algorithm that uses these variances to prescribe specific indicated actions is currently being developed, but may not be included in alternate software embodiments.) To calculate and display the CPS variances, the system performs the following steps: (1) system calculates the mean of all Composite Priority Scores in the portfolio, producing a “Portfolio Mean CPS”; (2) for each initiative, system calculates the variance vs. the Portfolio Mean CPS (e.g., Initiative A's CPS minus Portfolio Mean CPS); (3) system displays variances from highest-above-mean to lowest-below-mean (using the CPS's from the example above, which yield a mean of 72.1) and displays the Portfolio Mean CPS at bottom of table for reference a follows (this example uses the same CPS's calculated and displayed above): INITIATIVE CPS VARIANCE vs. Mean; Initiative B 95.8+23.7; Initiative D 79.5+7.4; Initiative C 74.8+2.7; Initiative E 69.3-2.8; Initiative A 67.5-4.6; Initiative G 60.3-11.8; Initiative F 57.8-14.3 Portfolio Mean CPS=72.1

Using these variances as guidance, user may now complete Step 7 above by selecting appropriate actions (e.g., speed up, maintain, slow down, or suspend) and action intensity for each initiative. The implication is that, all other things being equal and total product development resources being fixed, the client company may want to speed up (assign more resources to) any initiative with a CPS significantly above the Portfolio Mean CPS and to slow down (assign less resources to) any initiative with a CPS significantly below mean, and suspend work on any initiatives with a CPS far below mean. Future versions of software may include the algorithm that may convert these variances to specific actions and intensities (e.g., “Speed up Initiative D at 40% resource increase”) that may balance the total product development resource pool by moving resources to initiatives with higher CPS's and away from initiatives with lower CPS's—resulting in a more strategically effective reallocation of a fixed development budget. Alternatively, the client company may elect to set targets for generating product development cost savings at specifiable levels. For example, a client company asks to run the model so that a total resource reduction/cost savings of 10% is achieved and the remaining resources are reallocated across all initiatives that are not suspended. (Note that practical considerations may override the output of the model, since the model cannot account for exceptional considerations that are beyond the scope of the software such as when a particular initiative has already been promised to important customers and may therefore be delivered even if the initiative has a very low CPS, or when a new product with a low CPS may still be essential to complete a product line so that the client company can be a “one-stop shop” or “full-service vendor.”)

Use Case #8 Post-Conditions—All use case data entry is saved in the system, available for Administering Consultant to access, modify, or delete, and is accessible to other valid users on a read-only basis. When this use case ends, user may either log off or proceed to other use cases.

2.9 Use Case #9—Build Presentation—In Use Case #9, the Administering Consultant uses the system to assist in building a PowerPoint-style presentation of assessment results and recommendations that can either be presented from the Application server, via an Internet connection, or exported to PowerPoint for offline use as a standalone .ppt file or conversion to PDF. (Since it is currently possible, though more tedious than ultimately envisioned, to completely develop a final client presentation in PowerPoint outside the system, several of the steps below describe functionality that may not be required in the alternate software embodiments unless its development is manageable. The Flow of Events below attempts to distinguish between what is essential in the prototype vs. what is essential in a finished application, but developer feedback may determine what actually gets built in the prototype.)

Use Case #9 Pre-Conditions—The first three pre-conditions of Use Case #1 are also applicable here. Alternatively, the Administering Consultant may be coming to this Use Case #8 directly from other use cases without logging off and back on. Additional pre-conditions: 1. Use Cases #1, 2, 4, 5, 6, 7, and 8 have all been completed and their data stored in the system. This is the only additional pre-condition for Use Case #9. Note: Administering Consultant may wish to begin presentation development before Use Case #8 has been completed. The system may allow this, although presentation cannot be completed in Use Case #9 without the prior completion of Use Case #8.

Use Case #9 Flow of Events—1. User enters Project ID code. 2. User navigates to project home page and selects “Build Presentation.” To eliminate any user confusion (especially when Administering Consultant and Consultant Facilitator are not the same person) between the workshop briefing presentation discussed in Use Case #3 and the final results and recommendations presentation that is the focus of Use Case #9, system asks user to choose between “Workshop briefing presentation” and “Results and recommendations presentation.” If user chooses “Workshop briefing presentation,” s/he is routed directly to Use Case #3, Step 7. If user chooses “Results and recommendations presentation, s/he continues with this Use Case #9 and proceeds to Step 3 below. 3. If Use Case #9 has been started or completed in a previous visit, user may elect to view or print the unfinished draft presentation or, if completed, the finished presentation. If Use Case #9 has not been started (as assumed here and in Step 4 below), user is presented with option to view sample client presentation (which currently exists as a Cristol & Associates/Strategic Harmony® Partners MS PowerPoint file and may be provided to the software developer for storage in the system). 4. User is presented with two options: (1) “Customize sample presentation” or (2) “Build presentation from scratch.” Regardless of the user's selection, in the finished Application software application the system may export to MS PowerPoint all the output displays from Uses Cases #4 through 8 as individual slides that can be edited and pasted into either the sample presentation or a from-scratch presentation. (This is not required in alternate software embodiments, as each system output display can be manually copied and pasted into PowerPoint. Then edits can be done offline within PowerPoint, and the final PowerPoint presentation can be brought back into the system when completed.) 5. Once the final presentation is stored in the system and can be run from the Application server, the user may wish to link certain content within the presentation to other related content that is stored in the system from previous use cases but has not been included in the actual presentation slides. (Depending on the complexity of developing this capability, it may be reserved for the finished application.) 6. User may elect to print or create PDF of a draft or completed presentation, or any portion of either. (Alternate software embodiments may provide ability to e-mail PDFs to client company or consulting colleagues, via Microsoft Outlook, without having to open Outlook and manually attach file, but this is not necessary in the prototype.) 7. When Administering Consultant is ready to leave this Use Case #9, s/he is prompted to “Set presentation status for other users” [mandatory] and is presented with four options. “Presentation Status” options include: (1) “Draft in progress,” (2) “First draft completed,” (3) “Final draft completed,” or (4) “As presented to client.” User is then prompted to “Set access level for other users” [optional]. User may prohibit his/her colleagues' read-only access to a draft in progress or first draft completed, if desired. (Other users' access is always read-only at any stage of presentation completion; as specified in pre-conditions, only the Administering Consultant can manipulate the content in Use Case #9.) If user skips this step, any content resident in the presentation build may be accessible to other users on a read-only basis.

Alternative Paths: At Step 2, if user is not the Administering Consultant, s/he may choose to view client presentation. If Administering Consultant has not prohibited access in Step 7 above, the presentation in its most recently stored state displays as read-only and can, at the user's option be printed but not yet converted to PDF. If Administering Consultant has prohibited access to draft in progress or first draft, and either of those was selected in Step 7 above as the current status of the presentation, system presents message such as, “Draft presentation not yet complete or available for viewing.”

Use Case #9 Post-Conditions—All use case data entry is saved in the system, available for Administering Consultant to access, modify, or delete, and is accessible to other valid users on a read-only basis. When this use case ends, user may either log off or proceed to other use cases.

2.10 Use Case #10—Access Management Tools—In Use Case #10, which may occur at any time relative to all other use cases, users may monitor project status for any/all Application projects currently in progress within the consulting firm, or access any completed project. Users can also access the Consensus Builder tool, ROI analysis tool, and Customer Research RFP Builder tool—as well as the Reference Library, including a Application overview, tutorials, and best practices information. Management and reference tools as described below may only be placeholders in the alternate software embodiments, but fully functional in the finished application. All aspects of Use Case #10 are optional for the user, as it is possible to successfully complete all prior use cases without engaging in any of the activities described below.

Use Case #10 Pre-Conditions—1. A valid user has logged on to the system. 2. User has been authenticated as Administering Consultant (authorized to enter data, make changes, perform analyses, etc.) Other users are limited to read-only browsing access except as noted below in “Alternative Paths. 3. A consulting project has been previously set up and assigned a name and Project ID code. 4. Completion of Use Cases #1, 2, 4, 5, 6, 7, 8, and 9 may be required only for portions of Steps 2 and 3 below as noted.

Use Case #10 Flow of Events—1. User navigates to project home page and selects “Management Tools.” User is presented with six options and, within the sixth, three sub-options as shown: (1) Check status of projects in progress (2) Access completed projects (3) ROI Analysis tool (4) Consensus Builder tool (5) Customer Research RFP Builder (6) Reference Library—including Application Overview, Tutorials. Tutorials are subject-specific training aids with content beyond that contained in Online Help. Online Help may always be readily accessible in any use case at any time without requiring the user to navigate through Management Tools. Online Help is only a placeholder in alternate software embodiments, but its easy accessibility may be indicated throughout in prototype navigation. and Best Practices User may select any of the above options in any sequence. For the purposes of this written use case, user may proceed through the options sequentially. 2. User selects “Check status of projects in progress” from Step 1 menu above. A list or menu then displays all valid active projects with their respective Project ID codes. In case the user is someone other than the Administering Consultant and is not aware that a project has been recently completed, the displayed project list may also automatically include any project that has been completed (presented to client company) within the last 90 days, and the project name may display with “(COMPLETED)” parenthetically following the project name. (The system may know if and when a project has been completed based on user action in Use Case #9, Step 6; there, if user selected “As presented to client” as the Presentation Status, the system considers that project complete as of the date of that action.) User then selects the in-progress project of interest. (If user selects a completed project, see “Alternative Paths” below.) Upon project selection, system reports which among Use Cases #1-#9 have been completed and which is in progress. For example, if selected project has been completed through Use Case #6 and Use Case #7 has been started (e.g., inputs entered, but assessment not yet performed), system would display project status as: “Completed through Competitive Impact Assessment. Manageability Assessment in progress.” Administering Consultant may also be provided with a “Comments” text box here to add other status information of potential interest to read-only users, such as more detail about the recently completed use cases and/or next steps, and projected timelines for completion. Alternate software embodiments may simply display sample results and a fictitious project list. The finished application may not only include the functionality above, but also may display a monitoring map that plots the status of each active project on a Application process flowchart (described in Section 1.4 under “Process Overview and Monitoring”). 3. User selects “Access completed projects” from Step 1 menu above. A list or menu then displays showing all valid completed projects with their respective Project ID codes and date of completion (date that Administering Consultant selected “As presented to client” as the Presentation Status in Use Case #9, Step 6). Alternate software embodiments may only be required to display a fictitious project list. When the user selects a specific completed project, the system regards that selection as entry of the Project ID (as if it had occurred as stipulated in Step 1 of all other use cases), and user may then proceed to any authorized use of any other use case connected with that project. 4. User selects “ROI Analysis tool” from Step 1 menu above. System presents three options: (1) explore ROI tool, (2) conduct ROI analysis, (3) view completed ROI analyses for specific project. This is all that may be required as a placeholder in alternate software embodiments; additional future use case documentation may provide ROI feature specifications for the finished application, as well as providing a sample analysis to display. 5. User selects “Consensus Builder tool” from Step 1 menu above. System presents three options: (1) explore Consensus Builder, (2) configure Consensus Builder, (3) view Consensus Builder results for specific project. This is all that may be required here as a placeholder in alternate software embodiments. However, active use of the Consensus Builder is critical to Use Case #2, Step 4, in those instances (referenced in Use Case #2) when client company internal consensus may be used in lieu of customer research to provide proxy coefficients that prioritize brand choice drivers. Complete Consensus Builder functionality may be required in the finished Application software application and may be specified in a future edition of this Master Use Case document. 5. User selects “Customer Research RFP Builder” from Step 1 menu above. System presents three options: (1) “View sample RFP,” (2) “Build Request for Proposal,” (3) “Retrieve saved RFP.” Full RFP building functionality is not required in alternate software embodiments; the finished application, however, may provide a wizard that guides the user through questions enabling the system to generate a customized RFP in the format of the sample RFP, save it to the system, and e-mail it to selected marketing research firms. Meanwhile, alternate software embodiments can present the sample RFP (which currently exists as a Cristol & Associates MS Word file, which ultimately may serve as an editable template). 6. User selects “Reference Library” from Step 1 menu above. System presents three options: (1) Application overview, (2) Tutorials, (3) Best Practices. If user selects option #1, system presents the Application master flowchart (shown on page 12) and allows user to view the generic Application overview presentation used with prospective clients. If user selects option #2, a menu of pre-packaged tutorials may appear—but tutorial content is not required in alternate software embodiments. If user selects option #3, system may present a menu of Best Practices modules; as with tutorials, best practices content is not required in alternate software embodiments.

Alternative Paths: At Step 1, user is visiting Management Tools only for general reference information or training purposes rather than to manage or work with an actual client company project. For this alternative path, Pre-Conditions #2 and 3 above are not necessarily required. Other embodiments of the software provide for the consultant user to be presented with the same menu of options with information and functionality that provide limited option, for example, in cases in which information and functionality are already limited as indicated above. Alternatively, the Administering Consultant may be allowed to use the ROI tool to conduct and analysis for an actual client company project stored in the system. In yet other embodiments, consultants may use the tool for training and/or obtain general information to view a completed analysis. At Step 2, the user sees that the project s/he wanted to check status of is now complete and, upon selecting that completed project from the project list, is taken directly to the point in Step 3 as if s/he had already chosen the “Access completed projects” option and selected the specific project of interest.

Use Case #10 Post-Conditions—In alternate software embodiments, any data entry in using the Consensus Builder tool, ROI tool, or RFP tool is saved in the system, available for Administering Consultant to access, modify, or delete, and is accessible to other valid users on a read-only basis. (In alternate software embodiments, there may be no data entry with these tools as they are only placeholders.) When this use case ends, user may either log off or proceed to other use cases.

Section 3 User Interface and Screen Shots Guide—Among the accompanying drawings are previously prototyped screen shots and tabular templates referenced in the preceding use cases. Below is a guide to screen shot prototypes organized by the functions of gathering inputs, analyzing inputs, generating outputs, building presentations, and using miscellaneous tools. Note to developer: Screen shots not currently prototyped in Microsoft PowerPoint or Microsoft Visio were principally done in Microsoft Excel 2000 or 2002, as were tabular templates, so the graphic and color limitations of these as shown in this document are obvious when viewed on-screen or in color hardcopy. Where specifically noted in Section 2 use case details, however, particular colors used have specific strategic meaning, and the software application may retain those color families as specified (e.g., not necessarily the same shade of green, red, or amber, but colors that users would clearly recognize as green, red, or amber). Elsewhere, the developer is free to judiciously apply color wherever it enriches communication effectiveness/readability and aesthetics, weighed against loading time and ability to print legible hard copies from the client-side application.

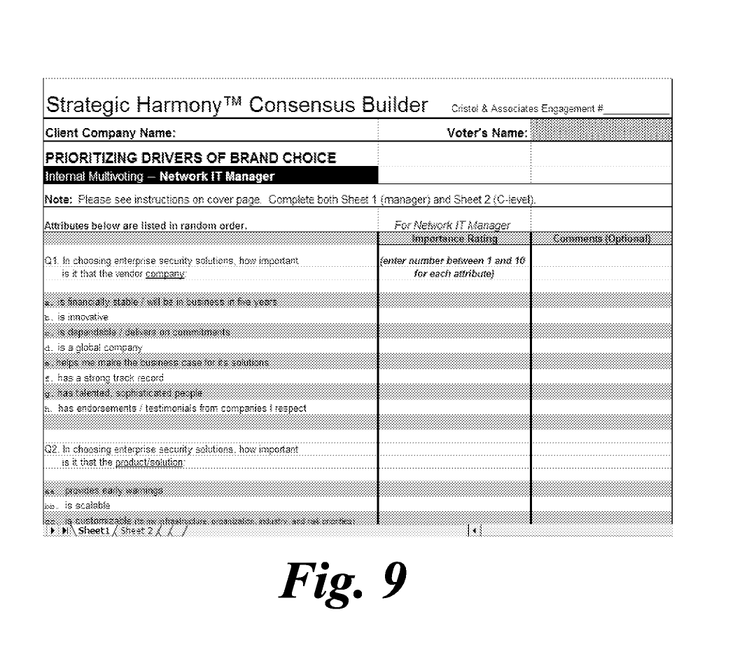

FIG. 5 depicts an entity relationship of brand strategy architecture. The brand strategy includes three levels—Level 1 defines brand promise, level 2 defines promise components, and level 3 defines proof points. The level 1 brand promise defines what the brand stands for—its pledge to customers. This describes what to say, rather than how to say it (not usually an advertising execution). The level 2 promise components comprise the key drivers of brand choice, which must be prioritized and dimensionalized into their specific sub-attributes. The level 3 proof points provide reasons to believe why the brand excels on attributes that drive brand choice, and may include products and solutions, features, functions, support, services, attitude, reputation, endorsement, partners, return on investment (ROI) business cases, and/or pricing. The brand strategy architecture includes 1, Brand Strategy Architecture template; 2, Brand Strategy Architecture completed example (see FIGS. 5, 6 and 7), 3; Drivers of Category Adoption rankings and correlation coefficients (not shown, but similar to FIG. 9 in which “Category Adoption” is substituted for “Brand Choice”); 4, Drivers of Brand Choice rankings and correlation coefficients (see FIG. 10); and 5, Proof Points Inventory (see FIGS. 18 and 20).

FIG. 6 illustrates an example of a Brand Strategy Architecture in the first embodiment for an iMac® brand strategy referenced above. The iMac® example brand strategy includes the three levels referenced in FIG. 5, with specific applications relating to the iMac® brand. The level 1 brand promise defines that iMac® brand stands for the simplest internet and computing experience. The level 2 promise component defines the drivers for the iMac® brand to be ease of purchase, ease of use, and performance. The level 3 proof points for the iMac® brand include providing an all-in-one-box/one-price entity that has the fastest setup and easiest to use computer system. Other proof points include a less complex computer system with fewer parts to break, one-button Internet access, the legendary Mac® user interface, and the assurance of same by the Apple logo. Proof point performance factors include speed, faster than comparable computer systems of its time, and ease of use of Internet based applications.

FIG. 7 is an example expansion of the Level 2 entity relationships of the Imac® Brand Strategy Architecture of FIG. 5. The promise components of the Level 2 Imac® brand strategy architecture includes metrics for ease of purchase, ease of use, and performance. Ease of purchase is further dimensionalized by sub-attributes including easy to select, easy to find, easy to order and/or purchase, and having flexible and simple financing. Ease of use is further dimensionalized by sub-attributes including easy to setup, easy to get on the Internet, easy to perform basic tasks, an operating system having an intuitive interface, a computer system having good documentation, and a company having easy to reach and competent support. Performance is further dimensionalized by sub-attributes including speed, sufficient memory, and smooth execution of software applications.

FIG. 8 depicts a Strategic Harmony® example of Level 2 driver listings with identifiers and association factors similar to those described in FIGS. 6 and 7. The driver listings are identified by driver name, defined by a description in those cases where the name is not self-explanatory, and qualitatively assigned to a factor-level association unless one is provided quantitatively through a common multivariate statistical technique known as factor analysis. A representative driver name list in the example from an enterprise software market includes financially stable vendor, innovation, scalability, whether company is global, whether the company is cooperative in making a business case, whether the company or group has a strong track record for delivering on commitments, has a good reputation, provides support at all times during the year (“24×&×365”), provides trustworthy data, and engages in high-quality reporting. Other driver names include products or services being customizable, interoperable, flexible easy to use and/or deploy, economical—including low cost of total ownership, saves time, easy to maintain, have performance characteristics compliant with regulatory agencies, and delivers a demonstrable ROI to the company or group. Additional driver descriptions includes customizable being defined to being customizable to a given infrastructure, organization, and/or industry. Integrated solutions means that the solutions are seamlessly combined from multiple points. Trustworthy data means that the data is credible, current, global, and accurate, or at least a combination of any two or more of the preceding. Interoperable means capability to work with existing infrastructure and/or with other vendor's applications, known and/or planned. In software cases, low cost of ownership is defined to mean having low software to hardware migration costs, and exhibit substantially resource efficiency. With regards to factor-level association, the drivers are qualitatively characterized to have trust, control, simplicity, and value.

FIG. 9 depicts an expansion of another Strategic Harmony® screenshot example for prioritizing Level 2 drivers of brand choice using the Application Consensus Builder tool in the case of applications related for use by a network IT manager. The prioritizing is presented in a focused questionnaire in which attributes are listed in random order within a series of queries. The network IT manager provides answers to the queries in the form of an importance rating in a scoring range between 1 and 10 for each of the queried attributes. An adjacent column provides for optional comments from the IT manager. In this screenshot question 1 asks how important is a vendor company that provides enterprise security solutions to be financially stable, innovative, dependable, is global, is responsive to finding solutions to the IT managers business case, has competent and sophisticated people, and provides endorsements and testimonials from respected companies. Question 2 asks how important a given enterprise security solution is scalable, provides early warnings, and is customizable to the IT manger's organizational infrastructure. The “how important” answer to the queries attributes is provided by the IT manager's declaring a numeric value or ranking value between 1 and 10, along with any optional comments.

FIG. 10 depicts a screenshot having a tabular illustration of examples of enterprise software having simplicity factor level association defined by numerical correlation coefficients. The correlation with brand choice varying between 0.09 and 0.56 is shown for attributes easy to deploy, interoperable, easy to use, easy to maintain, integrated solution, easily accessible support, runs from a single console, and easy to purchase and/or license.

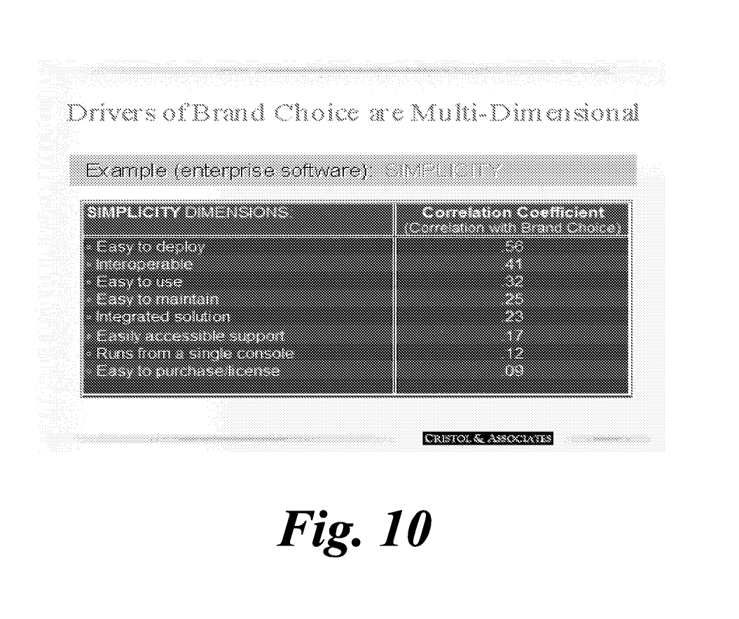

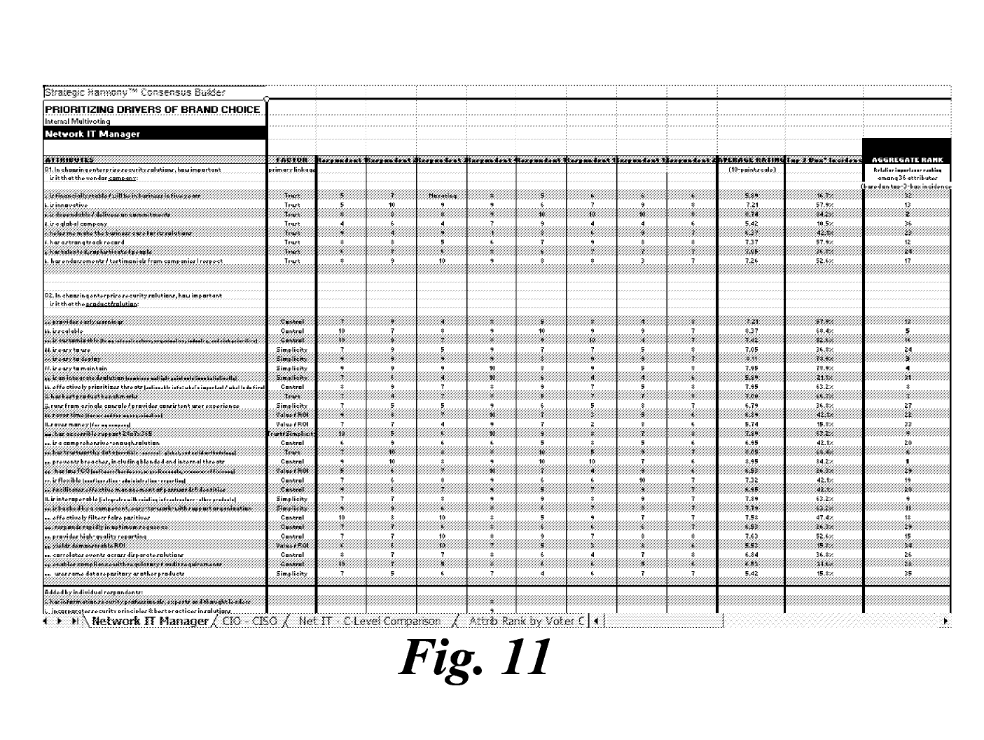

FIG. 11 is a screenshot illustration from the first embodiment that shows how the output of the Consensus Builder tool displayed in a spreadsheet. The output shows the 1-10 ranking value by IT manager respondent against queried attributes as a means for prioritizing drivers of brand choice. Adjacent to the queried attributes is the factor-level association of trust, control, simplicity, and value/ROI. An average rating column, a top 3 bar incidence column, and an aggregate ranking column is filled with calculations derived from the numerical values provided by the IT manager respondents. In this screenshot is partially shown a attributed rank by voter organization tab.

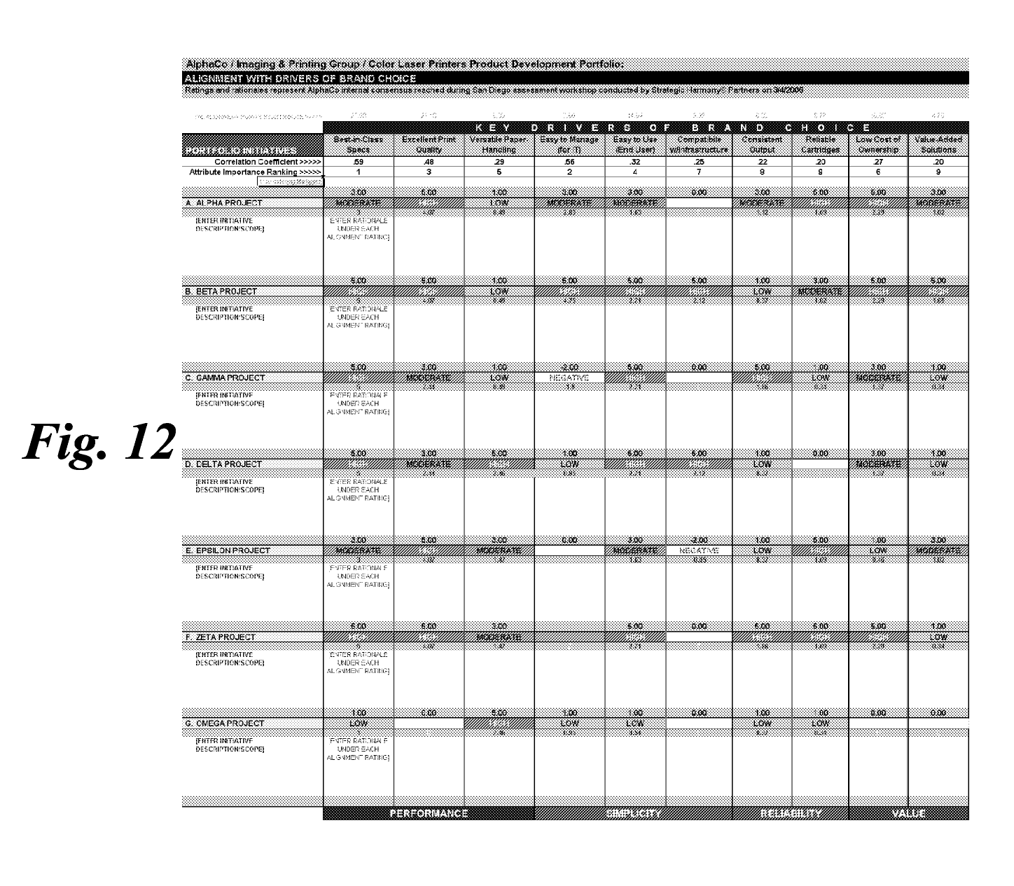

FIG. 12 is a screenshot illustration of the Strategic Harmony® Alignment Dashboard showing of the assessment results for the relative impact that each product development initiative will likely have on key drivers of brand choice.

FIG. 13 is a screenshot depiction of the “Pacing Guide—Strategic Harmony® Proof Points Session” that Application workshop facilitators use to set workshop pacing targets. This screenshot present users with categorical and numerical information to permit editing pacing guides and to save edits under certain organizational circumstances that dictate spending a little more or a little less time on certain drivers and initiatives rather than spending equal time on each one. The equal time being the default that the Pacing Calculator would automatically prescribe, since it divides a fixed amount of time by a fixed number of drivers/initiatives.

FIG. 14 is a screenshot depiction from the first embodiment of the “Pacing Guide—Strategic Harmony® Portfolio Session” that Application workshop facilitators use to set workshop pacing targets. In this screenshot the Development Initiative names may each display with a letter ID, sequentially—i.e., A, B, C, etc. Thus as described above, if Use Case #3 was not completed, the list of initiatives displays, user may be prompted to enter: (1) Initiative Description [optional] and (2) Alignment Rating [mandatory], explained previously in “Terms and Definitions.” Though Initiative Description is optional, it is strongly encouraged in training—so skipping it may elicit a prompt such as “Skip description of Initiative A?” The Initiative Description field may accommodate text entry up to 700 characters, to insure that the scope of the initiative is sufficiently communicated to all users who may need to reference portfolio content. User is then prompted to enter Alignment Rating for each initiative on each driver of brand choice included in the assessment (as entered and stored in Use Case #1, Step 4, and presented here in order of Importance Ranking as stored in Use Case #2, Step 5). For each initiative, user is presented with five possible ratings on each brand driver:-HIGH IMPACT-strong alignment; likely yielding high positive impact on how brand is perceived by customers on this driver-MODERATE IMPACT-moderate alignment; likely yielding significant positive impact on this driver, but not as much as those initiatives rated “High”-LOW IMPACT-low alignment, likely yielding minor impact on this driver-NO IMPACT-no, or negligible, impact on this driver-NEGATIVE IMPACT-inverse alignment; likely to hurt brand perceptions on this driver.

FIG. 15 is a screenshot depiction of the templates used for capturing Proof Points Workshop output described as a Proof Points Inventory/Audit and Competitive Assessment. Drivers of brand choice are entered, along with the brand that currently most excels on each driver. Then the client's most compelling proof points, or reasons to believe they excel on a particular driver, are entered in columns labeled FEATURES, SERVICE(S), and OTHER.

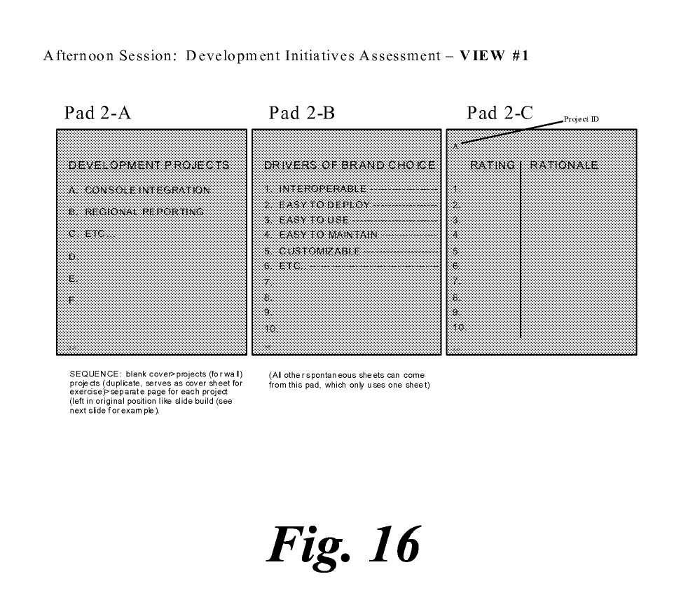

FIG. 16 is a screenshot depiction of the templates used for capturing Product Development Portfolio Workshop output in the form of a Development Initiatives Assessment. In this second session conducted by consultants, development projects are summarized and consensus-rated on each driver of brand choice, with a client-supplied rationale entered for each rating.

FIG. 17 is a depiction from using whiteboards in facilitating required team discussions during Proof Points and Product Development Portfolio Workshops. Consultants format the whiteboards to display product scope, competitors, brand choice drivers, and proof points categories. Other whiteboards are formatted for portfolio sessions to display development projects, brand choice drivers, brand(s) to beat, and competitive impact. The whiteboards may be presented alternatively on easel pads, flat screen digital televisions, analog equivalents, or projected by computer-driven digital projectors.

FIG. 18 is a tabular illustration of Proof Points Inventory template designed for output to a spreadsheet program. Driver dimensions of “Control,” in this example for an enterprise software product, are set up to capture and display control proof points that provide reasons to believe that a client's brand offers customers excellent and/or superior control.

FIG. 19 is another tabular illustration for entry of driver dimensions distributed among proof points for control by factor name field that is changeable with each sheet of the Proof Points Inventory workbook.

FIG. 20 is a screenshot example from a completed Proof Points Inventory for a fictitious enterprise software company. Here the screenshot depicts simplicity proof points to delineate reasons for a client's brand being superior by features, services and solutions. Note the tabs at the bottom indicating additional sheets in the workbook representing additional choice-driving attributes.

FIG. 21 is another screenshot example of a “current competitive situation” baseline inventory of product characteristics distributed among—in this example of an enterprise software product—simplicity, control, trust, and value categories and further classified according to whether superior, parity, or inferior to competing entities on each key driver of brand choice.

FIG. 22 is a screenshot example of how results display from an Alignment Assessment of a product development portfolio. Displayed is the likely impact that each product development initiative, as currently scoped, will have on each key brand choice driver and, therefore, to what degree each initiative is aligned with those aspects of ideal customer experience. Initiatives are rated according to whether their potential impact is high, low, moderate, negliglible, or negative.

FIG. 23 is a screenshot illustrating a bar chart display from calculating the attribute-specific relative impact of the collective initiatives in a product development portfolio.

FIG. 24 is a screenshot example of results obtained for product development initiatives' potential competitive impact on key drivers of brand choice and distributed among cells of a spreadsheet by category, numerical scores, and competitive classification determined from conducting a Competitive Impact Assessment of a product development portfolio;

FIG. 25 is a screenshot example of a Competitive Impact Assessment showing the potential competitive impact of one selected initiative from a product development portfolio.

FIG. 26 is a screenshot example a total portfolio view of Competitive Impact Assessment results that shows the collective potential competitive impact of all product initiatives in a product development portfolio.

FIG. 27 is a screenshot example of a “compressed dashboard view” of the Competitive Impact Assessment that eliminates the rating rationales text.

FIG. 28 is a screenshot example of how results are displayed from a Manageability Assessment.

FIG. 29 is a screenshot example how a Product Development Portfolio Assessments Recap is displayed.

FIG. 30 is a screenshot example of Overall Strategic Importance rankings and indices that shows each importance index's Alignment and Competitive components.

FIG. 31 is a screenshot tabular example of a Strategic Harmony® Priority Guide is displayed to provide a rationale for overall strategic importance.

FIG. 32 is another screenshot tabular example of balancing strategic importance against manageability.

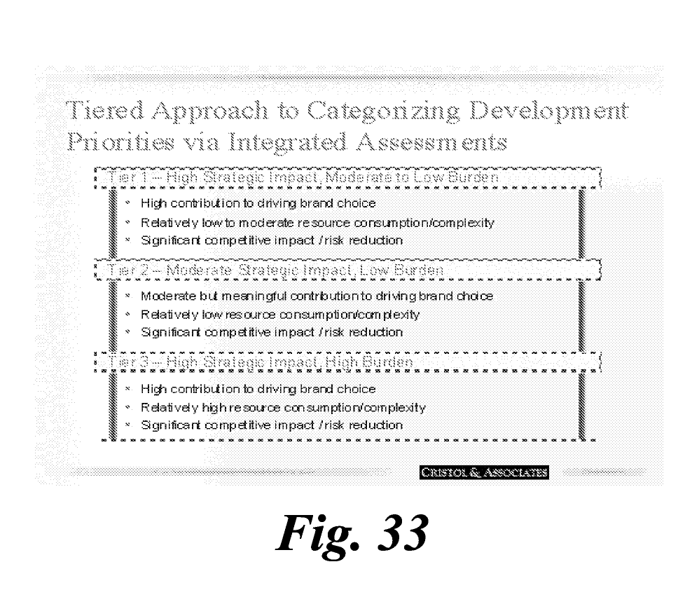

FIG. 33 presents a tabular screenshot graphic of a tiered approach to categorizing development priorities via integrated assessments.

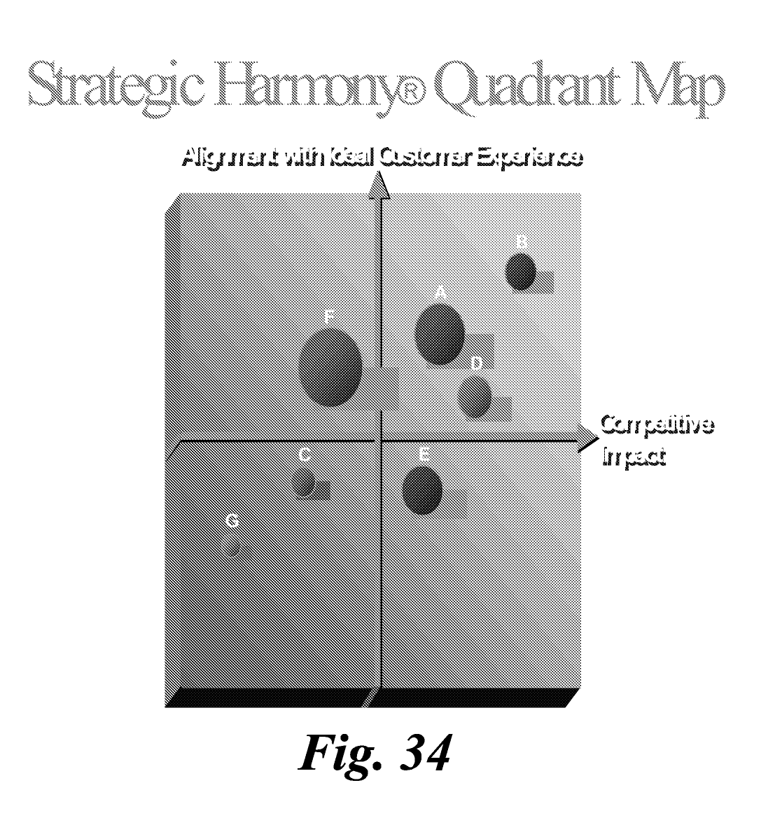

FIG. 34 presents a screenshot graphic of a Strategic Harmony® Quadrant Map integrating alignment, competitive impact, and Manageability scores into one graphical representation. Here an alignment ideal vs. competitive impact is plotted with variably sized oval shaped spheres A-G. The size of the oval shaped spheres A-G vary approximately in proportion to development burden in terms of resources and complexity.

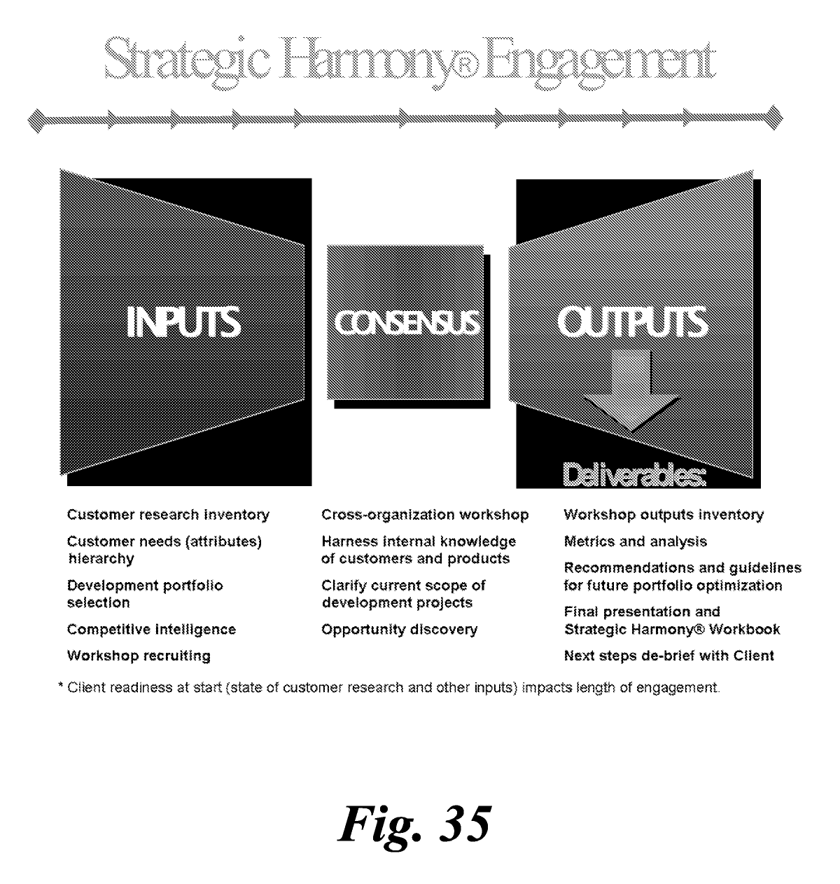

FIG. 35 depicts a screenshot graphic concerning inputs, consensus, and deliverable outputs to show key phases of how the method is implemented in a typical client consulting engagement;

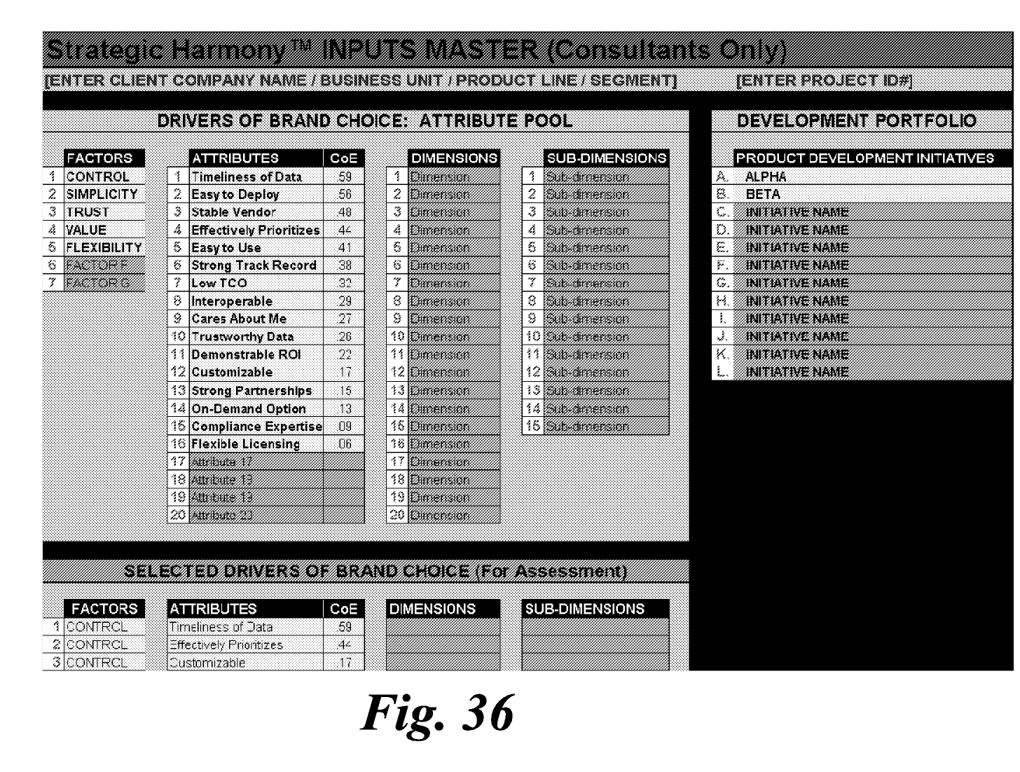

FIG. 36 depicts a spreadsheet screenshot of an inputs master for use by consultants before project-specific data is entered.

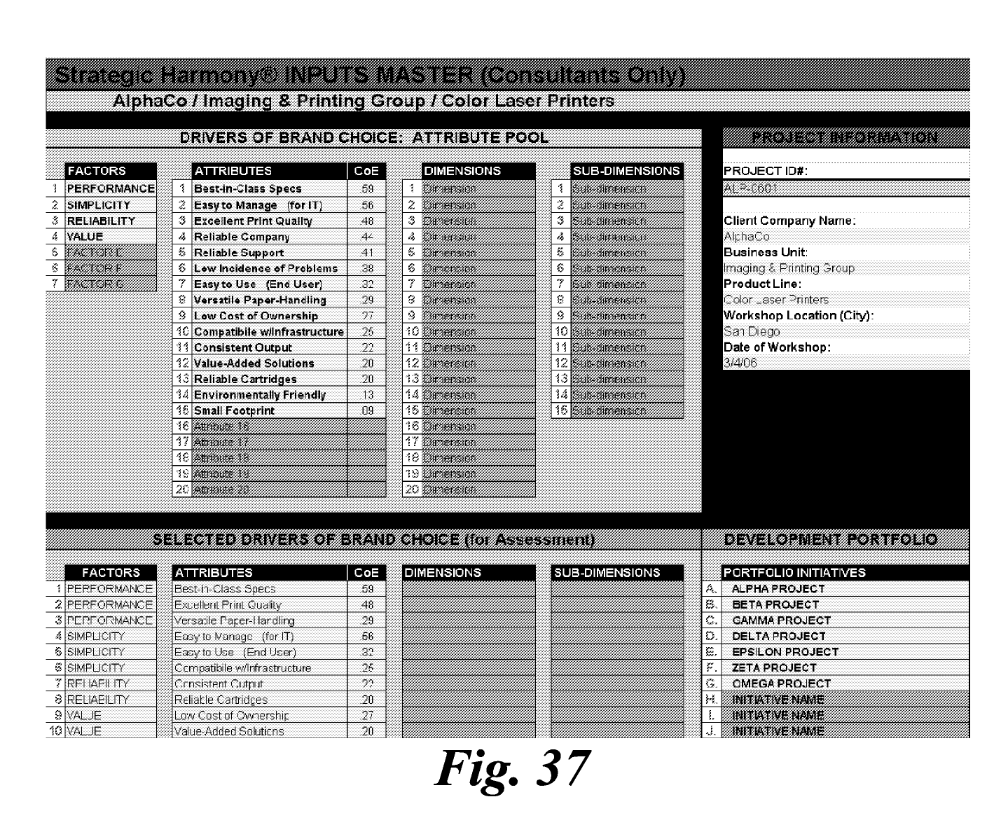

FIG. 37 depicts another spreadsheet screenshot of an inputs master for use by consultants after the consultant enters project-specific data.

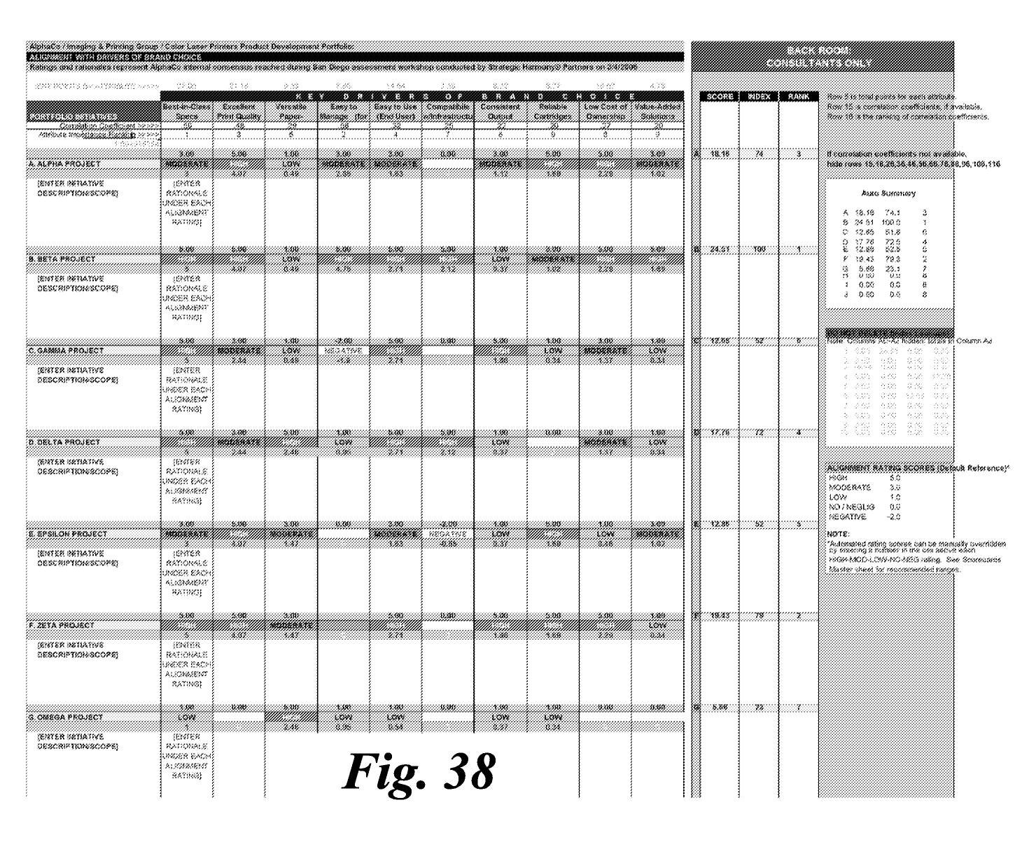

FIG. 38 depicts a spreadsheet screenshot concerning alignment with drivers of brand choice and illustrates a region denoted “Back Room: Consultants Only” where Strategic Harmony® mathematical formulae are applied to produce various metrics. (“Back Room” appears in the software embodiment of the Application as a computation and reference area of the spreadsheet that is outside the visible print area accessible by client companies and is hidden in the final dashboards transmitted to clients. Consultants not only use this area to study relationships between selected data, but also use the reference value ranges as reminders on what degree of latitude they have to subjectively modify values based on a combination of their professional experience and any extenuating circumstances or unusual client company assumptions underlying the presence of certain data present there. The foregoing description of “Back Room” applies to all subsequent mentions of “Back Room” in other applicable figures.)

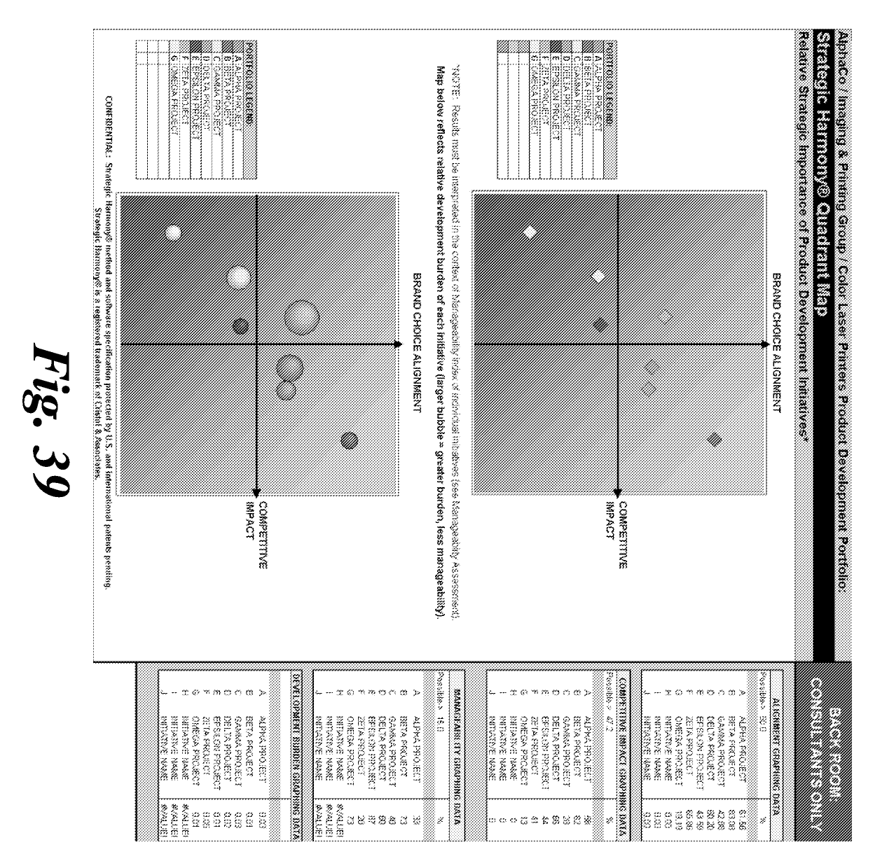

FIG. 39 depicts screenshot graphics of a two-dimensional Strategic Harmony® Quadrant Map integrating Alignment and Competitive Impact scores, and a three-dimensional Quadrant Map integrating Alignment, Competitive Impact, and Manageability scores. Both graphs are quadrant maps that illustrate a brand vs. competitive impact. In the upper plot illustrate graphical locations of different management indices by differentially colored diamonds of approximately the same size. In the lower plot the size of the circular spheres vary in color and size to illustrate relative development burden. That is, the size varies approximately in proportion to development burden of each initiative in terms of resources and complexity. That is, the larger the circular sphere or bubble, the greater the burden and the less manageable a given product development initiative.

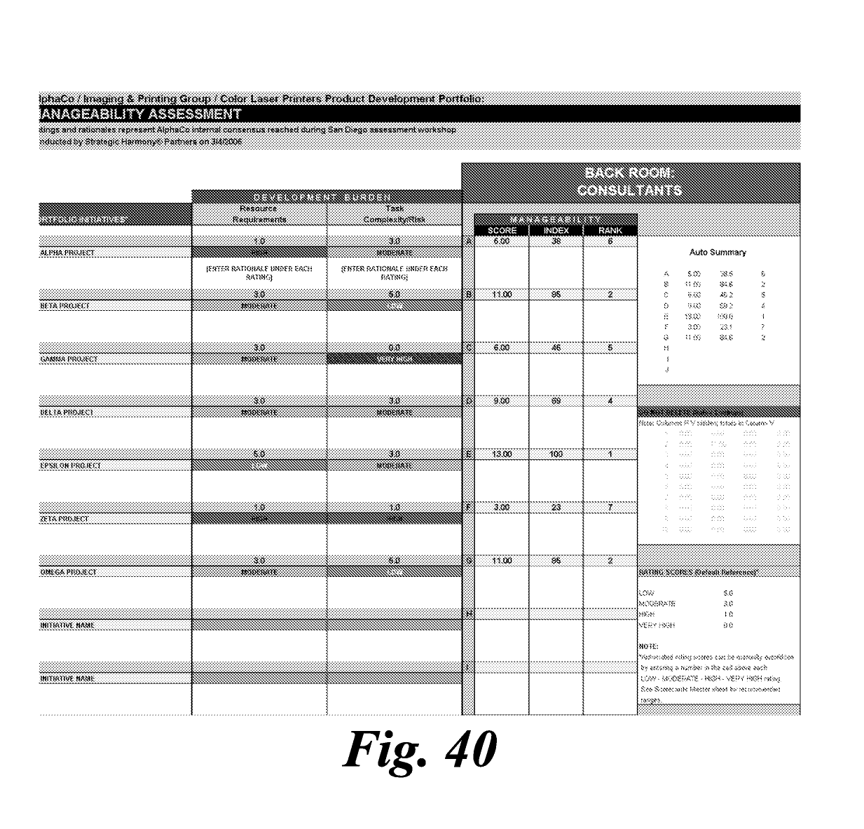

FIG. 40 depicts a spreadsheet screenshot showing details operating or associated with the “Back Room: Consultants Only” in arriving at numerical descriptors for development burden of designated portfolio initiatives.

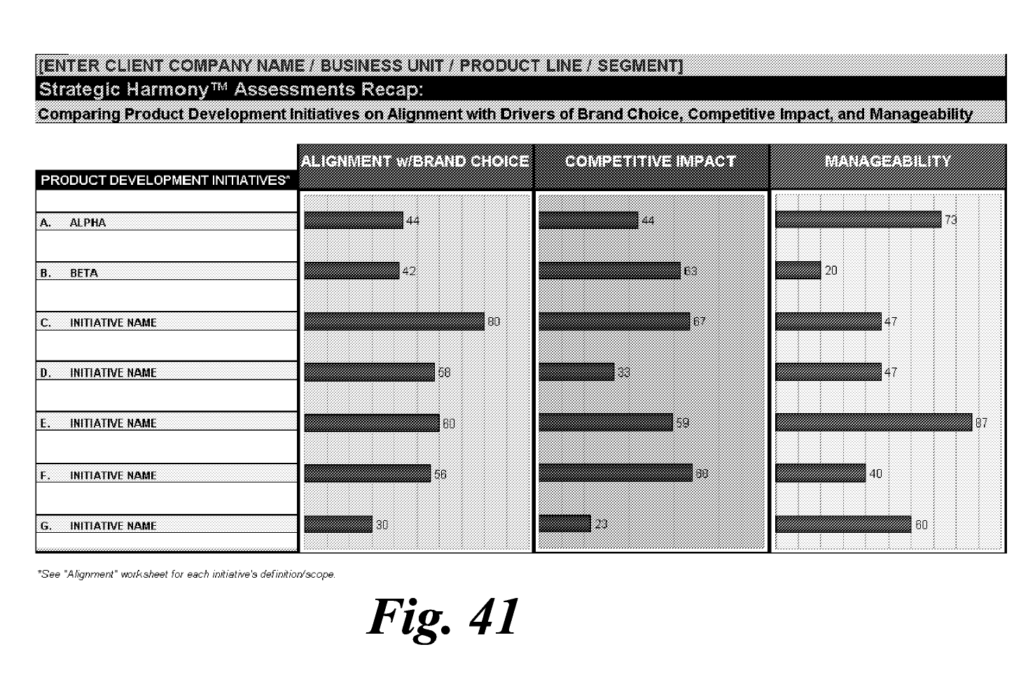

FIG. 41 depicts a screenshot graphic of bar graphs describing alignment with brand choice, competitive impact, and manageability.

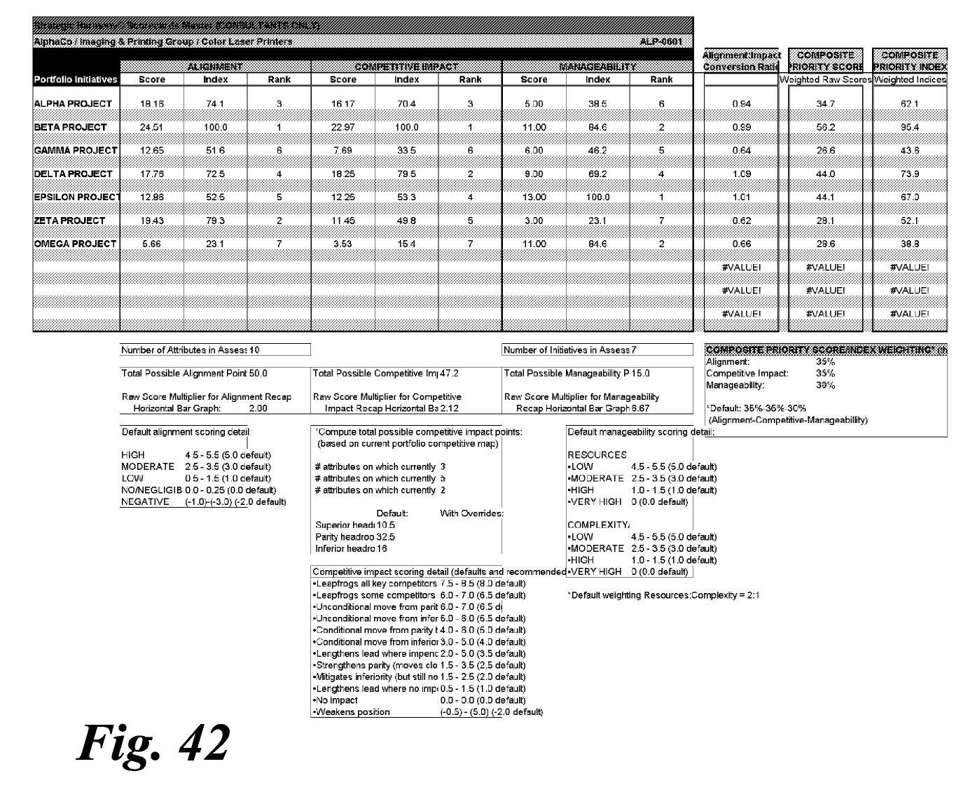

FIG. 42 depicts a spreadsheet screenshot of scores, ranks, and indices of alignment, competitive impact, and manageability for designated portfolio initiatives, plus conversion ratios and reference metrics ranges for consultants.

Results depicted by FIGS. 15-42 are obtained by methods described in FIGS. 1 and 2A-D. Alternate embodiments to the methods are described below for developing and delivering a decision intelligence report to a client so that the client may make an informed decision regarding resource allocation.

3.1 Setting Up a Project—Marketing and management consulting firms with software infrastructure already have their own internal systems for valid users logging on to the system, user authentication, and setting up new project names and codes. Consequently, no drawings are submitted here for these functions.

3.3 Analyzing Inputs—Screens for analyzing inputs include: (1) Drivers of Brand Choice (various sorts, example in FIG. 8); (2) Consensus Builder Results Recaps (FIG. 11); (3) Competitive Situation Dashboard (FIG. 21); (4) Development Portfolio Alignment with Brand Drivers (FIG. 22); (5) Relative Impact of Total Portfolio By Attribute (FIG. 23); (6) Development Portfolio Competitive Impact (FIGS. 24, 25, 26, 27); (7) Manageability (FIG. 28).

3.4 Generating Outputs—Screens for generating outputs include: (1) Assessments Recap (FIG. 29); (2) Development Priorities Based on Overall Strategic Importance (FIG. 30); (3) Priority Guide (FIG. 31); (4) Balancing Strategic Importance against Manageability (FIG. 32).

3.5 Building Presentations—Use Case #9 described alternative scenarios for building and presenting Application results and recommendations to client companies. For content, however, a sample presentation is available upon request.

3.6 Monitoring Project Status—Not functional in alternate software embodiments. Specifications may be included in alternate software embodiments. Screens for monitoring may include variations of FIGS. 2A, 2B, 2C, and/or 2D. 3.7 ROI Analysis—Not functional in alternate software embodiments.

3.8. Generating Customer Research Request for Proposal—Not functional in alternate software embodiments. Specifications may be included in alternate software embodiments.

3.9 Online Help—Not functional in alternate software embodiments. Specifications may be included in alternate software embodiments.

HOW PARTICULAR EMBODIMENTS DIFFER FROM OTHER RELATED BUSINESS METHODS: The preferred embodiment involves certain disciplines that may intersect with those employed by other marketing-related and product development-related business methods for which patents have been sought and/or granted, such as Enterprise Marketing Automation and related strategic marketing processes, product lifecycle management processes, computer-implemented product control centers, and computer-based brand strategy decision processes. However, the preferred embodiment differs significantly from all of these; some key differences are summarized below. Enterprise Marketing Automation and related strategic marketing planning processes. Application, the preferred embodiment, focuses on optimizing product development priorities in the context of disciplined brand strategy; Enterprise Marketing Automation patents focus on software-centric approaches to developing brand strategy, executing marketing campaigns, and tracking results—with little to no focus on the specifics of product development optimization as it relates to brand strategy. The preferred embodiment takes some of the more common conceptual components of brand strategy and frames them in a “Brand Strategy Architecture” format, but even more significantly differentiates itself from Enterprise Marketing Automation inventions by linking that architecture to product development portfolio assessment as well as assessment of current product portfolios (portfolios of products already available in the market). There are other existing strategic marketing planning processes that are not necessarily automated or technical in nature, and there are automated product development management tools. But the former are not linked to product development as is Application, and the latter are typically project management software tools for execution of product development projects and do not yield the strategy which drives prioritization of those projects. Application produces that strategy through integration with brand strategy. Though there may be certain components of an Enterprise Marketing Automation solution—such as brand assessments, competitive assessments, and brand positioning statements—that are similar to selected components of Application, the import of these individual parts of the preferred embodiment is in uniquely linking all of this brand-related planning to product development portfolio management rather than just doing automation-assisted brand positioning and marketing communications in a vacuum. Product Lifecycle Management Processes. Such tools, if proprietary, are generally software-centric and software-dependent, and may pick up where Application leaves off—that is, once product development projects have been identified and prioritized by management decision-makers (whom the preferred embodiment is designed to influence and assist), other lifecycle management software helps optimize resource allocation and project management to get the development done more efficiently and effectively. As such, lifecycle management software would help execution of strategies that are in part the output of Application, with no overlap. In other words, while lifecycle management software assists in optimizing work on projects that are already included in a product development portfolio, Application helps determine what gets into that portfolio in the first place, and how to strategically prioritize the projects within the portfolio.

Product Control Centers. Patented computer-implemented “Product Control Centers” assist users through the process of developing a product. They do not, however, address brand strategy development or drivers of brand choice, whereas the preferred embodiment uniquely combines brand strategy with product development portfolio assessment and is strategic rather than technical. Further, Application provides value-added integration between product strategy and marketing strategy; a Product Control Center, which focuses on engineering rather than marketing, does not. The preferred embodiment is not dependent upon proprietary software (implementations of particular embodiments have been successfully conducted for well-known companies using only off-the-shelf Microsoft Office with no proprietary software involved), nor is the preferred embodiment's value limited to improvements in product development logistical processes—as it reprioritizes the products and features to be developed by using specific aspects of marketing and brand strategy as guides. Computer-Based Brand Strategy Decision Processes. Such patented processes focus on allocating marketing resources multinationally to support a global brand. Unlike the preferred embodiment, they do not address product development/product strategies and the integration of those with brand strategy to provide decision intelligence on optimizing product development resource allocation by strategically reprioritizing development projects. Again, Application is strategically focused and not technically dependent on proprietary software (though its implementation may be supported by proprietary software over time).

In alternate embodiments there are two factors: Alignment and Competitive Impact. These are both principal components of the Strategic Importance Index, for which the default formula weights them equally (50% Alignment, 50% Competitive Impact). Flexible Weighting provides business logic for—and the capability for—Strategic Importance Indices to reflect variability in the importance of Competitive Impact (relative to the importance of Alignment) across different product development portfolios. For example, one successful brand may already be the leader (best in class) on most of the attributes that drive brand choice; another brand may be inferior on most attributes that drive brand choice. There is more “headroom” for the latter brand to improve its competitive position, so Competitive Impact is a more useful way of comparing different product development initiatives in such cases than in cases where a brand is already the leader on most attributes and has less opportunity to improve its competitive position. In other words, the more attributes on which a brand is already superior, the less weight Competitive Impact should receive relative to Alignment in computing Strategic Importance Indices. However, the poorer the brand's current competitive position across attributes, the more weight Competitive Impact should receive.

Manageability weighting (Manageability being the third of the principal Strategic Harmony® metrics, along with Alignment and Competitive Impact) may also be variable; the more similar each product development initiative is to the others in manageability components (resource requirements and complexity/risk), the less manageability matters in the overall analysis. The more diverse the initiatives are in degree of manageability, the more manageability matters in the overall analysis.

Assigning relative weights to Alignment and Competitive Impact (overriding defaults):
1. Look up the total possible number of Competitive Impact points (“headroom”) on the Scorecards Master sheet of the Strategic Harmony® Software (Excel Workbook).
2. Average “headroom” (total possible Competitive Impact points for brand at parity with competitors on all attributes) is 65 points. Maximum headroom (inferior on all attributes) is 80 points. Minimum headroom (superior on all attributes, but opportunity to lengthen lead) is 35 points. The default Strategic Importance Index calculation, weighting Competitive Impact at 50%, assumes the average headroom of 65 points. When headroom is significantly more or less than that, the brackets below represent recommended adjustments:
   If headroom at 80 points (the maximum): Alignment 35%, Competitive Impact 65%
   If headroom at 75: Alignment 40%, Competitive Impact 60%
   If headroom at 70: Alignment at 45%, Competitive Impact 55%
   Default (headroom at 65): Alignment 50%, Competitive Impact 50%
   If headroom at 60: Alignment 55%, Competitive Impact 45%
   If headroom at 55: Alignment 60%, Competitive Impact 40%
   If headroom at 50: Alignment 65%, Competitive Impact 35%
   If headroom at 45: Alignment 70%, Competitive Impact 30%
   If headroom at 40: Alignment 75%, Competitive Impact 25%
   If headroom at 35 (minimum): Alignment 80%, Competitive Impact 20%
Note: in cases where headroom is low but the brand's lead is threatened on multiple attributes, consider making a less significant reduction of Competitive Impact's importance.

In one particular embodiment a Composite Priority Score (CPS) is comprised of Strategic Importance 75%, Manageability 25%. (Flexible weighting of the components of Strategic Importance—Alignment and Competitive Impact—may determine each of those components' weight relative to each other, but in every default case the aggregated Strategic Importance score may account for 75% of the Composite Priority Score. Specifically, this translates to a default in which Alignment accounts for 37.5%, Competitive Impact accounts for 37.5%, and Manageability accounts for the remaining 25%. However, there are cases in which it makes sense for Manageability to account for a greater or lesser portion of the total CPS.

In cases where Manageability does not vary much from one product development initiative to the next, Manageability of any individual initiative becomes a less relevant consideration in optimizing resource allocation. (The more alike our choices, the less it matters.) In cases where there are dramatic differences in Manageability across a portfolio of initiatives, Manageability matters more.

Assigning relative weights to Strategic Importance and Manageability:
1. Adjust from default; default is based on Manageability Indices across the portfolio having a range (from most to least manageable) of approximately 50 points (“manageability spread”).
2. Recommended adjustments based on variable manageability spreads:
   If spread >75 points: Manageability 33.3%, Strategic Importance 66.7%
   If spread=66-75 points: Manageability 30%, Strategic Importance 70%
   If spread=56-65 points: Manageability 27.5%, Strategic Importance 72.5%
   Default (spread=46-55): Manageability 25%, Strategic Importance 75%
   If spread=36-45 points: Manageability 22.5%, Strategic Importance 77.5%
   If spread=26-35 points: Manageability 20%, Strategic Importance 80%
   If spread=16-25 points: Manageability 15%, Strategic Importance 85%
   If spread <16 points: Manageability 10%, Strategic Importance 90%
Assigning relative weights to Alignment and Competitive Impact (overriding defaults):
3. Look up the total possible number of Competitive Impact points (“headroom”) on the Scorecards Master sheet of the Strategic Harmony® Software (Excel Workbook). Average “headroom” (total possible Competitive Impact points for brand at parity with competitors on all attributes) is 65 points. Maximum headroom (inferior on all attributes) is 80 points. Minimum headroom (superior on all attributes, but opportunity to lengthen lead) is 35 points. The default Strategic Importance Index calculation, weighting Competitive Impact at 50%, assumes the average headroom of 65 points. When headroom is significantly more or less than that, the brackets below represent recommended adjustments:
   If headroom at 80 points (the maximum): Alignment 35%, Competitive Impact 65%
   If headroom at 75: Alignment 40%, Competitive Impact 60%
   If headroom at 70: Alignment at 45%, Competitive Impact 55%
   Default (headroom at 65): Alignment 50%, Competitive Impact 50%
   If headroom at 60: Alignment 55%, Competitive Impact 45%
   If headroom at 55: Alignment 60%, Competitive Impact 40%
   If headroom at 50: Alignment 65%, Competitive Impact 35%
   If headroom at 45: Alignment 70%, Competitive Impact 30%
   If headroom at 40: Alignment 75%, Competitive Impact 25%
   If headroom at 35 (minimum): Alignment 80%, Competitive Impact 20%
Note: in cases where headroom is low but the brand's lead is threatened on multiple attributes, consider making a less significant reduction of Competitive Impact's importance.

### Inputs Master Sheet of Alternate Embodiments of Software:

1. Correlation coefficients, and coefficient ranking, for each driver of brand choice displays under attributes on both the Alignment and Competitive Impact dashboards.
2. Cells re-tint to original bright green if attribute entered is deleted.
3. Attribute names and factor names fields increase from 20 to 30 characters.
4. Computation of correlation coefficients as multipliers of both Alignment and Competitive scores is automated when needed.
5. Alignment: Impact conversions are included on Assessments Recap, transplanted from Scorecards Master.

### Alignment Dashboard:

6. Auto-complete and auto-format from H, M, L, NO, or NEG as alternative to dropdown entry.
7. “No/negligible” on dropdown menu appears in cell as blank (no fill).
8. “Negative” auto-formats with red text, no fill.
9. Variable number of columns can be designated per factor; merge factor name and auto-adjust color formatting (more flexibility planned when reporting layer is added).
10. Total alignment points by attribute are computed and display at top of each attribute column; instructed to ignore blank cells in total.
11. Average alignment points per attribute are computed for each.

12. Horizontal bar graphs for relative impact of total portfolio by attribute are generated (and will display on Outputs to PPT page when reporting layer is added).
13. Rationale text fields wrap as single text entries.

### Competitive Impact Dashboard:

14. “Weakens position” option added to dropdown menu and reference data (default=−2.0).
15. If baseline is “Superior,” automate rest of that column to display same (unless overridden due to Negative impact in Alignment).
16. Variable number of columns can be designated per factor; factor names auto-merge and auto-adjust color formatting (more flexibility planned when reporting layer is added).
17. On all competitive position cells in columns where Baseline row is “Superior,” automate cross-check of Alignment level to “decide” whether to apply “Extends lead” or “No impact.”
18. Code all attributes on which Baseline is “Superior” to tag whether or not there is a “threat” (so that consultant can accurately choose between “Extends lead (threat)” and “Extends lead (no threat)” on dropdown menu.
19. In Total Portfolio row, automate highlighting of cells in which position has changed from baseline.
20. Auto-complete and auto-format from S, P, or I as alternative to dropdown entry method.
21. Compute total impact points by attribute at foot of each column.
22. Compute average impact points per attribute for each.
23. Generate baseline map showing color bars for current competitive position (Superior/Parity/Inferior) on each attribute.

### Quadrant Map:

24. “Boost”/normalize scores for mapping (feature determines default position of X hand Y axes and automates compensation).

### Scorecards Master:

25. Adds CPS calculations on Scorecards Master
26. Picks up Initiative Names from Inputs Master
27. On Alignment:Impact conversions, compares raw score conversions to index conversions.
28. Sub-segment weighting capability to automatically modify all scores, dashboards, quadrant maps, and other releveant metrics/graphics outputs impacted by sub-segment weighting.

Look up the total possible number of Competitive Impact points (“headroom”) on the Scorecards Master sheet of the Strategic Harmony® Software (Excel Workbook).

Average “headroom” (total possible Competitive Impact points for brand at parity with competitors on all attributes) is 65 points. Maximum headroom (inferior on all attributes) is 80 points. Minimum headroom (superior on all attributes, but opportunity to lengthen lead) is 35 points. The default Strategic Importance Index calculation, weighting Competitive Impact at 50%, assumes the average headroom of 65 points. When headroom is significantly more or less than that, the brackets below represent recommended adjustments:

If headroom at 80 points (the maximum): Alignment 35%, Competitive Impact 65%
If headroom at 75: Alignment 40%, Competitive Impact 60%
If headroom at 70: Alignment at 45%, Competitive Impact 55%
Default (headroom at 65): Alignment 50%, Competitive Impact 50%
If headroom at 60: Alignment 55%, Competitive Impact 45%
If headroom at 55: Alignment 60%, Competitive Impact 40%
If headroom at 50: Alignment 65%, Competitive Impact 35%
If headroom at 45: Alignment 70%, Competitive Impact 30%
If headroom at 40: Alignment 75%, Competitive Impact 25%
If headroom at 35 (minimum): Alignment 80%, Competitive Impact 20%

Note: in cases where headroom is low but the brand's lead is threatened on multiple attributes, consider making a less dramatic reduction of Competitive Impact's importance.

In alternate embodiments, one theme throughout all the above types of inventions underscores the uniqueness of Application: none of these other solutions are designed specifically to address a systemic separation of marketing and product development organizations common in larger companies—e.g., where the chief marketing officer has purview over brand and product marketing, while product development resides in the technical center in the domain of senior engineering managers, scientists, or program developers. This separation manifests in the fact that product development is not a more critical part of other inventions that purport to be comprehensive marketing planning solutions. More tightly integrating marketing and product development, to their mutual benefit and therefore toward the objective of building shareholder value and competitive advantage for a company, was a key motive for the preferred embodiment.

Accordingly, the scope of the invention is not limited by the disclosure of the particular embodiments. Instead, the invention should be determined entirely by reference to the claims that follow.

1. A business method to enhance business performance, market impact, and brand equity comprising:
producing a portfolio assessment regarding market impact and brand choice alignment, the portfolio assessment having at least two product development initiatives;
developing metrics to prioritize the at least two product development initiatives;
determining the strategic value of the metrics; and
allocating resources in proportion to the strategic value.

2. The method of claim 1, wherein determining the strategic value of the metrics includes evaluating the at least two product development initiatives in terms of relative potential strategic contribution.

3. The method of claim 1, wherein determining the strategic value of the metrics includes evaluating the at least two product development initiatives in terms of relative development burden manageability.

4. The method of claim 1, wherein determining the strategic value of the metrics includes evaluating the at least one product development initiative in at least one of a partial portfolio and a whole portfolio.

5. The method of claim 1, wherein developing metrics to prioritize product development initiatives includes defining a plurality of attributes designed to drive at least one customer's choice of brands and characteristics that customers consider to be distinguishing from similar products and services.

6. The method of claim 2, wherein determining the strategic value of the metrics includes assessing the degree of competitive impact.

7. The method of claim 2, wherein assessment of strategic contribution includes evaluation of each product development initiative's relative degree of alignment with key attributes that drive brand choice or describe the ideal customer experience.

8. The method of claim 3, wherein assessment of development burden manageability includes evaluation each product development initiative's relative level of resources needed to successfully bring the initiative to market.

9. The method of claim 3, wherein assessment of development burden manageability includes evaluation of each product development initiative's relative complexity or risk in successfully bringing the initiative to market.

10. The method of claim 3, wherein assessment of competitive impact includes the impact of the entire product development portfolio being assessed rather than the individual initiatives within the portfolio.

11. The method of claim 8, wherein assessment of brand choice alignment includes alignment of the entire product development portfolio being assessed rather than the individual initiatives within the portfolio.

12. The method of claim 12, wherein producing the portfolio assessment includes analyzing the metrics to derive conclusions for resource allocation.

13. The method of claim 1, wherein the portfolio assessment is designed to improve alignment between product strategy and brand strategy utilizing common assumptions about attributes that drive brand choice.

14. A method to predict the relative strategic value of product development initiatives, the method comprising:
producing at least one business indices;
associating at least one business indices with at least one branded entity;
assessing factors deriving the at least one business indices having competitive impact; and
allocating resources in proportion to those indices having competitive impact.

15. The method of claim 15, wherein producing the at least one business indices includes manageability scores.

16. The method of claim 16, wherein producing manageability scores includes resource requirements and risk manageability.

17. The method of claim 17, wherein producing manageability scores include presenting in a graphic format.

18. The method of claim 18, wherein presenting in the graphic format includes a quadrant map.

19. A computer readable medium having computer executable instructions to perform a method comprising;
producing a portfolio assessment regarding market impact and brand choice alignment, the portfolio assessment having at least two product development initiatives;
developing metrics to prioritize the portfolio assessment;
determining the strategic value of the metrics; and
allocating resources in proportion to the strategic value.
